(19) United States
(12) Patent Application Publication
(10) Pub. No.: US 2026/0237102 A1
(43) Pub. Date: Aug. 13, 2026

(54) EFFICIENT END-TO-END EDGE BREAKER IMPLEMENTATION

(71) Applicant: InterDigital CE Patent Holdings, SAS, Paris (FR)

(72) Inventors: Jean-Eudes Marvie, Plerin (FR); Olivier Mocquard, Rennes (FR)

(21) Appl. No.: 19/471,316

(22) PCT Filed: Apr. 3, 2024
(86) PCT No.: PCT/EP2024/058981

§ 371 Date: Sep. 30, 2025

(30) Foreign Application Priority Data
Apr. 6, 2023 (EP) 23305505.2
Jun. 14, 2023 (EP) 23305941.9

(51) Int. Cl. G06T 9/00; G06T 9/20; H04N 19/70

(52) U.S. Cl. CPC G06T 9/001; G06T 9/20; H04N 19/70

(57) ABSTRACT

Example embodiments provide encoding and decoding methods and apparatus for coding of mesh data. In example embodiments, connectivity data of a mesh is coded using edgebreaker technology as an ordered sequence of symbols. Some embodiments provide for pre- and post-processing of non-manifold meshes to allow for efficient coding of such meshes as one or more mani-fold meshes. Some embodiments provide techniques for efficient coding of per-vertex and/or per-triangle attributes of the mesh. Some embodiments provide arithmetic coding techniques that are well adapted to efficient coding of mesh connectivity and/or attribute data.

### CROSS-REFERENCE

This application claims priority of European Patent Application No. 23305505.2, filed 6 Apr. 2023, and of European Patent Application No. 23305941.9, filed 14 Jun. 2023, both of which are incorporated herein by reference in their entirety.

### BACKGROUND

The present disclosure relates to systems and methods for encoding and decoding a mesh based on edgebreaker technology. Edgebreaker is a technology that is capable of efficiently coding the connectivity of a triangular mesh. In its most straightforward implementation, a mesh encoded using edgebreaker is represented by an ordered series made up of the symbols, C, L, E, R, and S, called the “CLERS” sequence. Generally speaking, starting with an initial triangle, these symbols describe different ways to attach a new triangle, providing information on whether or how different edges of the new triangle are connected to one or more of the existing triangles. Edgebreaker technology is described in greater detail, for example in the following sources:
J. Rossignac, “3D compression made simple: Edgebreaker with ZipandWrap on a corner-table,” in Proceedings International Conference on Shape Modeling and Applications, Genova, Italy, 2001. Describes decoding in a forward direction with the use of a corner table (CT) representation of the mesh, which leads to a very compact algorithm.
H. Lopes, G. Tavares, J. Rossignac, A. Szymczak and A. Safonova, “Edgebreaker: a simple compression for surfaces with handles,” in ACM Symposium on Solid Modeling and Applications, Saarbrucken, 2002.
J. Rossignac, “Edgebreaker: Connectivity compression for triangle meshes,” GVU center, Georgia Institute of Technology, 1999. Describes decoding in a forward direction using a half-edge representation.
J. Rossigniac, “Course on triangle meshes and corner table,” 2006.
M. Isenburg and J. Snoeyink, “Spirale Reversi: Reverse decoding of the Edgebreaker encoding,” Computational Geometry, vol. 20, pp. 39-52, 2001. Describes the “spiral reversi” technique, which uses a half edge representation, but performing the decoding in a reverse manner, which leads to faster decoding of O(n).

Following the MPEG V-Mesh (now renamed V-DMC) call for proposals the solution proposed by Apple was selected to become the foundation of the MPEG V-Mesh Test Model (TM). The proposal is described in K. Mammou, J. Kim, A. Tourapis and D. Podborski, “m59281—[V-CG] Apple's Dynamic Mesh Coding CfP Response,” Apple Inc, 2022. Schematic summary figures outlining the proposal are provided in FIG. 1 and FIG. 2 of the present disclosure.

The test model, for some frames, uses a static mesh coder for the encoding of a base mesh that is then subdivided to obtain an approximation of the original mesh. Currently, the V-Mesh test model encodes a base mesh using the Google Draco implementation of an edgebreaker-based mesh encoder. Specifically, the implementation uses the “spirale reversi” version of edgebreaker as described in M. Isenburg and J. Snoeyink, “Spirale Reversi: Reverse decoding of the edgebreaker encoding,” Computational Geometry, vol. 20, pp. 39-52, 2001.

While edgebreaker coding provides an efficient way to code the connectivity of a base mesh, it has certain limitations. For example, edgebreaker coding on its own is effective only for manifold surfaces without “holes” or “handles.” Additional processing is required to bring such non-manifold surfaces into a format that is capable of being coded using edgebreaker technology. Moreover, edgebreaker coding on its own only codes for the connectivity of a mesh. The CLERS sequence itself does not code additional properties of a mesh, such as the locations of the vertices and any other attributes of the vertices (such as color, normal direction, UV coordinates, and the like).

### SUMMARY

Some example embodiments support meshes with multiple connected components. In one example embodiment, a method includes encoding a first connected component of a mesh with edgebreaker coding; after encoding the first connected component of the mesh, identifying an uncoded corner in the mesh; and encoding a second connected component of the mesh using the identified uncoded corner as an entry corner.

In some embodiments, such a method may be performed as follows. identifying at least one non-manifold edge in a mesh; duplicating vertices along the non-manifold edge to separate the non-manifold edge into at least two manifold edges; stitching together two of the at least two manifold edges; and after stitching together two of the at least two manifold edges, encoding the mesh using edgebreaker coding.

An example encoding method includes: identifying at least one non-manifold edge in a mesh, the non-manifold edge being defined by parent vertices; preprocessing the mesh by duplicating parent vertices along the non-manifold edge to separate the non-manifold edge into at least two manifold edges, each manifold edge being defined by child vertices, each child vertex being duplicated from a respective parent vertex; encoding the preprocessed mesh into a bitstream using edgebreaker coding; and providing in the bitstream information identifying, the parent vertex of the child vertices.

An example decoding method includes: obtaining from a bitstream information defining a plurality of connected components of an edgebreaker-coded non-manifold mesh; obtaining from the bitstream information associating child vertices with parent vertices; at least partially decoding at least two of the connected components, each of the connected components having child vertices associated with respective parent vertices; and deduplicating the child vertices to reconstruct the non-manifold mesh.

An example encoding method comprises: preprocessing a mesh having a hole by creating a dummy vertex, the dummy vertex being connected to each vertex along a perimeter of the hole; encoding the preprocessed mesh in a bitstream with edgebreaker coding; encoding in the bitstream information identifying the dummy vertex; and encoding at least one attribute for each of a plurality of vertices in the preprocessed mesh, wherein the attribute is not encoded for the dummy vertex.

An example decoding method comprises: obtaining from a bitstream information encoding a mesh; obtaining from the bitstream information identifying at least one dummy vertex in the mesh; and decoding from the bitstream attribute information for a plurality of vertices in the mesh, wherein attribute information is not decoded for the at least one dummy vertex.

In some such embodiments, decoding attribute information for a plurality of vertices comprises predicting attribute information for a plurality of the vertices, wherein no attribute information is predicted for the dummy points. The decoder may remove the dummy points.

An example mesh encoding method comprises: encoding a connectivity of a mesh; entropy encoding a first table of starting point positions of vertices in the mesh; and separately entropy encoding a second table of point residuals of vertices in the mesh.

An example mesh decoding method includes: decoding information indicating connectivity of a mesh; entropy decoding a first table of starting point positions of vertices in the mesh; and separately entropy decoding a second table of point residuals of vertices in the mesh.

An example mesh encoding method includes: obtaining information defining a mesh having a plurality of connected components (CCs), each vertex in a CC having a unique global-scope index; for each CC, shifting the indices of the vertices in the CC from the global-scope index to a CC-scope index; and encoding each of the CCs using the CC-scope indices.

An example mesh decoding method includes: obtaining information encoding a plurality of connected components (CCs), each vertex in a CC having a respective CC-scope index; decoding each of the CCs; and for each of the vertices, shifting the index of the vertex from the CC-scope index to a global-scope index.

An example of a mesh encoding method includes: obtaining information describing a mesh having a plurality of triangles, each triangle having an attribute; encoding the mesh as an ordered sequence of symbols in edgebreaker coding, each of the triangles corresponding to an associated one of the symbols; and encoding the attributes of the triangles, the attribute of a current triangle being encoded using a prediction based only on attributes of at least one triangle preceding the current triangle in the ordered sequence of symbols. For example, the attribute of each triangle may be encoded as a delta value relative to the preceding triangle in the sequence (the value of the attribute of the preceding triangle serving as the prediction).

A mesh decoding method according to some embodiments includes: obtaining an ordered sequence of symbols representing an edgebreaker coding of a mesh having a plurality of triangles, each triangle having an attribute; decoding the mesh; and decoding the attributes of the triangles, the attribute of a current triangle being decoded using a prediction based only on attributes of at least one triangle preceding the current triangle in the ordered sequence of symbols.

### BRIEF DESCRIPTION OF THE DRAWINGS

FIG. 1 is a functional block diagram of an example mesh encoding system.

FIG. 2 is a functional block diagram of an example mesh decoding system.

FIG. 3 illustrates an example of an edgebreaker mesh codec according to some embodiments.

FIG. 4 is a flow chart of an encoding process according to some embodiments.

FIG. 5 is a flow chart of a decoding process according to some embodiments.

FIG. 6 illustrates an example of a corner table data structure.

FIG. 7 illustrates an example of an extended corner table to support UV coordinates attribute and normal vector attributes.

FIG. 8 illustrates an extended Corner Table data structure used in memory for the algorithmics.

FIG. 9 illustrates an example encoding entry point procedure.

FIG. 10 illustrates an example procedure preProcess for performing input model conversion, cleanup, filling, and quantization.

FIG. 11 illustrates the procedure encode, including edgebreaker topology coding and attribute predictions.

FIG. 12 illustrates an example procedure startCompression.

FIG. 13 illustrates the procedure compressRec.

FIG. 14 illustrates the procedure checkHandle.

FIG. 15 illustrates an example decoding entry point procedure.

FIG. 16 illustrates the procedure initDecompression, which allocates memory to store decompression outputs and initializes other marking tables.

FIG. 17 illustrates an example procedure startDecompression.

FIG. 18 illustrates the statement connectivityCompression.

FIG. 19 illustrates the example procedure decompressConnectivity.

FIG. 20 illustrates an example of the CheckHandle procedure to support shifts.

FIG. 21 illustrates the statement attributesDecompression.

FIG. 22 illustrates an example of the procedure DecompressVertices.

FIGS. 23-26 illustrates an example of the procedure decompressUvWithSeparateIndex, including statement A (FIG. 24), statement B (FIG. 25), and statement C (FIG. 26).

FIG. 27 illustrates an example of the procedure postProcess, which converts the reconstructed CT mesh into an indexed face set while removing the dummy points, and optionally recreates non-manifolds if lossless coding is used.

FIG. 28 illustrates side by side preProcess and postProcess procedures.

FIGS. 29A and 29B illustrate meshes with non-manifold vertices. FIG. 29C illustrates an example technique for fixing the issue by splitting the vertices.

FIG. 30 illustrates how two of the three surfaces that would result from duplicating the non-manifold vertices are fixed by re-stitching.

FIGS. 31A-31D illustrate filtering of a non-manifold surface according to some embodiments. An example technique may be referred to as cutting and re-stitching.

FIG. 32 illustrates an example vertex duplication stage.

FIG. 33 illustrates an example pre-processing operation of re-stitching using the table of matched opposites.

FIGS. 34A-34B illustrate examples of the procedures deduplicateVertices and processDuplicate.

FIG. 35 illustrates an example of a process for regenerating a non-manifold surface by de-duplicating some vertices.

FIG. 36 illustrates a process in an example embodiment in which a hole in the surface of a mesh is filled with a dummy vertex and dummy triangles.

FIG. 37 illustrates an example of a C++ procedure to fill all the holes of a mesh described as a corner table (O, V, OT, OTC).

FIGS. 38A-38C illustrate an example of a C++ procedure to fill a single hole of a mesh described as a corner table (O, V, OT, OTC).

FIGS. 39A-39B illustrate the prediction of attributes using main index table using a procedure such as encodeAttributes.

FIG. 40 illustrates an example of the predicate isCornerVertexDummy.

FIG. 41 illustrates a decoding counterpart procedure decodeAttributes.

FIG. 42 illustrates an example of the procedure posEncodeWithPrediction.

FIG. 43A illustrates a strategy for multi parallelogram prediction of corner c positions and dummy points filtering according to some embodiments.

FIG. 43B illustrates a strategy for min stretch prediction of corner c UV coordinates and dummy points filtering according to some embodiments.

FIGS. 44A-44B illustrate an example of the procedure posDecodeWithPrediction.

FIGS. 45A-45B illustrate an example of the procedure uvEncodeWithPrediction.

FIGS. 46A-46B illustrates an example of the statement predictUV. dvec2 and dvec3 are double precision vectors.

FIG. 47A illustrates handling UV seams using only a main index table.

FIG. 47B illustrates handling of UVs with separate index table and selection strategy for the corner cₚ used for the prediction of UV coordinates with separate index for corner c.

FIGS. 48A-48B illustrate an example of the procedure encodeSeparateIndexAttributes.

FIGS. 48A-49B illustrate examples of the procedure decodeSeparateIndexAttributes.

FIG. 50 illustrates an example of the procedure save.

FIG. 51 illustrates an example of pseudo code to control the Dirac encoder for the CLERS table.

FIG. 52 provides an illustration reproducing part of the coding principle used for motion vectors in some embodiments.

FIG. 53 illustrates an example offset/shift for ExpGolomb coding.

FIG. 54 illustrates an example of code using arithmetic coding contexts for some embodiments.

FIG. 55 illustrates compression performance of an encoding method as described herein.

FIG. 56 is a block diagram of an example of a system in which various aspects and embodiments are implemented.

FIG. 57 illustrates an example implementation of one embodiment of dummy index removal.

FIG. 58 illustrates an example implementation of another more efficient embodiment of dummy index removal.

FIGS. 59A-59B illustrate an example procedure encodePerFaceAttributes.

FIG. 60 illustrates an example of Dirac AC entropy coding for coding of per-face material IDs.

FIGS. 61A-61C illustrate an example of search order for corner[0]=c (the operation is repeated for corner[1]=c.n then for corner[2]=c.p). FIG. 61A illustrates a face for which an Id is to be coded and L,R,F adjacent triangles. (The three adjacent always exist since dummy points are used to fill holes.) FIG. 61B illustrates lookup in neighborhood looping in a first direction over R, R1, R2, etc. FIG. 61C illustrates a subsequent lookup in the other direction.

### DETAILED DESCRIPTION

### Overview of Example Embodiments

Edgebreaker (EB) is a technology for encoding and decoding (collectively “coding”) the topology (connectivity and handles) of the mesh, which is the core of the algorithm, and proposes the use of predictors for the positions of the vertices to generate some entropy coding efficient data.

Some embodiments of the present disclosure provide a full end-to-end extended version of the EB. Some embodiments include a complete syntax low-level for the bitstream and a more advanced syntax.

Example embodiments provide support of topology coding (connectivity and handles) and support of geometry with delta coding.

Some embodiments provide mesh cleanup for non-manifold removal (preprocessing on CT).

Some embodiments provide support for holes and boundaries, through “virtual” dummy points.

Some embodiments include a lossless mode that reconstructs meshes with bad “connectivity” at decoding if needed.

Some embodiments provide support for multiple connected components (CCs).

Some embodiments include support for texture coordinates encoding using a unique index table or separate index tables.

Some embodiments include multi-parallelogram and stretch predictions. Some such embodiments further provide support for dummy points and separate index tables when needed.

Some embodiments include Dirac and/or RANS arithmetic coders (ACs). Some such embodiments use a specific binarization scheme and arithmetic coding contexts as described herein for use with Dirac coding.

Some embodiments include support of pre-quantized input meshes in addition to input mesh quantization.

Some embodiments include support for per face identifiers or colors.

Some embodiments provide for optimization of per face attribute prediction and encoding.

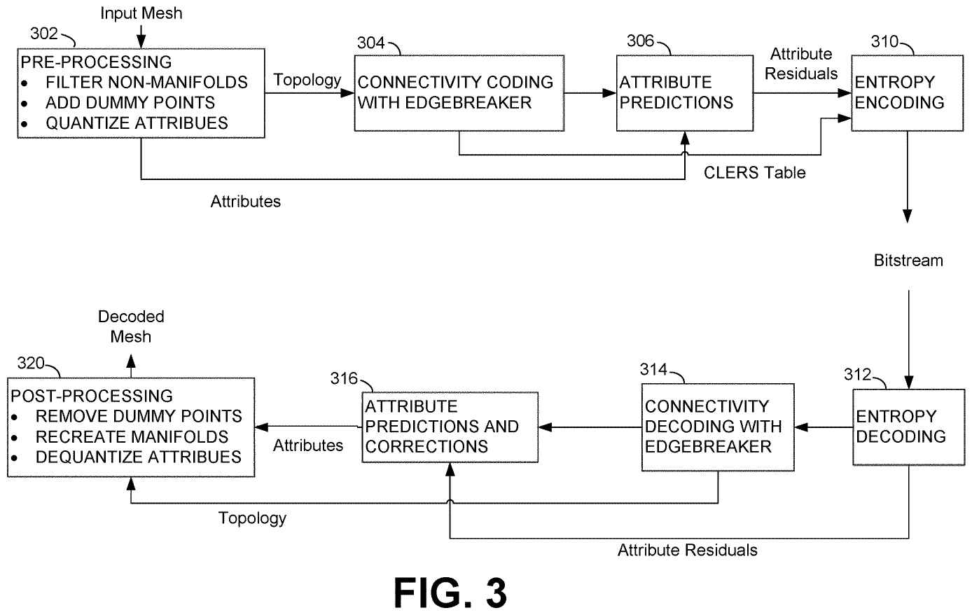

FIG. 3 illustrates an example of an edgebreaker mesh codec according to some embodiments. The top row is the encoding line, and the bottom row is the decoding line. As illustrated in FIG. 3, example embodiments include some or all of the following. During encoding, pre-processing 302 may be used to clean potential connectivity issues (non-manifolds edges and vertices) that can exist on the input mesh. This cleanup is performed because the edgebreaker algorithm by itself does not work on meshes having such connectivity issues. In some embodiments, cleaning non manifold edges and vertices involves duplicating a number of points. Some embodiments keep track of those duplicated vertices to merge those when decoding. This enables to reduce the number of points in the decoded mesh but calls for sending some additional information in the bitstream. In some embodiments, this pre-processing 302 further includes adding some dummy points to fill potential holes on the surface because the edgebreaker algorithm alone does not handle holes. Example embodiments operate to fill the holes before encoding and recreate the holes after decoding. Example embodiments use “virtual” dummy points and generate and encode dummy triangles attached to these dummy points, but the 3D positions of those points are not encoded or decoded. In some embodiments, the vertex attributes are quantized if needed. Those attributes can be provided to the coder already quantized.

Example embodiments encode the connectivity of the mesh AT 304 using a modified version of the edgebreaker algorithm which generates a CLERS table (a table made of ‘C’, ‘L’, ‘E’, ‘R’, and ‘S’ symbols). This stage also generates some tables in memory that are used for the attribute prediction stage. The vertex attributes are then predicted at 306, starting by the position ones. Then, other attributes are predicted, eventually relying on the position predictions, which it is the case for the texture UV coordinates. Configuration and metadata are also provided in the bitstream, the CLERS table, some other connectivity and all the attribute prediction residuals are entropy coded at 310 and added to the bitstream.

In an example decoding method, all of the entropy coded sub-bitstreams are entropy decoded at 312. We reconstruct the mesh connectivity at 314 using the CLERS table and the edgebreaker algorithm. We also add some extra information to manage the handles, which describe the topology. We use the mesh connectivity as well as a minimal set of vertex positions expressed in 3D coordinates to predict all the other per-vertex positions at 316. We then apply the attribute residuals to correct the predictions and obtain the reconstructed vertex positions. The other attributes are also decoded at 316, potentially relying on decoded positions, as for UV coordinates. The connectivity of attributes using separate index tables is reconstructed using per a per edge binary seam information that is entropy coded.

In a post-processing stage at 320, we remove the dummy triangles, we optionally recreate the non-manifold issues in case the coder is configured to perform lossless coding, and we optionally dequantize the vertex attributes if the model was quantized by encoder.

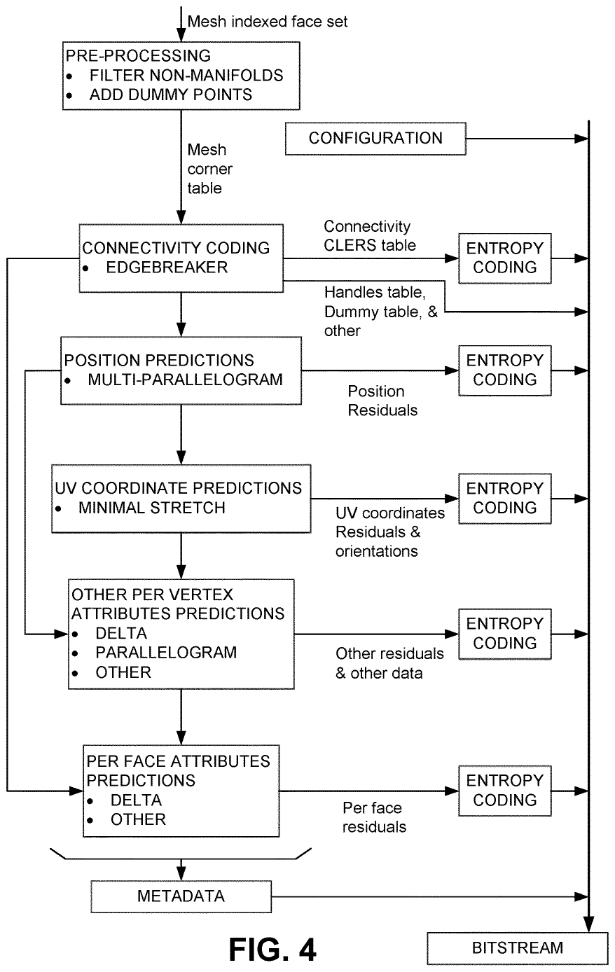

FIG. 4 is a flow chart of an encoding process according to some embodiments.

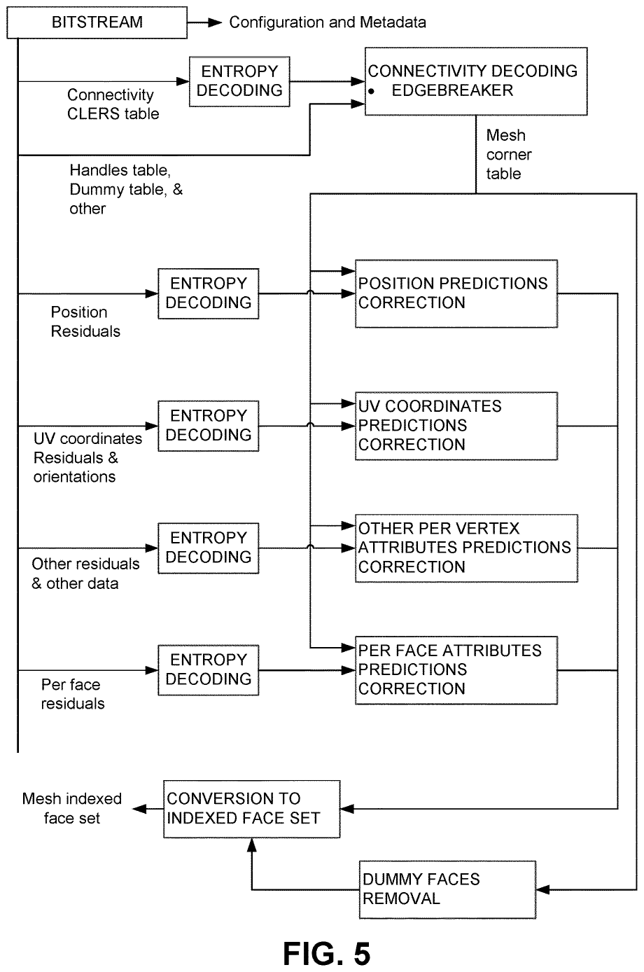

FIG. 5 is a flow chart of a decoding process according to some embodiments.

### Extended Corner Table.

A corner table data structure to represent a mesh is described in J. Rossignac, “3D compression made simple: Edgebreaker with ZipandWrap on a corner-table,” in Proceedings International Conference on Shape Modeling and Applications, Genova, Italy, 2001; and further described in J. Rossigniac, “Course on triangle meshes and corner table,” 2006.

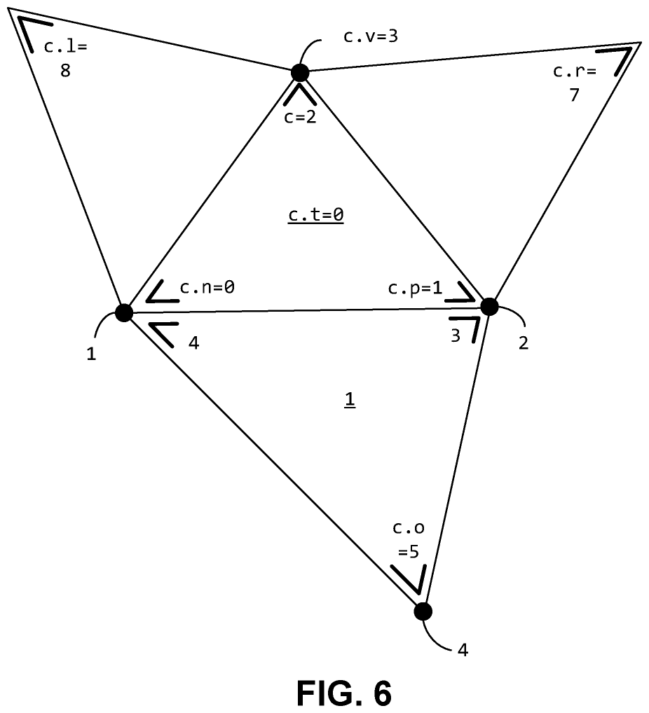

FIG. 6 illustrates a portion of a triangular mesh including as stored in a corner table (also referred to as an OV table). For each corner index c of a corner in the corner table, c.v=3 identifies the index of the vertex at which that corner is located. The index c.t=0 is the index of the triangle that includes corner c. Within that triangle, the index c.n=0 identifies the next corner (in a counterclockwise direction), and c.p=1 identifies the previous corner. The index c.o identifies the corner that is opposite to the corner c. For example, in FIG. 6, corner c.o=5 is opposite corner c=2 (and vice versa). The index c.l identifies the corner to the left of corner c, and the index c.r identifies the corner to the right of corner c. The connectivity as shown in FIG. 6 may be recorded in a corner table with entries that include the following:

| | | Opposite |
|---|---|---|
| Corner Index | Vertex Index | Corner Index |
| 0 | 1 | 7 |
| 1 | 2 | 8 |
| 2 | 3 | 5 |
| 3 | 2 | 9 |
| 4 | 1 | 6 |
| 5 | 4 | 2 |

The “corner index” column does not need to be stored in the table because it corresponds to the position of each row within the table. The triangle index for each corner can be calculated as

$$c . t = INT ( c / 3 )$$

Thus, corners 0, 1, and 2 are all in the triangle with index 0; corners 3, 4, and 5 are all in the triangle with index 1; and so on. Additional relationships among entries in the corner table may be expressed as follows:

$$c . n = 3 c . t + ( c + 1 ) MOD 3$$

$$c . p = c . n . n$$

$$c . l = c . p . o$$

$$c . r = c . n . o$$

In some embodiments, an additional table may be used to store position coordinates of each vertex.

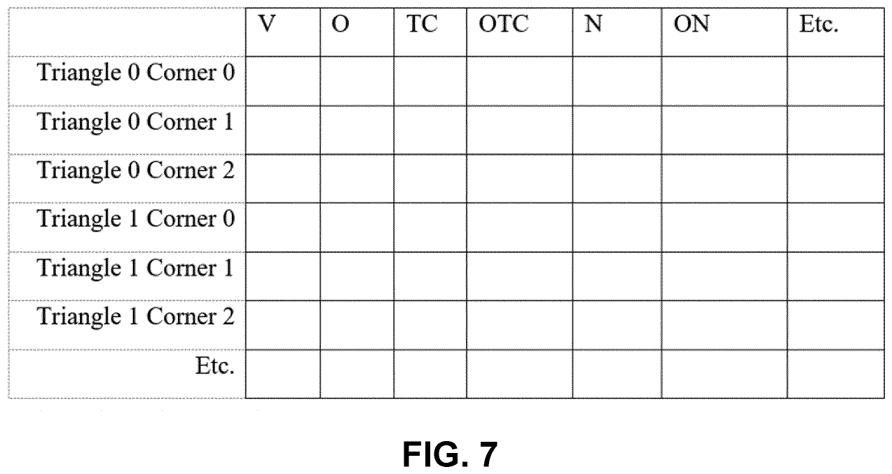

FIG. 7 illustrates an example of an extended corner table as used in some embodiments to support UV coordinates attribute and normal vector attributes, both using separate indexing tables, resp. TC/OTC and N/ON. Texture coordinates and normal vectors may be stored in two other separate tables.

Example embodiments extend the corner table data structure to support other attributes with or without secondary attribute indices, as illustrated in FIG. 7. In case the mesh does not have separate indices to dereference the UV coordinates attributes, example embodiments include a table of UV coordinates alongside the position table. The UV coordinates table is then dereferenced using V as for the position. Otherwise, some embodiments also add two tables TC and OTC to code the connectivity of (to dereference) the UV coordinates. TC is used to store UV coordinates indices and OTC to store the opposite corners for the UV connectivity. The same principle may be applied to add support for per vertex normal (N/ON/normal_vectors) or per vertex colors (C/OC/colors).

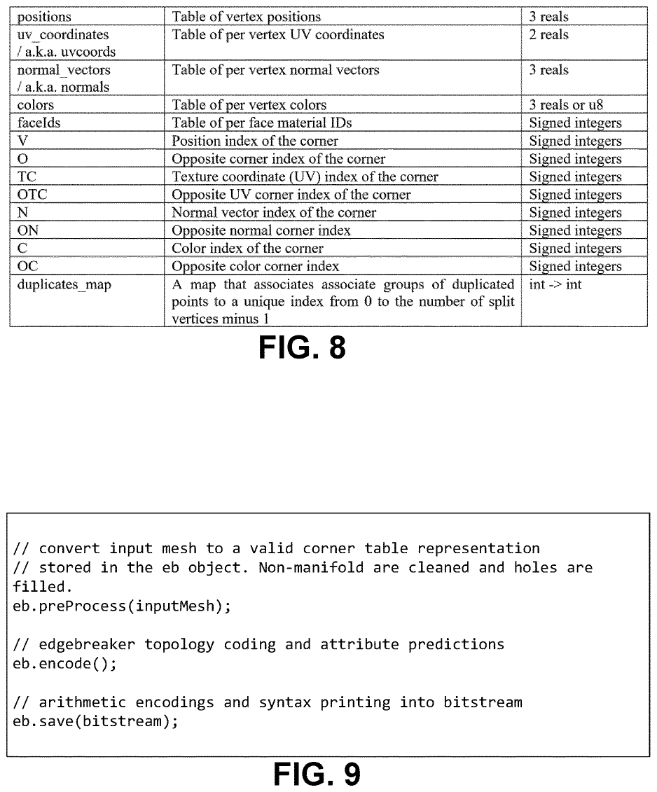

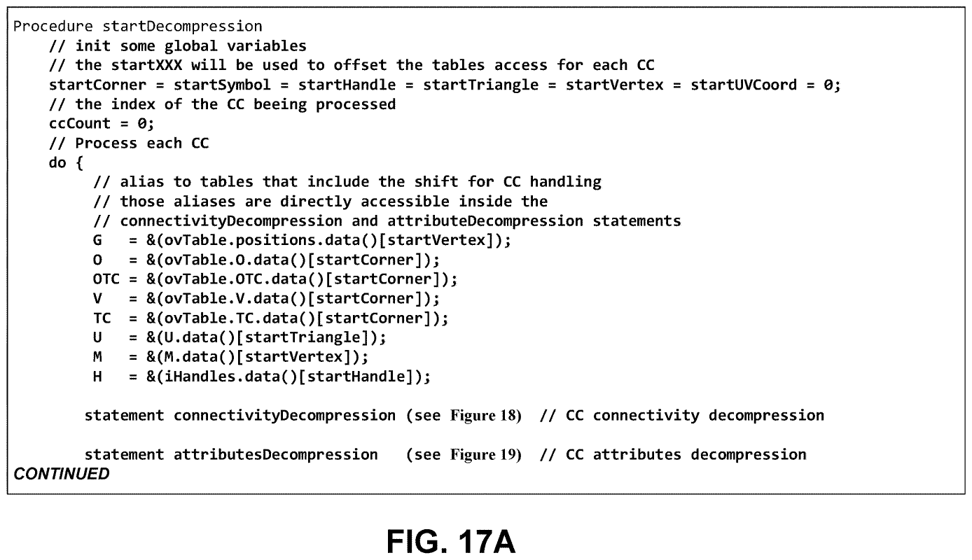

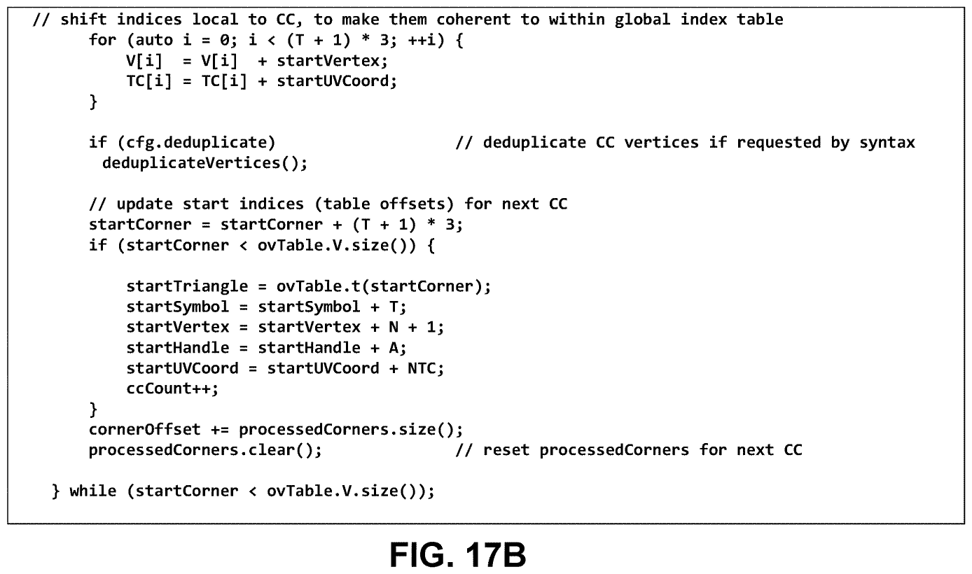

FIG. 8 schematically illustrates an extended Corner Table data structure that may be used in memory in an example embodiment. Using separate tables for each row of the table is depicted in FIG. 17 for more flexibility.

FIG. 8 summarizes the data structures we use to store all the information of our extended corner table. This approach can be extended for any per vertex attribute type, to use or not dedicated index tables modeled using the pair (index table/opposite table). Per face IDs are included in the table in this implementation.

OVERVIEW of encoding procedures.

In this section we give some high-level procedures to better understand the structure and flow of an example encoding process.

An example encoding entry point procedure is depicted in FIG. 9. It includes three steps that perform respectively the pre-processing of the input mesh, its edgebreaker, encoding and finally the entropy coding and storage into the bitstream.

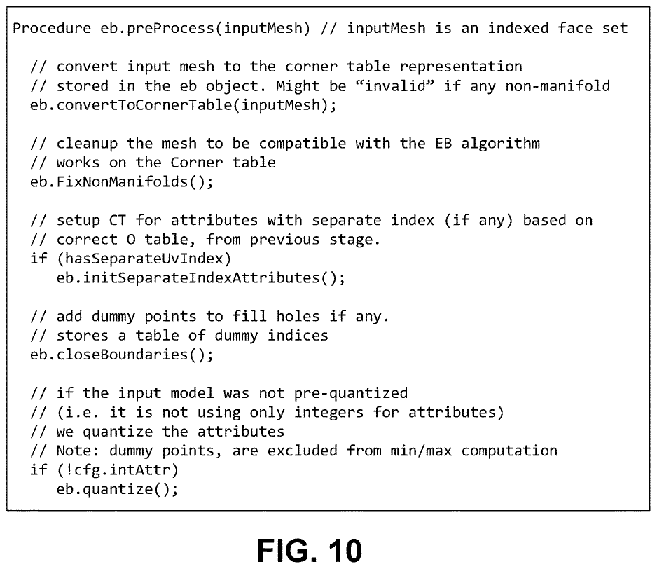

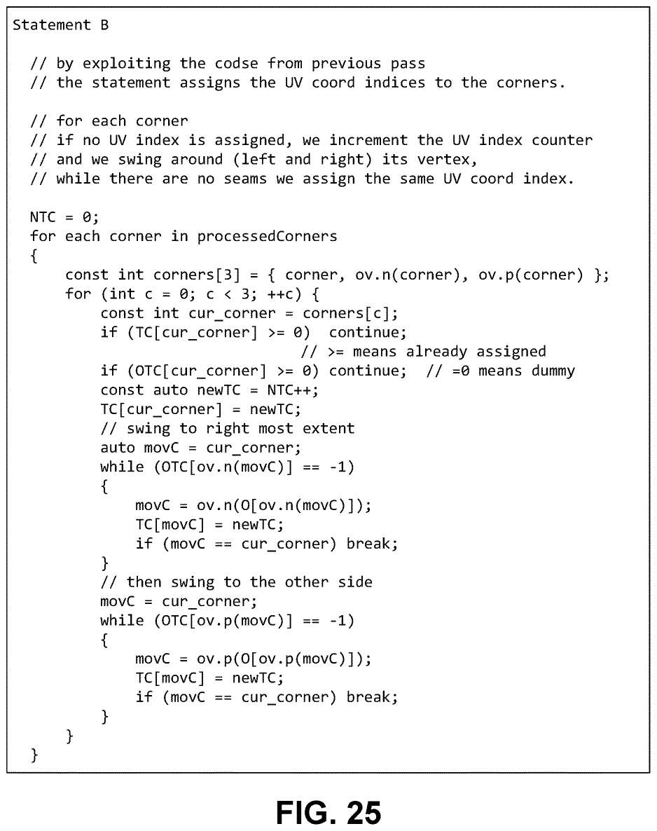

FIG. 10 illustrates an example procedure preProcess for performing input model conversion, cleanup, filling, and quantization. The features of this procedure will be provided in further detail below. It is introduced here for global understanding before introducing the edgebreaker encoding hereafter. The save procedure, depicted in FIG. 25, will also be described in further detail below.

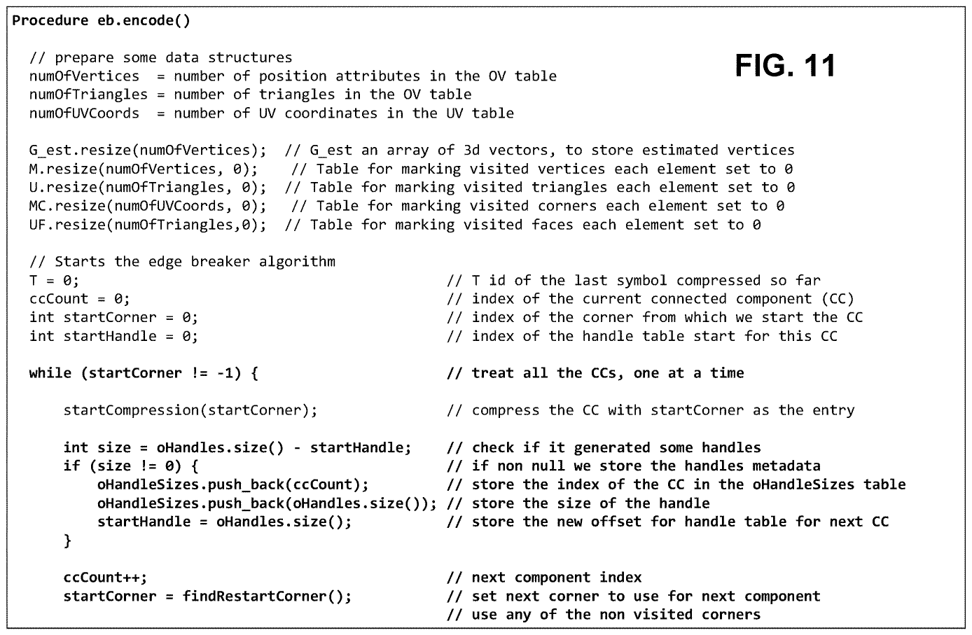

FIG. 11 illustrates the procedure encode, including edgebreaker topology coding and attribute predictions. Features described in particular detail herein are shown in bold lettering. This procedure first initializes some data structures, it mainly allocates some tables for marking attributes or triangles and a table G_est to store the estimations (predicted) of the position attributes. It then run the edgebreaker algorithm on each connected component (CC) of the mesh. To do so we add the while loop in the procedure and manage some start indices for the handles that we update for each new component. After coding of one CC we run the procedure findRestartCorner to check if there exists a non-marked corner in the MC table (i.e. not coded yet) that we can use as the entry corner for the coding of a new CC.

Some example embodiments support meshes with multiple connected components. In one example embodiment, a method includes encoding a first connected component of a mesh with edgebreaker coding; after encoding the first connected component of the mesh, identifying an uncoded corner in the mesh; and encoding a second connected component of the mesh using the identified uncoded corner as an entry corner.

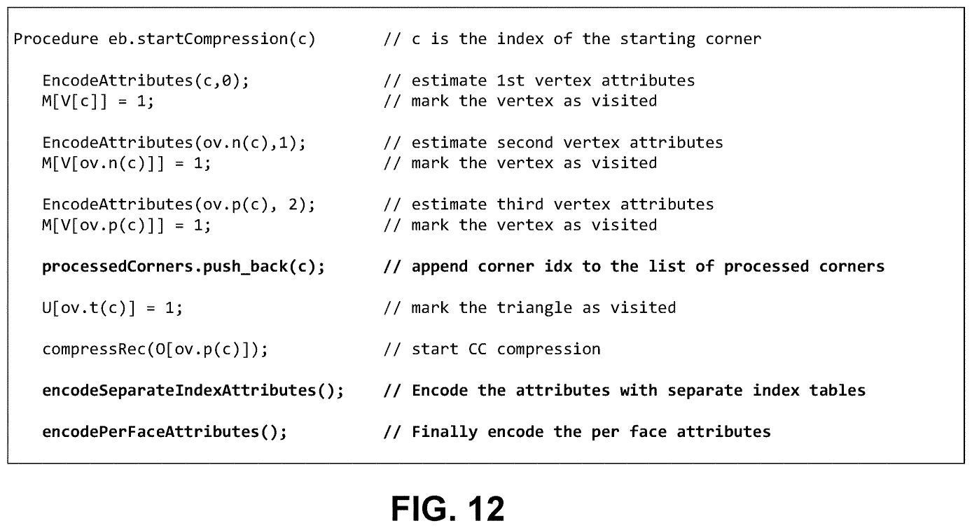

FIG. 12 illustrates an example procedure startCompression. Features described in particular detail herein are shown in bold lettering. This procedure is the actual edgebreaker algorithm starting point to encode a CC. It encodes the first triangle then starts the recursive encoding of the CC. The method includes the recording of processed corners into the table named processedCorners. This table is used later to handle attributes with separate index table. We also add a specific procedure, encodeSeparateIndexAttributes, at the end of the process to encode/predict the attributes that have separate index tables. This last procedure exploits the processedCorners table to perform its processing.

The encodeAttributes, and the encodeSeparateIndexAttributes, and the encodePerFaceAttributes procedures are described in further detail below. They basically perform attribute predictions and store the results on some tables that will be entropy encoded afterward. Note for now that the encodeAttributes procedure computes the predictions, for the attributes using the primary index table, for the given corner.

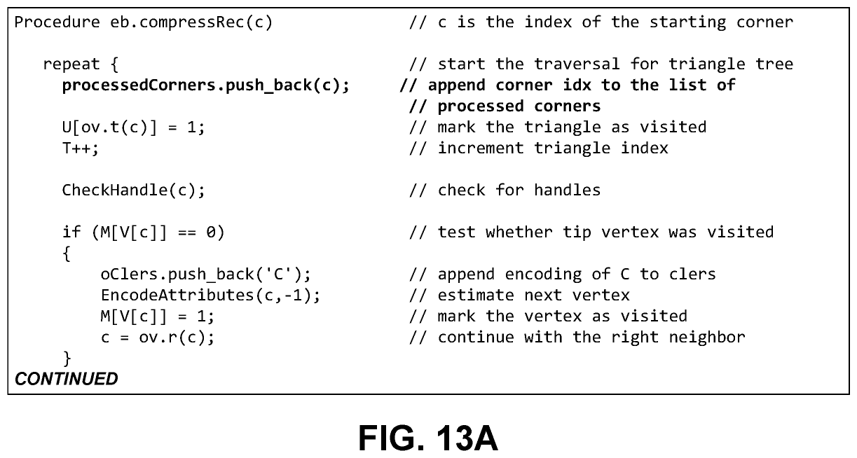

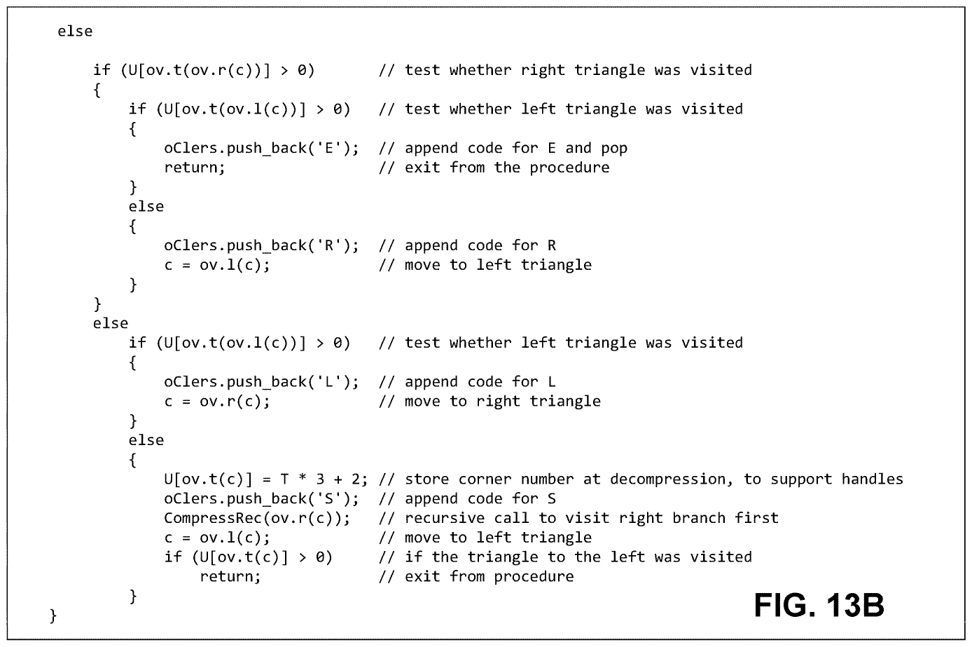

FIG. 13 illustrates the procedure compressRec. The table oClers is the output table of CLERS symbols. Features described in particular detail herein are shown in bold lettering. This procedure is the core edgebreaker algorithm to encode a CC. Processed corners are added into the table named processedCorners.

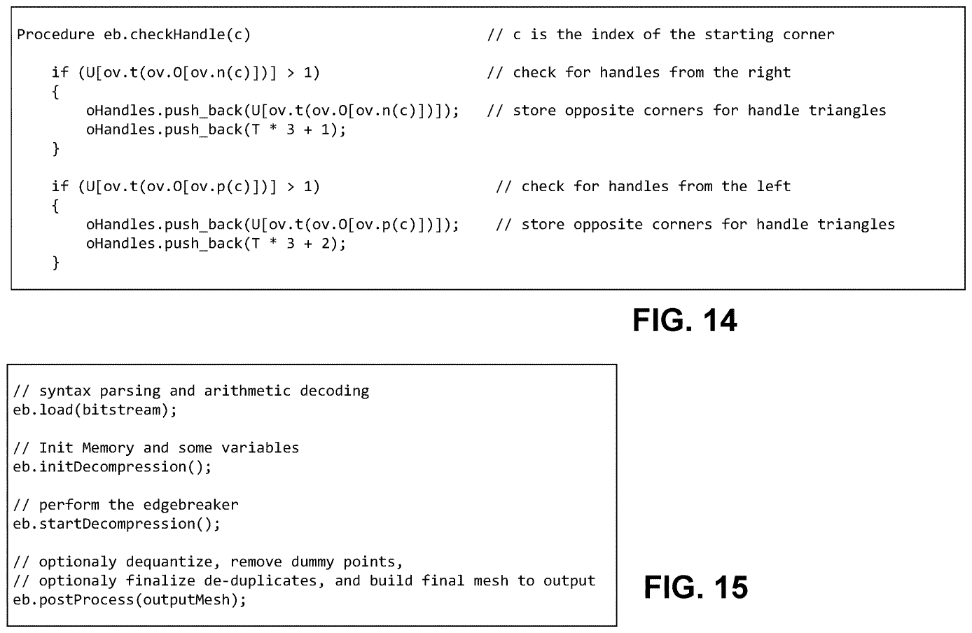

FIG. 14 illustrates the procedure checkHandle.

Given the foregoing description of how to construct the CLERS and Handles table at the encoding stage, the following description describes example embodiments for reconstructing, at decoding, the mesh topology from those tables to recreate the corner table.

### Overview of Decoding Procedures.

FIG. 15 illustrates an example decoding entry point procedure. Features described in particular detail herein are shown in bold lettering. The procedure includes several steps that perform respectively the syntax parsing and arithmetic decoding of the input bitstream, its edgebreaker decoding using a corner table and finally some post-processing one the corner table to produce the final mesh in an indexed face set data structure. In this section we will only devise the edgebreaker decoding procedures (initDecompression and startDecompression) and the sub-procedures related to topology decoding. Parsing and entropy decoding will be described in further detail below.

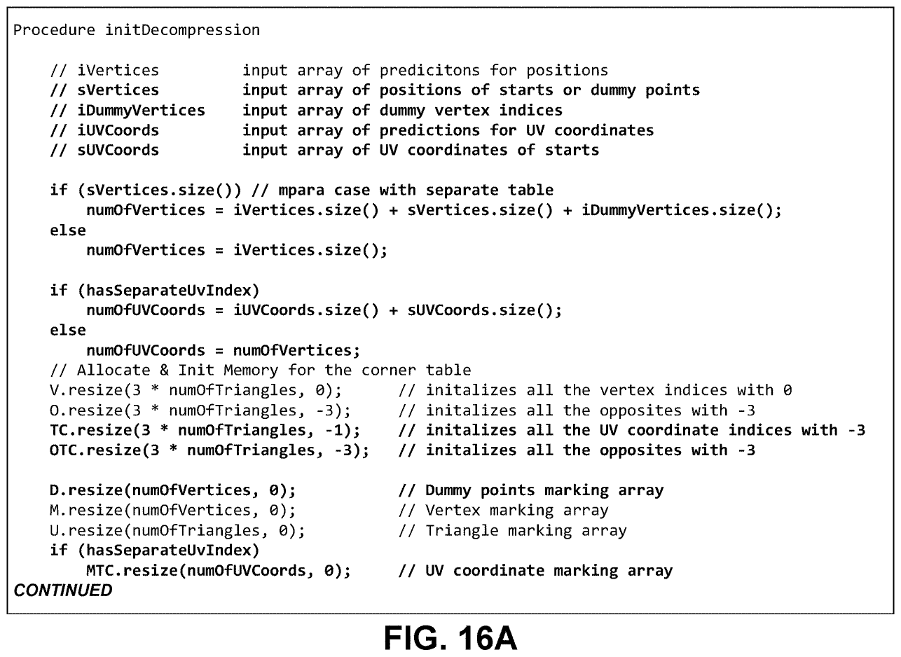

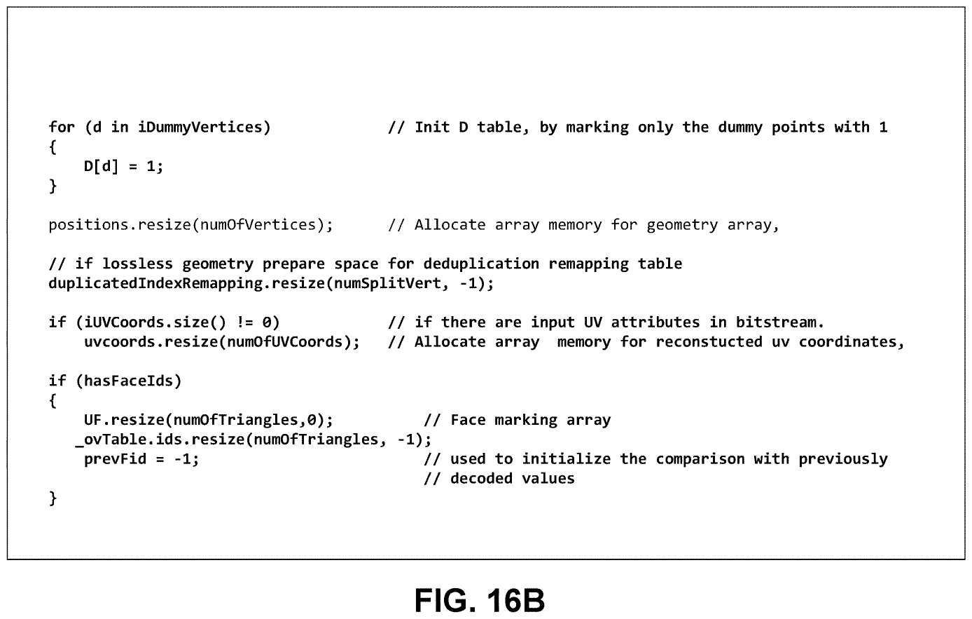

FIG. 16 illustrates the procedure initDecompression, which allocates memory to store decompression outputs and initializes other marking tables. Features described in particular detail herein are shown in bold lettering. In the initDecompression procedure, a “start” is a point for which there is no prediction, hence its attributes are stored in a separate table containing global values (sVertices, sUVCoords). In counterpart, attributes that are predicted are stored in other input tables iVertices and iUVCoords. Those tables will be described further below.

The present section describes example tables that are used for the topology decoding (V, O, TC, OTC, D, M, U, MTC and duplicatedIndexRemapping). The values that are used to initialize O, TC, OTC and D are recorded since those conditions are used to permit the proper execution of the algorithm later on. Example embodiments include tables to handle the texture coordinate attributes (which are extended the same way in some embodiments for normal and colors per vertex), the attributes with separate index tables (see hasSeparateUvIndex statement) and finally the deduplication remapping table. We also added the handling of dummy point.

FIG. 17 illustrates an example procedure startDecompression. Features described in particular detail herein are shown in bold lettering. The procedure startDecompression, which starts the decoding, is invoked following initDecompression initialization stage.

Example embodiments provide for the handling of CCs using offsets. Then, for each CC, after the connectivityDecompression and the attributesDecompression stages, the vertex indices and UV coordinates indices are shifted back to make them valid in the global index space. This process may also be extended in some embodiments to any other attribute types. Example embodiments further include a deduplication post processing which will be described in further detail below.

### Decoding Connectivity Recursion.

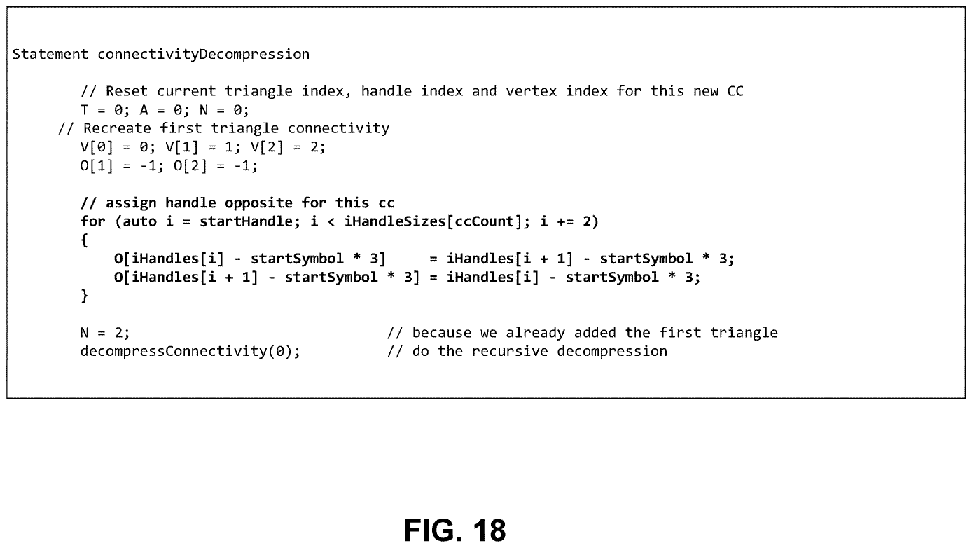

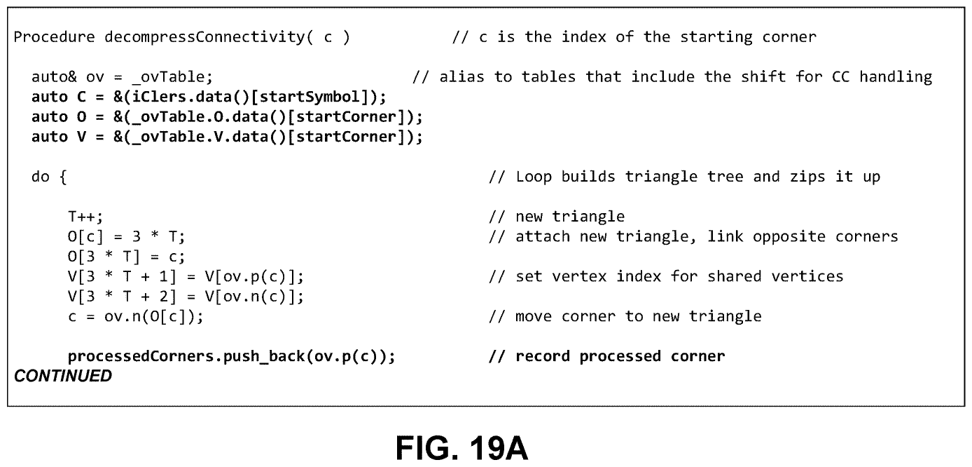

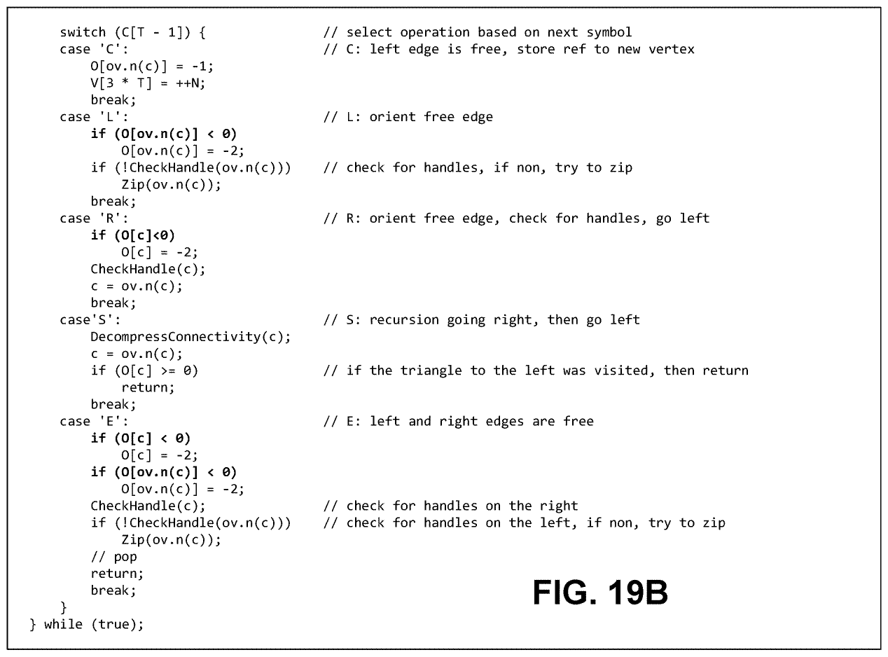

FIG. 18 illustrates the statement connectivityCompression. Features described in particular detail herein are shown in bold lettering. The connectivityDecompression statement presented in FIG. 18 may be inserted in place in the pseudocode of FIG. 17 so it accesses the setup variables. The statement is executed for each CC. In this logical block, the algorithm initializes the opposite corners of the CC handles using techniques such as those described in H. Lopes, G. Tavares, J. Rossignac, A. Szymczak and A. Safonova, “Edgebreaker: a simple compression for surfaces with handles,” in ACM Symposium on Solid Modeling and Applications, Saarbrucken, 2002. Example embodiments further add the first corner (of index 0) in the table of processedCorners. We finally reconstruct the connectivity of the first triangle and start the connectivity decompression recursion, described with reference to FIG. 19.

FIG. 19 illustrates the example procedure decompressConnectivity. Features described in particular detail herein are shown in bold lettering. In example embodiments, the decompressConnectivity procedure supports shifts to manage CCs, and the procedure includes the history recording for the processed corners. The procedure further provides support for opposite corners to support handles using, for example, techniques described in H. Lopes, G. Tavares, J. Rossignac, A. Szymczak and A. Safonova, “Edgebreaker: a simple compression for surfaces with handles,” in ACM Symposium on Solid Modeling and Applications, Saarbrucken, 2002.

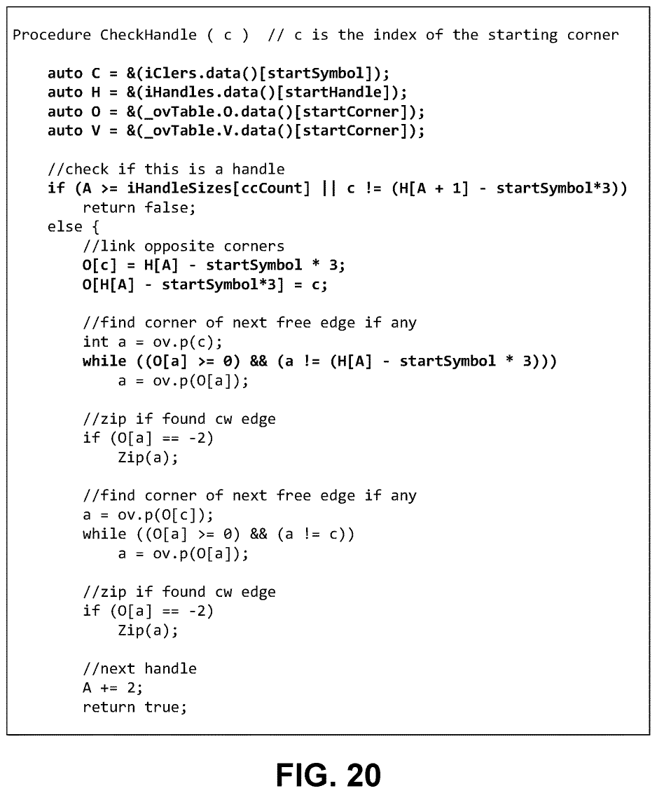

FIG. 20 illustrates an example of the CheckHandle procedure to support shifts. The Zip procedure makes use of the shifted tables O and G (the code is not presented here).

At the end of the connectivityDecompression statement (see FIG. 17), the connectivity is reconstructed and can be used together with the predicted attributes residuals that were previously entropy decoded to reconstruct/estimate the attributes. This next step is described in the following section.

### Decoding Attributes Recursion.

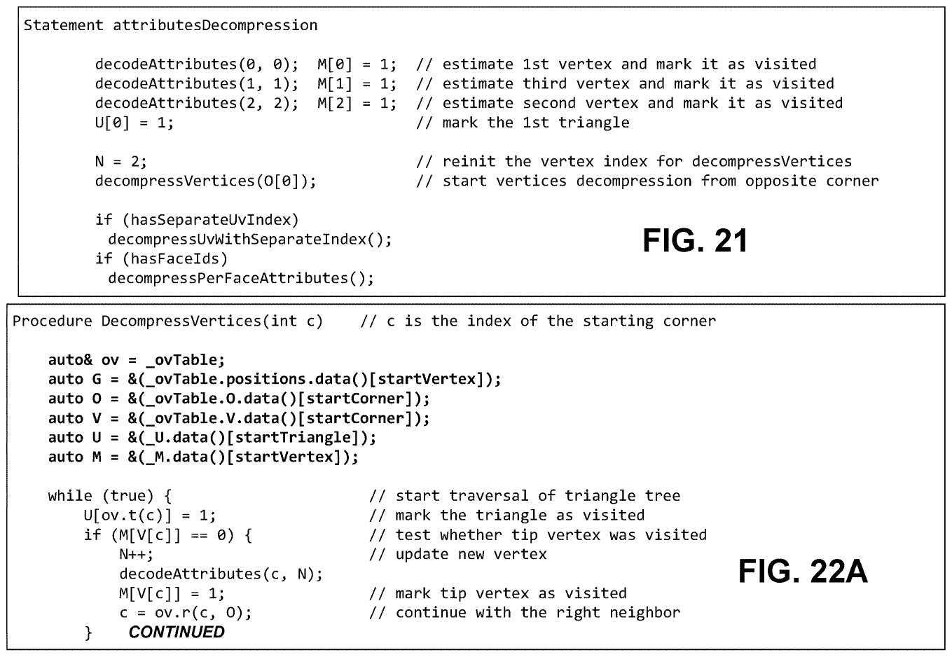

FIG. 21 illustrates the statement attributesCompression. The attributesDecompression statement may be inserted in place in the pseudocode of FIG. 17 so it accesses the setup variables. The statement is executed for each CC. In this logical block, we first reconstruct the attributes of the first triangle using decodeAttributes and recursively reconstruct the attributes of the other triangles by calling decompressVertices. This first step only works on attributes using the main index table.

In a second recursion we optionally reconstruct the attributes dereferenced by secondary index tables. Those are implemented after the first recursion has terminated before being processed because they rely on its output data. The presented code illustrates the second step for UV coordinates, invoking the decompressUvWithSeparateIndex procedure. Extension to other types of per-vertex attributes such as normal vectors or color per vertex is also performed in some embodiments. The prediction scheme at lower level is adjusted accordingly.

Some embodiments further include a third recursion in which the per face attributes are reconstructed, as described in further detail below.

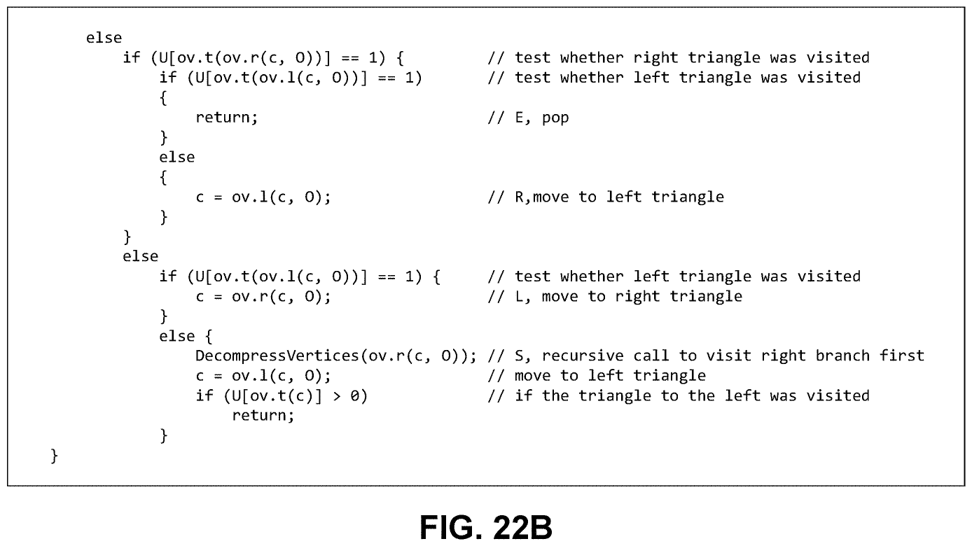

FIG. 22 illustrates an example of the procedure DecompressVertices. The procedure uses shifted tables to handle CCs. The recursion goes through the triangle tree and reconstruct the attributes when needed by invoking the decodeAttributes procedure.

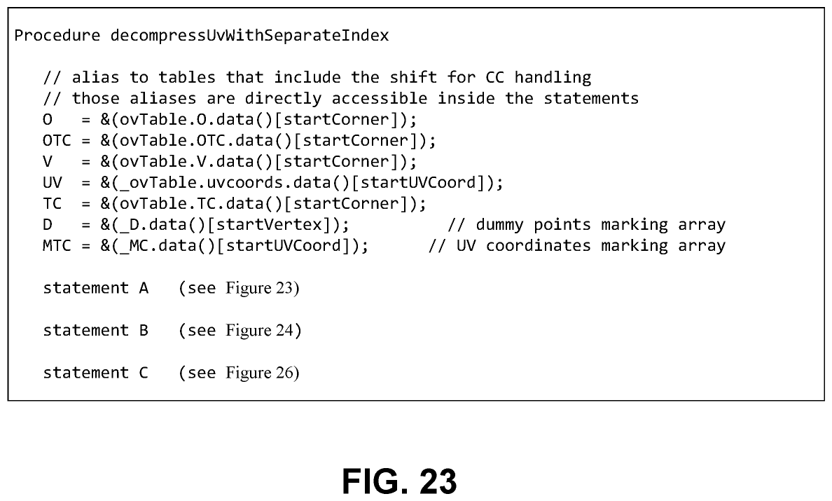

FIG. 23 illustrates an example of the procedure decompressUvWithSeparateIndex. It behaves differently from decompressVertices by handling the texture seams using the secondary index tables, TC and OTC.

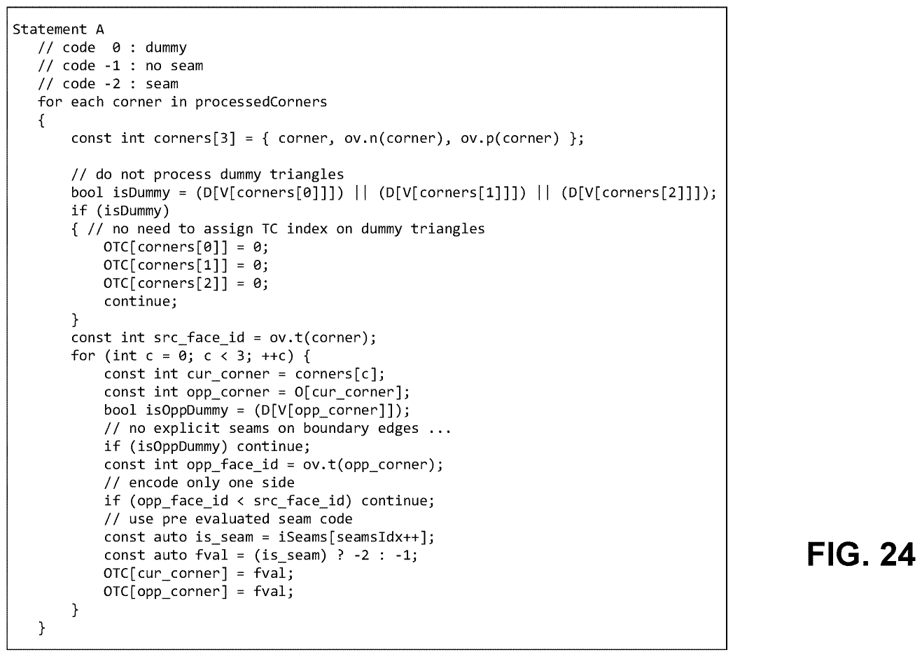

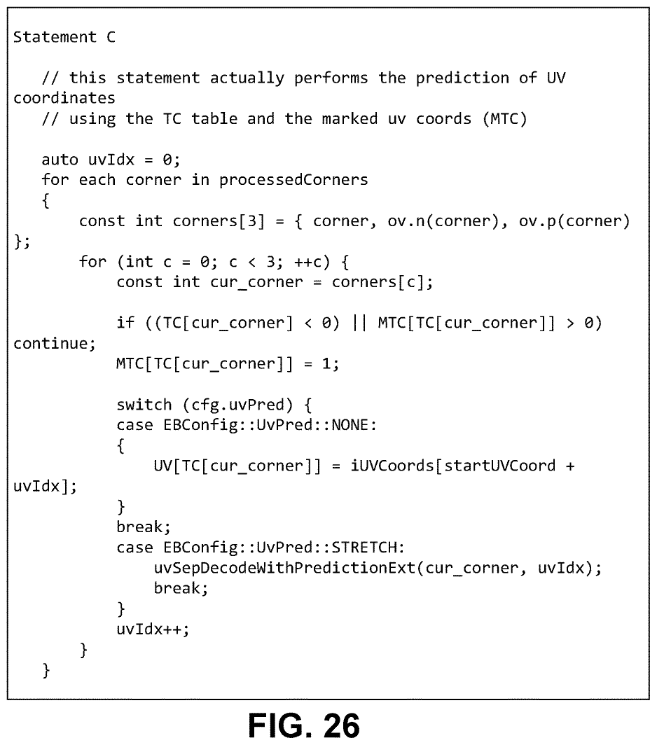

The procedure is decomposed in three successive statements; statement A, shown in FIG. 24; statement B, shown in FIG. 25, and statement C, shown in FIG. 26. Each one of these performs a loop on the processedCorners. In some embodiments, the order of corners is implicitly found as in the decompressVertices procedure, in which case the processedCorners table may not be necessary. However, the table is shown in this example for ease of coding and explanation.

With reference to FIG. 24, using the iSeams table (that comes from the bitstream), the recursion of statement A first assigns a code in [0, −1, −2] to each corner of the OTC table to identify if they are on a seam or if UV coordinates will be identical on each side of the edge. In the first case, different UV indices are used for each side of the edge. Note that the example embodiment also skips the eventual dummy points inside this loop. It is not necessary to reconstruct a full opposite table OTC (in the sense of connectivity as for table O), the table may be used only to store the codes for statement B.

With reference to FIG. 25, in a second pass, the recursion of statement B exploits the codes from pass A to assign the UV coordinate indices to the corners by swinging around those. This pass populates the table TC with the UV indices. During the loop, corners already visited or associated with dummy points are skipped.

In a final pass, with reference to FIG. 26, the recursion from statement C computes the final UV coordinates using the TC table and the MTC table to mark the UV coordinates already processed. If the bitstream was coded without predictions (cfg.uvPred=NONE), the value of the table iUVcoords is copied as is into the UV table using the CC shift. Otherwise, the UV coordinates are predicted using the uvSepDecodeWithPredictionExt procedure as described below.

### Decoding Post-Processing.

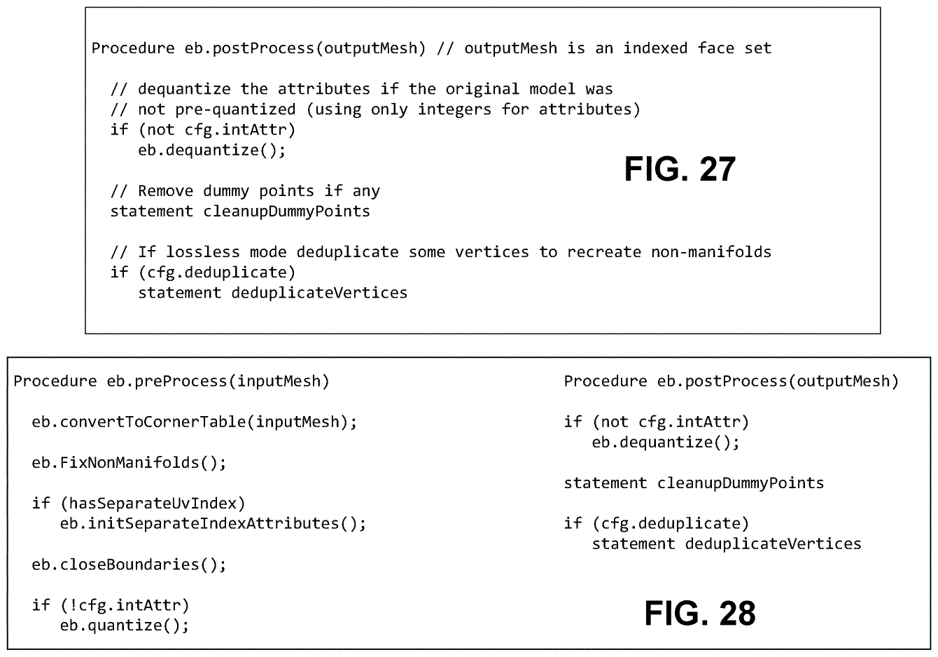

At the end of the startDecompression procedure, as described in FIG. 15, the connectivity and the attributes are decoded. In some embodiments, additional post processing steps are performed to finalize the mesh. The postProcess procedure is depicted in FIG. 27. The different parts of this procedure are described below symmetrically to the preProcess procedure (see FIG. 28).

FIG. 27 illustrates an example of the procedure postProcess, which converts the reconstructed CT mesh into an indexed face set while removing the dummy points, and optionally recreates non-manifolds if lossless coding is used.

Example pre-processing and post processing steps are shown in more detail in the following section.

### Pre-Processing and Post-Processing.

In some embodiments, pre-processing is performed to convert some standard indexed face set mesh into a corner table representation for efficient use by the edgebreaker algorithm optimized to run on corner table. An indexed face set mesh is also known as face-vertex mesh. Those are traditionally stored into “.obj”, “.ply” or other common file formats that store triangle meshes. The face-vertex representation is also the one that is ingested by graphics hardware for rendering. Converting to a corner table may be performed using known techniques. However, while converting to the CT representation, example embodiments also perform the filtering of non-manifold vertices and edges, as described below. Example embodiments also introduce virtual dummy points and dummy faces to fill eventual holes of the input mesh, as described below. Symmetrically, at the decoding, the eventual dummy points are removed, and the non-manifold connectivity is re-created in case of lossless mode. FIG. 28 presents an overview of example pre and post processes side by side. Quantizing and dequantizing processes may be performed using standard uniform quantization mechanisms. In some embodiments, quantizing and dequantizing are not performed, for example in embodiments that code pre-quantized meshes (e.g. meshes with all integer attributes).

FIG. 28 illustrates side by side preProcess and postProcess procedures. The comments and captions of FIGS. 10 and 27 provide additional details respectively on pre- and post-processing. In some embodiments, optional actions for deduplicates are also performed during the pre-processing within the fixNonManifold procedure.

### Non-Manifold Filtering.

Some meshes, coming from 3D reconstruction from scanners for instance, may have some “incorrect” connectivity in the sense that it does not have a manifold topology that can be processed using standard edgebreaker coding. For example, the surface described by the triangles may be non-manifold at some vertices or edges and thus subject to processing as shown in FIGS. 9 and 10. The purpose of the filtering is to fix those issues to allow for edgebreaker coding. In some embodiments, this is performed by duplicating selected vertices so the triangles sharing a non-manifold edge or vertex do not share the same edge or vertex anymore.

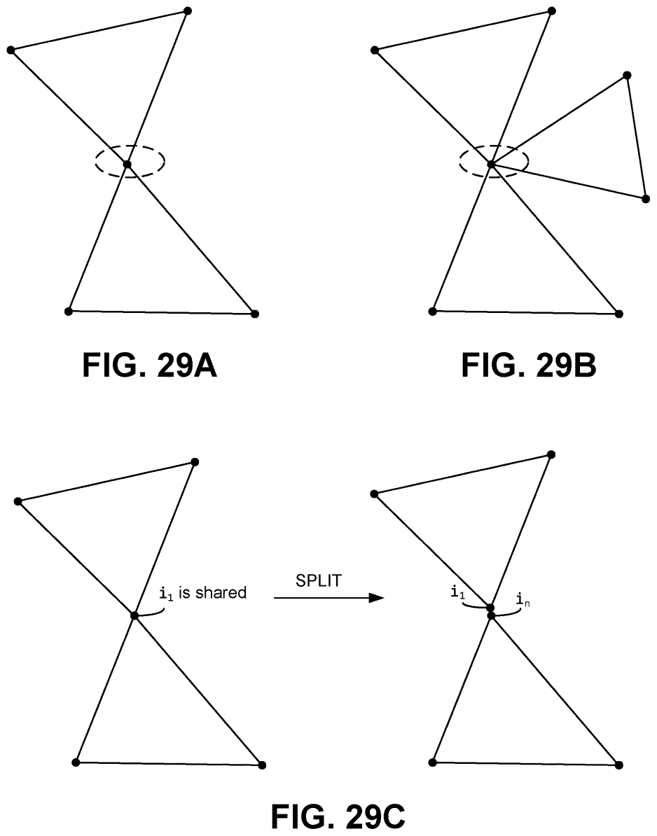

FIGS. 29A and 29B illustrate meshes with non-manifold vertices. The non-manifold vertices are indicated with a dashed oval.

FIG. 29C illustrates an example technique for fixing the issue by splitting the vertices.

In the example of FIG. 29A, one vertex (say, of index i₁ in the vertex table) is shared by the two triangles but those triangles do not share any edge (hence, the vertex is non-manifold). Example embodiments fix this non-manifold issue by duplicating the common vertex, creating a new vertex with the same 3D position and same attributes, this new vertex will be added to the vertex table and be of index iₙ in this table. In this case, one face description refers to i₁ and the second to iₙ. (For visibility, the vertices i₁ and iₙ are illustrated in FIG. 29C as having slightly different positions after splitting, but it should be understood that the positions of vertices iₜ and iₙ, as represented in a table of attributes, may be the same after the split.) After processing, the faces are not connected any more, so there will not be a non-manifold issue. In the present example it will result into two connected components (CC), each one made of only one triangle (a “connected component” is a set of triangles for which there always exists a path of connectivity to reach other triangles of the component). By doing this duplication, we see that we may generate multiple connected components.

When the approach for fixing non-manifold vertices is applied to non-manifold edges, some surface continuity issues can arise. With reference to FIG. 30, a single non-manifold edge is shared by three triangles. If we duplicate the vertices of the non-manifold edge, the faces will not be connected anymore. If the face T1 and T2 were part of a larger connected component, this would introduce a “crack” in the surface of the mesh. In addition, duplicating all those vertices introduces more vertex data to encode. As illustrated in FIG. 30, in an example embodiment, a re-stitching method may be performed to rejoin two of the three surfaces that would result from duplicating the non-manifold vertices. (For clarity, duplicated vertices are illustrated as having slightly different positions, even though the splitting and stitching process does not change the position attributes of the vertices.) As a result of the stitching process illustrated FIG. 30, faces T1 and T3 are stitched together into a single manifold surface, while T2 remains a separate manifold surface.

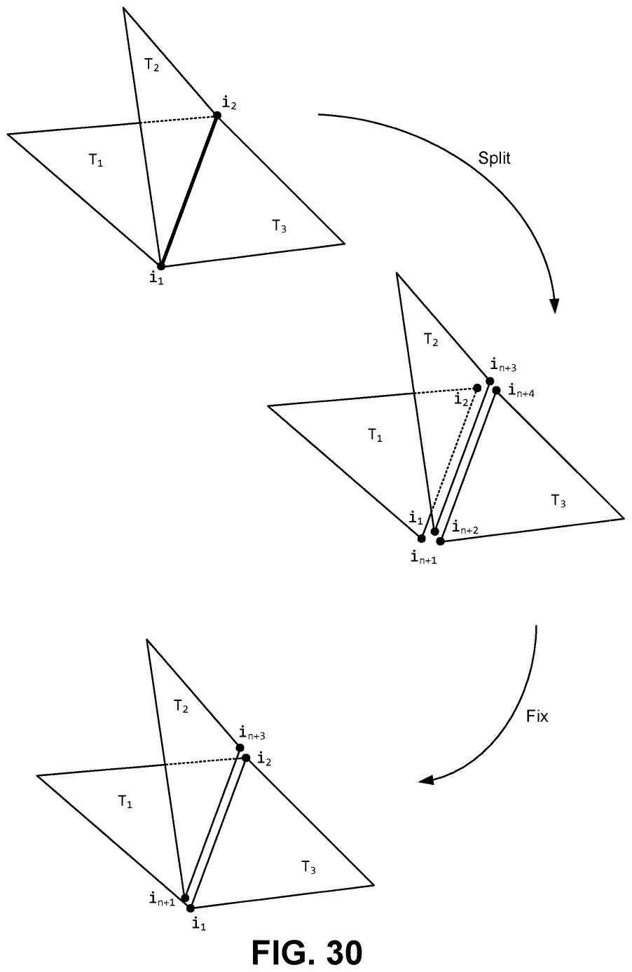

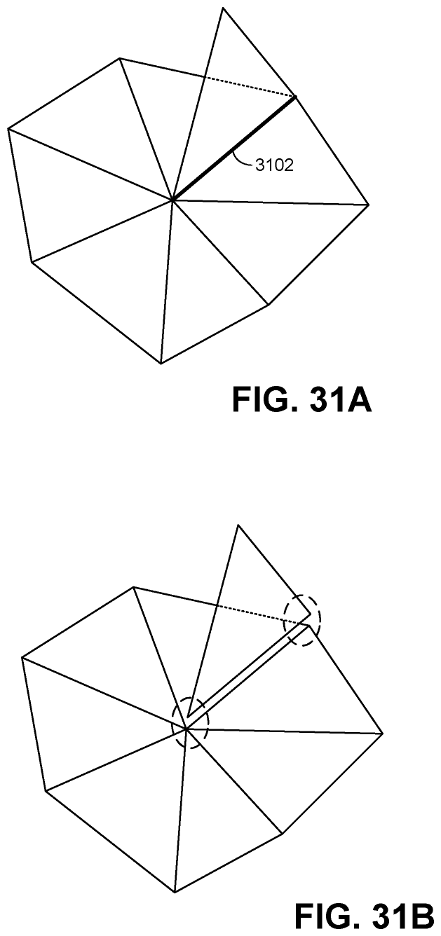

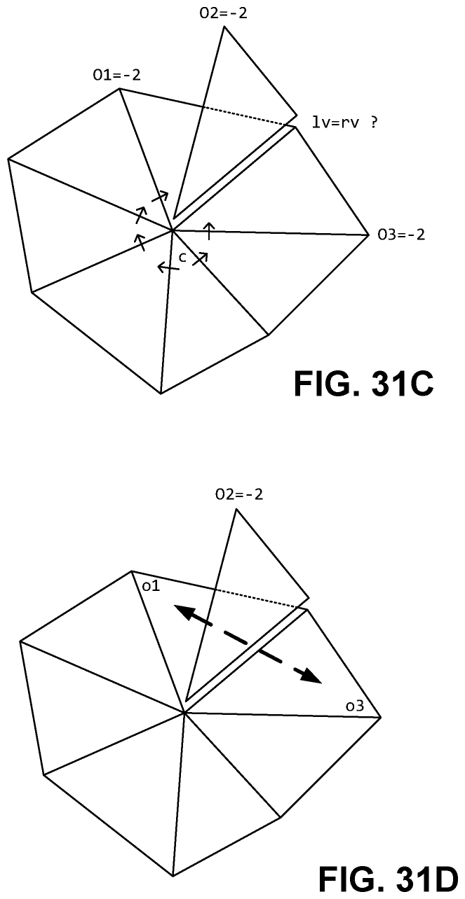

FIGS. 31A-31D illustrate filtering of a non-manifold surface according to some embodiments. An example technique may be referred to as cutting and re-stitching. As zshown in FIG. 31A, triangle connectivity on a non-manifold edge 3102 is cut by resetting opposite corners to −2 (or to another predetermined value as appropriate). Vertices are duplicated if needed, as shown in the dashed ellipses of FIG. 31B, where only the vertices of the top triangle are duplicated (for the sake of illustration, the duplicated vertices are shown at a slightly offset position, though the position attributes of those vertices may not in fact be changed by the duplication process). As shown in FIG. 31C, the process swings right and left from the visited corner c. As shown in FIG. 31D, opposite corners are re-stitched when left vertex index lv equals right vertex index rv and o1=o2=−2.

Some example embodiments perform a vertex duplication operation to remove one or more non-manifold edges. Subsequently, a pre-processing step is performed that fixes the newly introduced holes when possible through a re-stitching process. This reduces or eliminates the need to handle specific cases during the rest of the process, which simplifies the implementation of edgebreaker and reduces the number of dummy points, the number of UV seams (since a geometry seam necessarily introduces a texture seam) and impact on the edgebreaker.

In some embodiments, such a method may be performed as follows. identifying at least one non-manifold edge in a mesh; duplicating vertices along the non-manifold edge to separate the non-manifold edge into at least two manifold edges; stitching together two of the at least two manifold edges; and after stitching together two of the at least two manifold edges, encoding the mesh using edgebreaker coding.

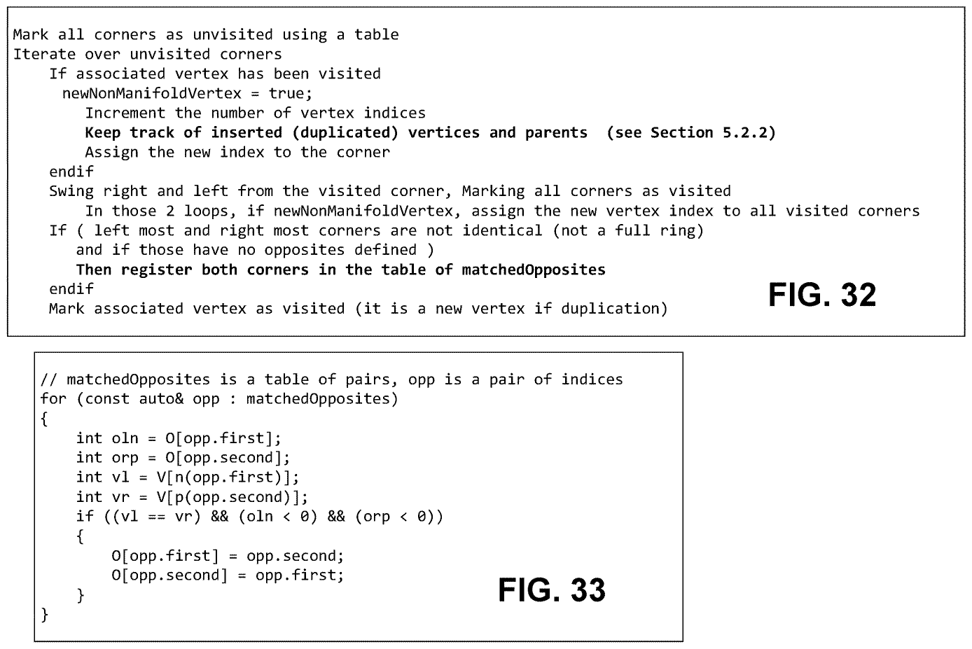

In some embodiments, the non-manifold filtering stage (illustrated by FIGS. 31A-31D) occurs during the pre-processing as follows. The mesh is filtered for non-manifold surfaces. The triangle connectivity of non-manifold surfaces is cut by re-setting the O table for some corners, setting the O value to −2 at appropriate corners. Vertices are duplicated if needed. Triangle connectivity is re-stitched if appropriate by amending the O table. The filtering of non-manifold surfaces may be performed using known techniques, such as in the Google Draco system. In example embodiments, a “re-stitch” stage is performed to reconnect some triangles. This also allows for re-creating a non-manifold surface in case of lossless coding. Example embodiments further include a stage of duplicating vertices. The “duplicate vertices” stage is depicted in FIG. 32. Features described in particular detail herein are shown in bold lettering. The bolded features include features for handling de-duplicates for lossless mode and for re-stitching. To summarize, example embodiments keep track of the index of added vertices (for the lossless case) and store a table of pairs of corners to “re-stitch” those at the end of the process in a last pass as shown in FIG. 31C and FIG. 33. FIG. 33 illustrates an example pre-processing operation of re-stitching using the table of matched opposites.

### Non-Manifold Filtering, Lossless Case.

In some embodiments, lossless coding of the input mesh is performed to reproduce exactly the connectivity, including the non-manifold issues. As shown in the previous section, example embodiments keep track of inserted (duplicated) vertices and the original vertices (referred to here as parents of the inserted vertices) in a table during the pre-processing. Some data representing those duplicates is provided in the bitstream and then used during the decoding (at several stages) to reconstruct the exact connectivity if needed.

The availability of a lossless mode for connectivity as described herein provides at least two benefits. First, it allows for a fully lossless coding mode for both connectivity and attributes. Second, in some cases, lossless coding of the mesh allows for higher coding gains even when lossy coding is used for the mesh as a whole (e.g. for the attributes). These gains may be the result of avoiding replicated vertices during the subdivision process of the coding and then for the displacements coding. The lossless coding of the mesh may also enhance the motion coding.

An example encoding method includes: identifying at least one non-manifold edge in a mesh, the non-manifold edge being defined by parent vertices; preprocessing the mesh by duplicating parent vertices along the non-manifold edge to separate the non-manifold edge into at least two manifold edges, each manifold edge being defined by child vertices, each child vertex being duplicated from a respective parent vertex; encoding the preprocessed mesh into a bitstream using edgebreaker coding; and providing in the bitstream information identifying, the parent vertex of the child vertices.

An example decoding method includes: obtaining from a bitstream information defining a plurality of connected components of an edgebreaker-coded non-manifold mesh; obtaining from the bitstream information associating child vertices with parent vertices; at least partially decoding at least two of the connected components, each of the connected components having child vertices associated with respective parent vertices; and deduplicating the child vertices to reconstruct the non-manifold mesh.

At the encoding stage, when positions are duplicated (potentially recursively) by the non-manifold filtering, example embodiments keep track of vertices having the same original parent. A unique identifier (e.g. ranging from 1 to the number of vertices ultimately added) is assigned to each vertex index that is associated with a vertex that has been duplicated. This information may be stored for instance in a map of duplicates (duplicatesMap) with each entry associating such an identifier with a duplicated vertex index. To populate the map of duplicates, when a vertex is added to the map, it is determined whether the parent is already in the map. In one case, the parent was already in the map, associated with a unique identifier. In an alternative case, both the parent and the added vertex are added to the map, associating those with a new identifier (which may be the current number of split vertices).

The number of split vertices is the number of original position indices that are duplicated in the process. The total number of entries in the duplicatesMap map at the end of the process is (num split vertices+num added vertices).

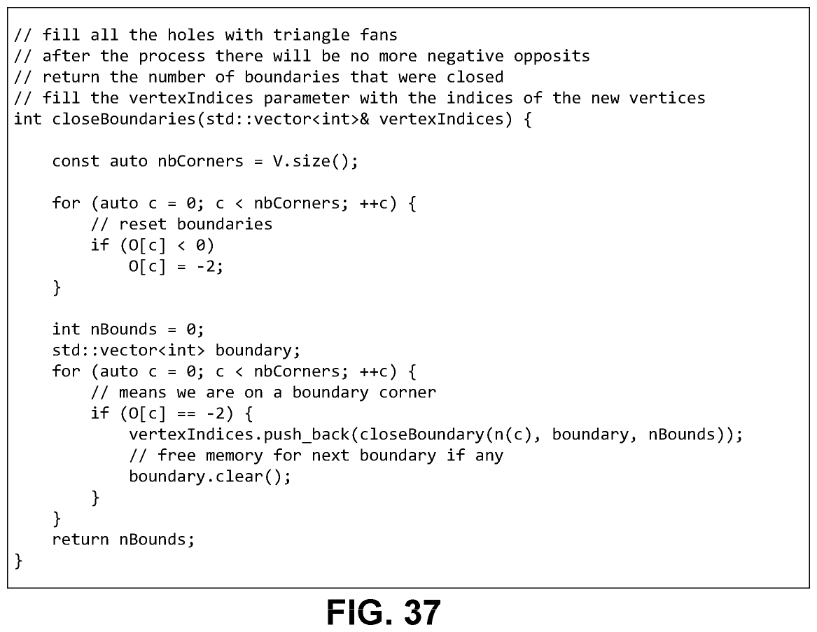

When the topology is traversed during encoding of the attributes using main index table (see FIG. 37), when split or added vertices are encountered, registration is performed of the processed corner index and the corresponding unique split vertex index. Some embodiments us an oDuplicateSymbolIdx array, which stores the processed corner index, and an oDuplicateSplitVertexIdx array which stores the unique split vertex index. As the processedCorners array is updated per triangle (and not for the two first vertices of any connected component), some embodiments additionally store Boolean values indicating if there is a duplicated vertex on the first two vertices of the first triangle of any connected component. Example embodiments thus additionally use an array of Booleans of size (2*connected components) named oDuplicatesOnStart.

Example embodiments then signal some or all of the following information in a bitstream:
The size of the oDuplicateSymbolIdx array=num split vertices+num added vertices
The integer array oDuplicateSymbolIdx of size oDuplicateSymbolIdx. (Of course, this or any other software-implemented feature described herein may be given a name other than the name used in this disclosure. For example, the integer array oDuplicateSymbolIdx may alternatively have a name such as perDuplicateProcessedCornerIndices). Some embodiments allow for up to three duplicates associated with the first processed corner index of any connected component (one corner for each of the three vertices of the first triangle of those). In some embodiments, this may be delta coded and inserted as a variable unsigned integer.
The integer array oDuplicateSymbolIdx of size oDuplicateSymbolIdx, which provides a unique value for each group of vertices duplicated from a parent vertex that has been split (including the original parent) encoded as variable such as an unsigned integer.
A Boolean array of size 2*(number of connected components), which may be coded using Dirac arithmetic coding coded as follows:
   variable unsigned int for dup01_encoded_size the size in bytes of the dup01Buffer containing AC encoded flags to signal duplication at positions 0 or 1 in each CC (2*nbCC bits before encoding)
   dup01_encoded_size bytes containing the encoded buffer.

Alternatively or additionally, example embodiments signal some or all of the following information in a bitstream:
A Boolean indicating if the vertex is duplicated, per the “encodeAttributes” position procedure call.
Then a Boolean to indicate this is the first occurrence.
If not first occurrence, the index of parent split vertex in a table of base split vertices.

In some embodiments, that information is arithmetically encoded. The amount of information encoded in the stream may be reduced using this approach when there is many split (this would have to be checked). In addition, the Boolean array (a) could be encoded only for CCs containing duplicated vertices, adding another level of indirection where a first string of bits should define which CCs includes duplicated vertices, but would reduce the size of the (a) array removing potentially ranges with constant false value.

In some embodiments, a determination is made of which encoding method results in the smallest bitstream, the mesh is encoded using that selected method, and an indication of the method used is signaled in the bitstream.

In some embodiments, to prevent encoding duplicated positions two or more times, the process returns from encodeAttributes without computing related residuals in response to a determination that a duplicated vertex has already been processed. The corresponding function is also performed in the decoder. Such embodiments are particularly useful for improving performance in the case of meshes with many splits.

The position topology of the input mesh is losslessly reproduced after encoding/decoding when using this deduplicate option. In some embodiments, the same technique is used to enable deduplication of attributes.

At the decoder side, the decoder obtains data such as iDuplicatesOnStart, iDuplicateSymbolIdx, iDuplicateSplitVertexIdx, and cornerIndex (which may alternatively be called currentDuplicateIndex or any other arbitrary name).

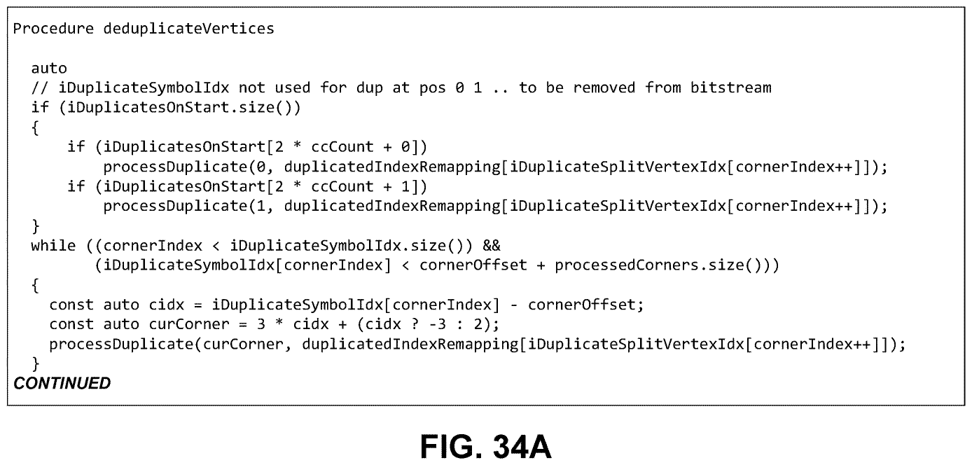

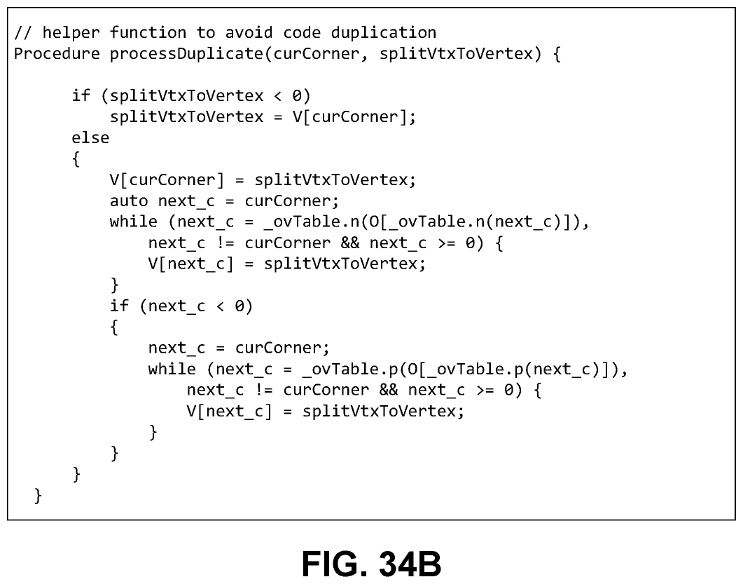

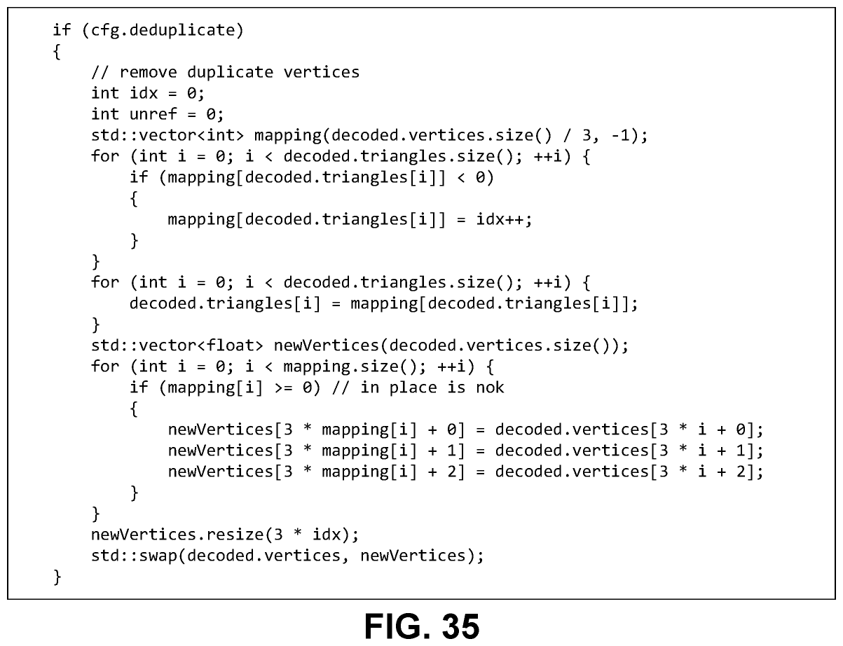

During decoding (see FIG. 17) an update is performed inside the deduplicateVertices procedure (see FIG. 34), and the index of the processed corner (adding offsets per CC as processedCorners is emptied after each CC). The decoder may then check whether the current corner is associated with a duplicate vertex (including the additional checks for the two first vertices of each CC, or using alternative techniques). The decoder then assigns a single index to each of the duplicated vertices iₙ the processDuplicate procedure. FIGS. 34A-34B illustrate examples of the procedures deduplicateVertices and processDuplicate. When first called with a given split vertex index, the current vertex index is associated to the split vertex index. On subsequent calls with a given split vertex index, the registered index corresponding to the first occurrence of the duplicated vertex is used to replace the duplicated index. Before the conversion of the CT to an indexed face set, this data is used to regenerate the non-manifolds by de-duplicating some vertices. An example of this process is illustrated in FIG. 35. Virtual dummy points for meshes with boundaries.

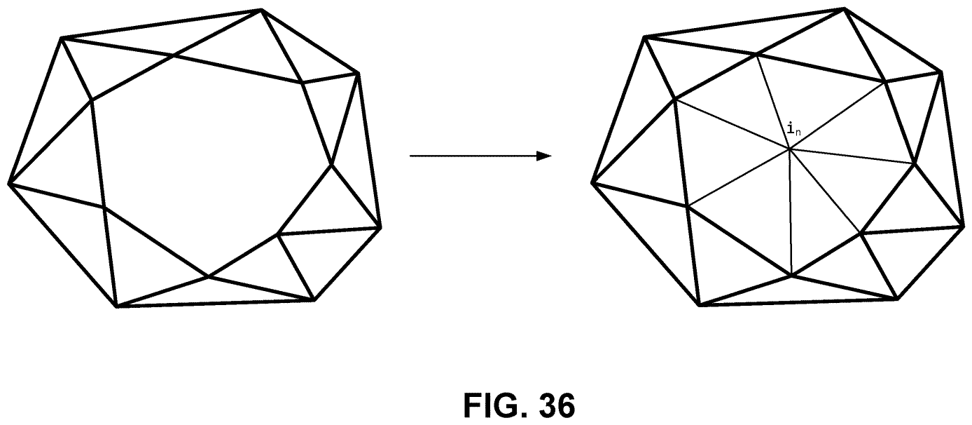

FIG. 36 illustrates a process in an example embodiment in which a hole in the surface of a mesh is filled with a dummy vertex and dummy triangles. The dummy point is given the index in the vertex table. The mesh on the left includes a central hole. As shown on the right, that hole is filled by adding vertex iₙ and fanning out triangles to fill the hole.

One known method of handling meshes with boundaries (also named meshes with holes) is to fill each hole with a dummy point and connect this new vertex to the border of the hole using a fan of triangles. The mesh is then encoded/decoded as if no hole was present. Some data to express which points are dummy is encoded in the bitstream so the point and its associated dummy triangles (from the fan) can be removed after the decoding. In such techniques, the dummy points are generally encoded using fake attribute values (usually from interpolation).

In example embodiments of the present disclosure, a process of filling holes with dummy points is performed after non-manifold filtering because the non-manifold filtering may itself introduce holes in the surface. Furthermore, example embodiments track the indices of dummy points and do not encode attributes (e.g. position, UV coordinates, color, etc.) of the dummy points. Example embodiments thus do not use fake attributes of the dummy points when predicting the attributes of non-dummy points.

In an example embodiments, dummy triangles are encoded but not the attributes (position, UV cords, etc.) of the dummy point. Interpolated attributes are not used to compute the predictions. Rather, some embodiments keep track of dummy points indices and skip those during predictions.

An example encoding method comprises: preprocessing a mesh having a hole by creating a dummy vertex, the dummy vertex being connected to each vertex along a perimeter of the hole; encoding the preprocessed mesh in a bitstream with edgebreaker coding; encoding in the bitstream information identifying the dummy vertex; and encoding at least one attribute for each of a plurality of vertices in the preprocessed mesh, wherein the attribute is not encoded for the dummy vertex.

An example decoding method comprises: obtaining from a bitstream information encoding a mesh; obtaining from the bitstream information identifying at least one dummy vertex in the mesh; and decoding from the bitstream attribute information for a plurality of vertices in the mesh, wherein attribute information is not decoded for the at least one dummy vertex.

In some such embodiments, decoding attribute information for a plurality of vertices comprises predicting attribute information for a plurality of the vertices, wherein no attribute information is predicted for the dummy points. The decoder may remove the dummy points.

Example embodiments are capable of handling meshes with and without separate UV coordinates index tables. Some encoders, such as the VDMC encoder, use base meshes with separate index tables and the geometry is made up of small number of closed meshes (eventually with holes but most of time closed), not of mesh patches. Hence, the economy of not encoding the first boundary is not significant in some embodiments.

As for the handling of “virtual” dummy points, an example procedure to handle the dummy points according to some embodiments is depicted by FIGS. 35 and 36.

In an embodiment where the attributes use the primary index table, the pre-processing procedure includes filling the holes by adding new corners and triangles in the corner table and setting up the connectivity. A table of indices of dummy vertices is stored in memory as well as some additional positions, and other optional attributes in the attribute tables (this attribute data is just used to fill the gaps, example embodiments use zeros). During the connectivity coding/decoding using edgebreaker, the connectivity is used as is, including the dummy triangles. For better prediction of other vertices and economy of data in bitstream, this table is used to skip the dummy point attributes during the attribute predictions at encoding and decoding.

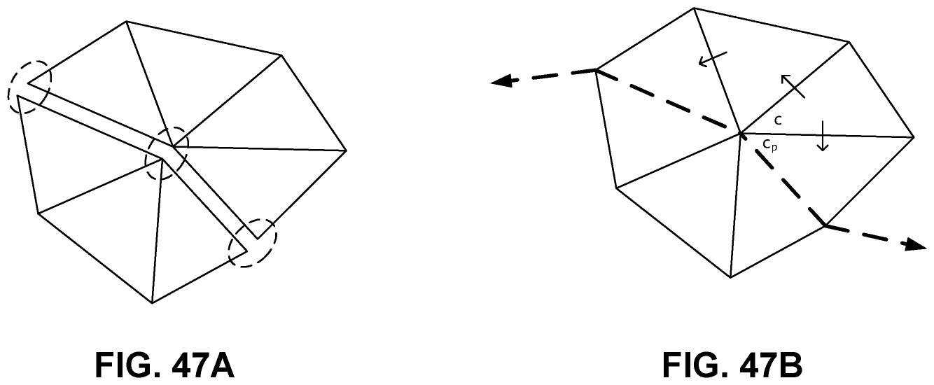

In an embodiment where attributes use a separate index table, different treatments are performed on the corner table. Such embodiments do not recreate a connectivity but rather just initialize the new TC elements with −1 and the new OTC with −(index of boundary+4) so that each added corner has attributes table TC and OTC marked as special elements, which may be handled like seams. (FIG. 47 illustrates an example of a texture seam).

FIG. 37 illustrates an example of a C++ procedure to fill all the holes of a mesh described as a corner table (O, V, OT, OTC).

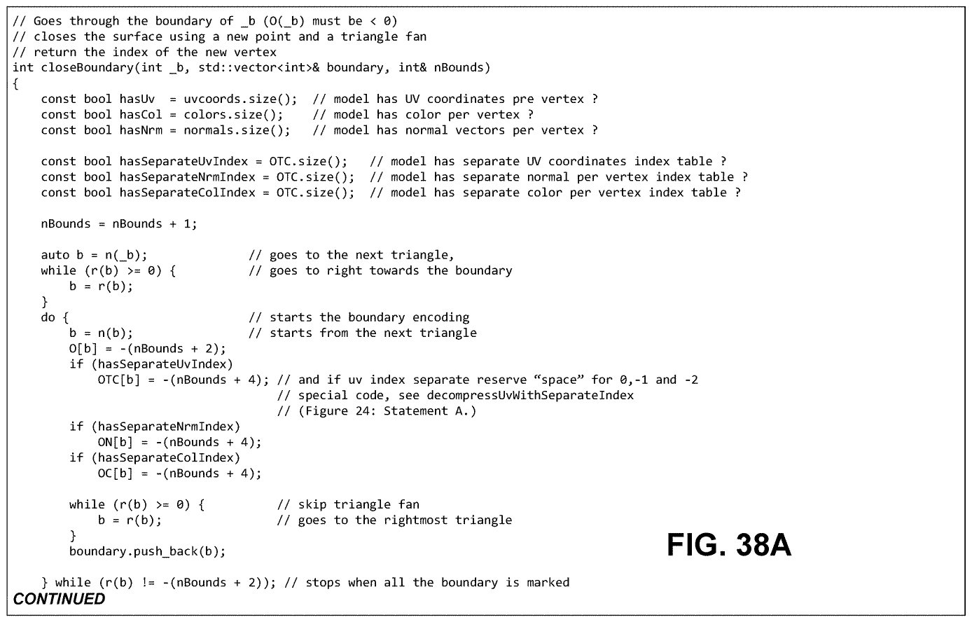

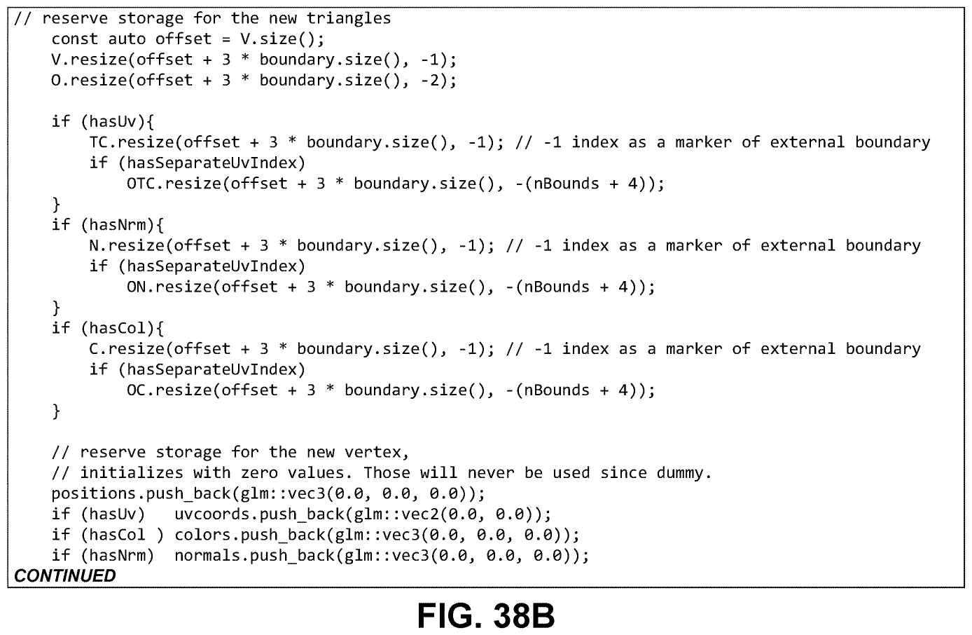

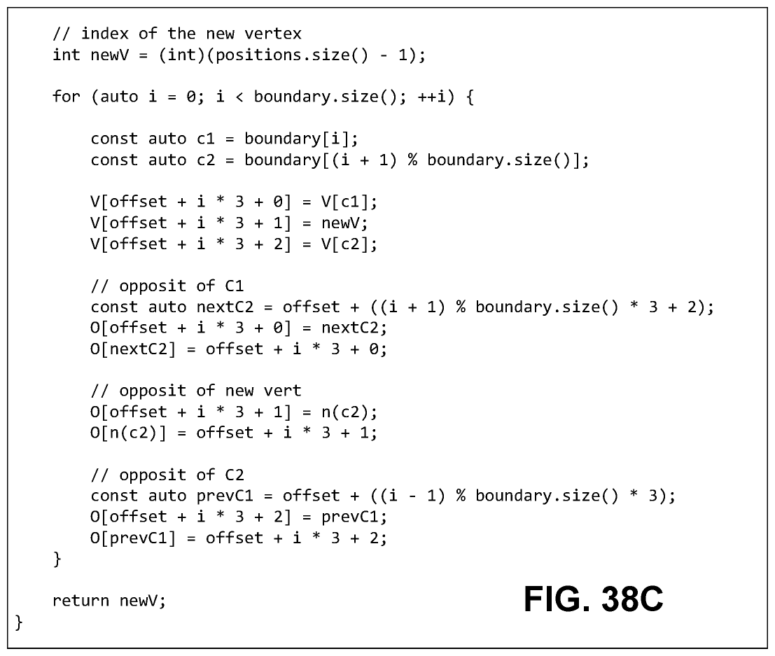

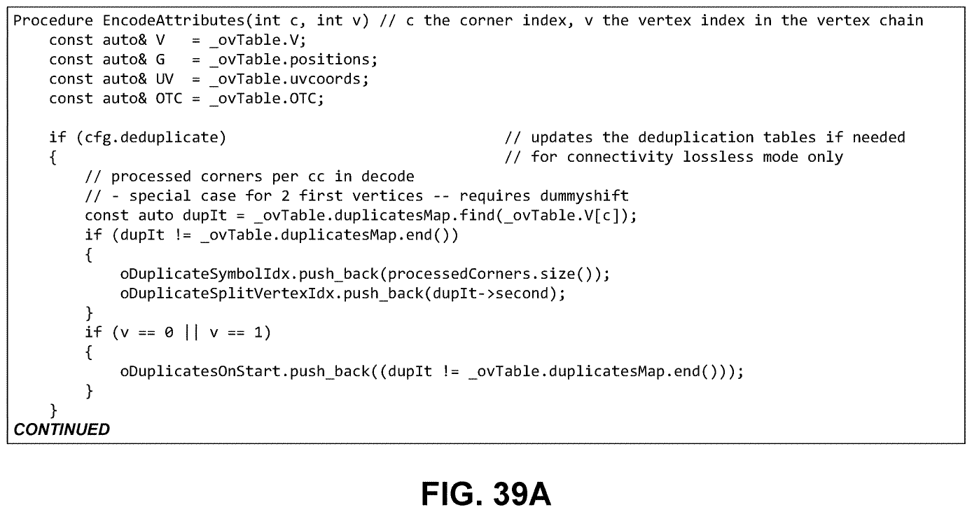

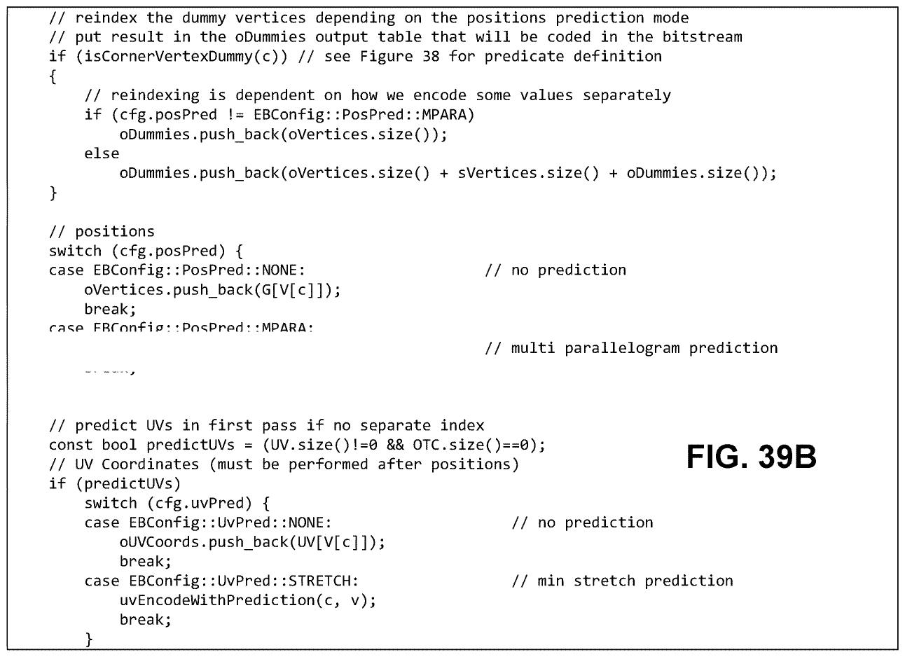

FIGS. 38A-38C illustrate an example of a C++ procedure to fill a single hole of a mesh described as a corner table (O, V, OT, OTC).

In example embodiments, a table of dummy point indices is encoded in the bitstream. See, for example, the syntax elements DATA_DUMMY_POINT_COUNT in Table 4, below, and DATA_DUMMY_POINTS_TABLE in Table 5, below. However, attributes associated with the dummy points are not encoded.

During post-processing, after the decoding of the mesh is finished, example embodiments use dummy point indices to remove the dummy points and the attached dummy triangles. The output of the process thus matches the original mesh in terms of boundaries. This processing may be performed during the transcoding to the final indexed face set representation.

Vertex indices are updated, removing references to dummy vertices and shifting subsequent indices accordingly.

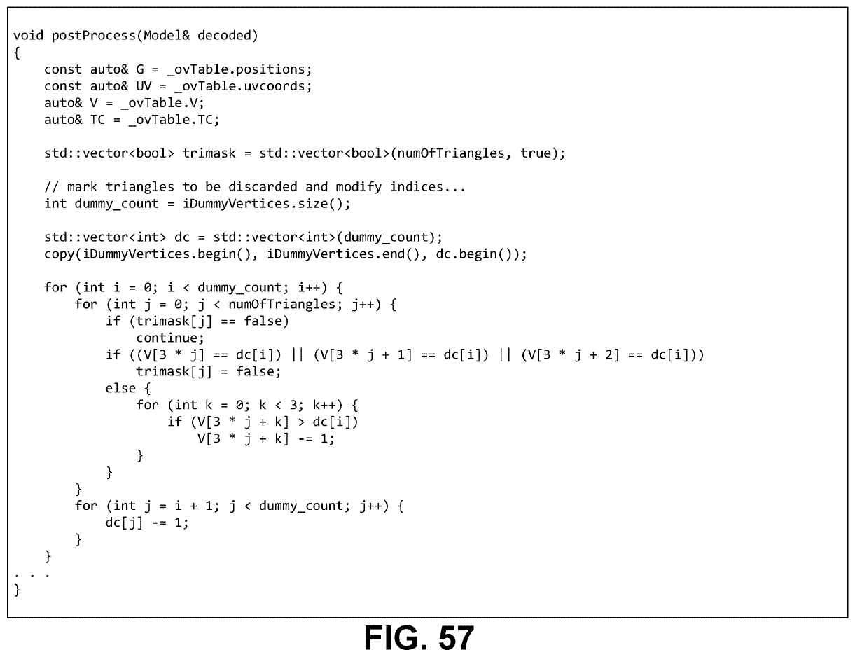

One example implementation of such a technique is illustrated in FIG. 57. The complexity of this implementation is dummy_count*numOfTriangles. When the model has a large number of triangles and of dummy points, the processing may be costly. In such cases it may be preferable to first define the mapping function using the list of dummy positions indices, and then to apply this remapping while recording which triangles should not be included in the decode mesh. (For example, a Boolean value false may be assigned to triangles including at least one dummy vertex, which are then discarded.) Encoding and decoding of per-vertex attributes.

In order to compute the predictions, example embodiments use multi-parallelogram prediction for the geometry, as described in D. Cohen-Or, R. Cohen and R. Irony, “Multi-way geometry encoding,” The School of Computer Science, Tel-Aviv University, Tel-Aviv, 2002; and M. Isenburg and P. Alliez, “Compressing polygon mesh geometry with parallelogram prediction,” IEEE Visualization, no. doi: 10.1109/VISUAL.2002.1183768, pp. 141-146, 2002. Example embodiments use min stretch prediction for the UV coordinates, as described in I. M. and S. J., “Compressing Texture Coordinates with Selective Linear Predictions,” in Computer Graphics International, Tokyo, Japan, 2003.

Example embodiments further provide processes for handling dummy points to fill holes and optional separate index tables for UV coordinates. The described techniques may further be used to support prediction of other attributes, such as normal per vertex, color per vertex or any other attribute per vertex.

Some embodiments provide prediction methods for the handling dummy points and separate index tables (hence UV seams).

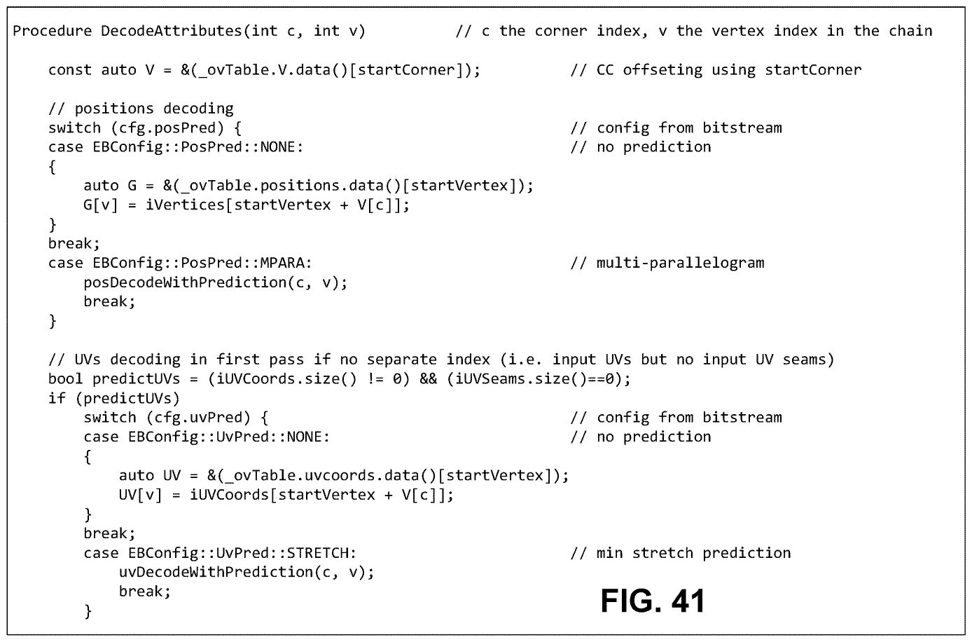

In some embodiments, the prediction of attributes using main index table is implemented by a procedure such as encodeAttributes presented in FIGS. 39A-39B. This procedure is invoked several times during the edgebreaker encoding. Its decoding counterpart procedure decodeAttributes is depicted by FIG. 41. Similarly, this procedure is invoked several times during the edgebreaker decoding.

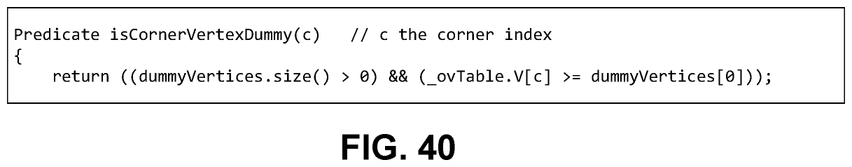

FIG. 40 illustrates an example of the predicate isCornerVertexDummy. At encoding, the dummy points are all at the end of the vertex table, which is not the case at decoding.

### Residual Coding of Positions.

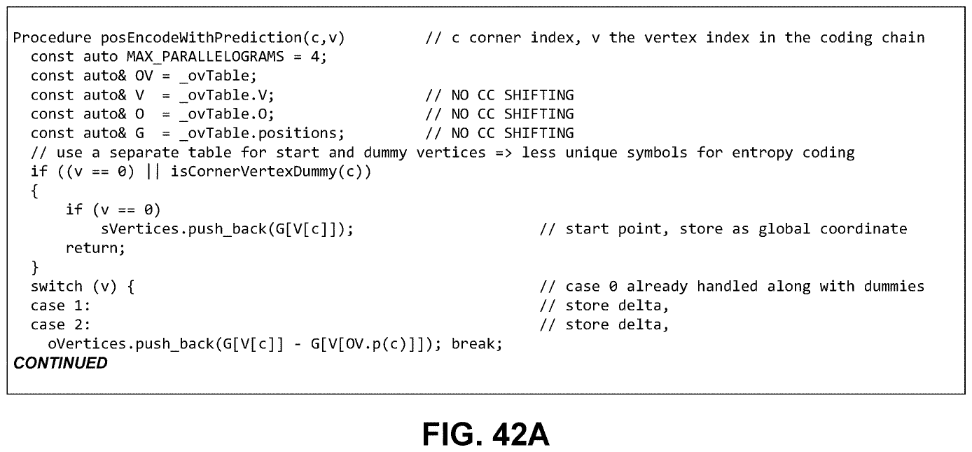

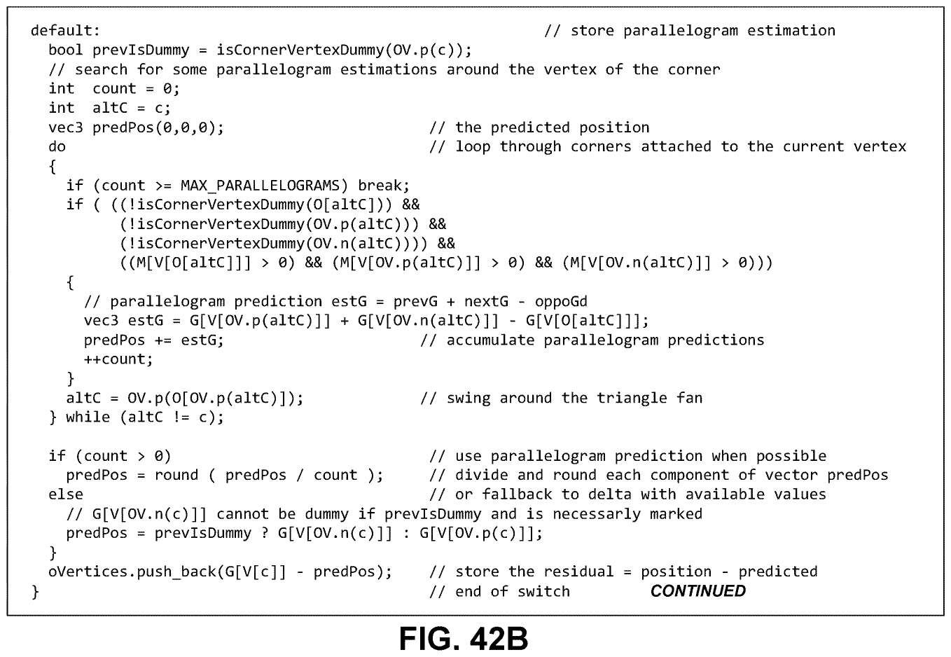

FIG. 42 illustrates an example of the procedure posEncodeWithPrediction.

Example embodiments store the starting point positions global coordinates and other point residuals in separate tables to get better entropy coding.

An example mesh encoding method comprises: encoding a connectivity of a mesh; entropy encoding a first table of starting point positions of vertices in the mesh; and separately entropy encoding a second table of point residuals of vertices in the mesh.

An example mesh decoding method includes: decoding information indicating connectivity of a mesh; entropy decoding a first table of starting point positions of vertices in the mesh; and separately entropy decoding a second table of point residuals of vertices in the mesh.

Some example embodiments extend the multi-parallelogram method to handle the dummy point cases so as to prevent erroneous predictions for parallelograms where dummy points are involved.

Some example embodiments extend prediction decoding to support multiple connected components by using tables shifting.

An example mesh encoding method includes: obtaining information defining a mesh having a plurality of connected components (CCs), each vertex in a CC having a unique global-scope index; for each CC, shifting the indices of the vertices in the CC from the global-scope index to a CC-scope index; and encoding each of the CCs using the CC-scope indices.

An example mesh decoding method includes: obtaining information encoding a plurality of connected components (CCs), each vertex in a CC having a respective CC-scope index; decoding each of the CCs; and for each of the vertices, shifting the index of the vertex from the CC-scope index to a global-scope index.

At the encoding stage, an example method includes computing the position prediction for a corner c and its attached vertex index v in the coding chain, for example using a method as illustrated in FIG. 40. During the prediction of a corner, we are sure that its associated triangle fan is always complete, and that each of its corners have a valid opposite, since example embodiments use dummy points to fill the holes (even a single triangle would become a pyramid made of 4 triangles in terms of connectivity).

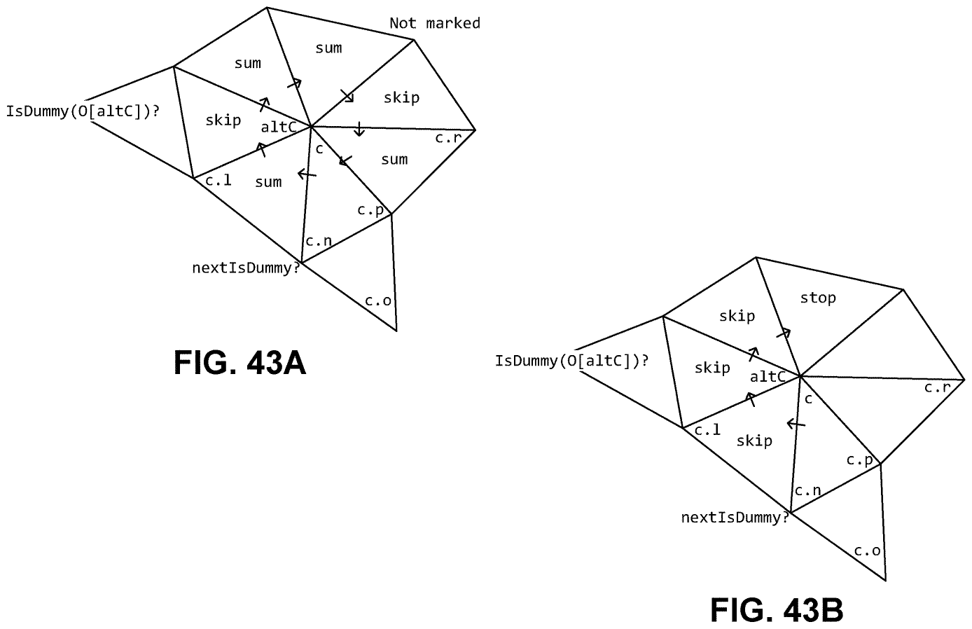

FIG. 43A illustrates a strategy for multi parallelogram prediction of corner c positions and dummy points filtering according to some embodiments.

FIG. 43B illustrates a strategy for min stretch prediction of corner c UV coordinates and dummy points filtering according to some embodiments.

In a first step, a process checks if the corner c to be coded is attached to a dummy vertex (if so, then skip the coding of the corner) or if we predict for the first vertex of the chain v=0 (then we encode the position of v using global coordinates and no prediction. In this later case the process stores the position in a specific table dedicated to entropy encode the starting vertices (table sVertices). Storing those in a specific table, different from the predictions one (table oVertices) allows for better entropy coding of these tables.

Otherwise, in a second step we test if the vertex is the second of the third (v=1 or v=2). In this case we do not perform predictions but rather use delta coding with vertex of previous corner and append the result in the table of predicted vertices;

$$oVertices . push\_back ( G [ V [ c ] ] - G [ V [ OV . p ( c ) ] ] ) .$$

Otherwise, the processing of the multi-parallelogram for a given corner c performs, in a first loop, a lookup all around its vertex to compute and sum each parallelogram prediction using opposite corners (see FIG. 41). A parallelogram to predict corner c from a sibling corner altC is valid for prediction only if the vertices of altC.o, altC.n, and altC.p were already processed by the connectivity recursion (which invokes the prediction). To test this, we use the vertex marking table M, which elements are set to true for vertex if already visited by the connectivity encoding loop. Then, the test during prediction is ((M[V[0[altC]]]>0) and (M[V[OV.p(altC)]]>0) and (M[V[OV.n(altC)]]>0))).

We extend this to test if altC.o, altC.n, and altC.p corners are not attached to dummy points (using the isCornerVertexDummy predicate). To summarize we use the corner altC for parallelogram prediction only if data is available (parallelogram vertices are not dummies and are already visited, hence available during decoding). At the end of the loop, we divide the prediction sum by the number of valid parallelograms that were found, we round the result and finally use the result to compute the residual (position−predicted) that is appended at the end of the output vertices table; oVertices.push_back (G[V[c]]−predPos).

If no valid parallelogram was found, we fall back on delta coding using G[V[OV.n(c)]] as prediction if previous corner of c is a dummy point and G[V[OV.p(c)]] otherwise.

At the end of the edgebreaker encoding procedure, the two tables sVertices and oVertices will then be entropy coded and stored into the bitstream.

At decoding, an example of the reconstruction of a corner's vertex position is depicted in FIGS. 42A-42B. The process is the same as for encoding and follows the same order for vertices and fan exploration. The obtained predictions are thus equal to the ones of the encoding. Note that for the decoding we use a table D to quickly find if a vertex is a dummy point. The table D is initialized by the procedure initDecompression (see FIG. 16). Also note that in the prediction decoding procedure we use tables shifting to handle CCs (which is not the case in the prediction encoding procedure).

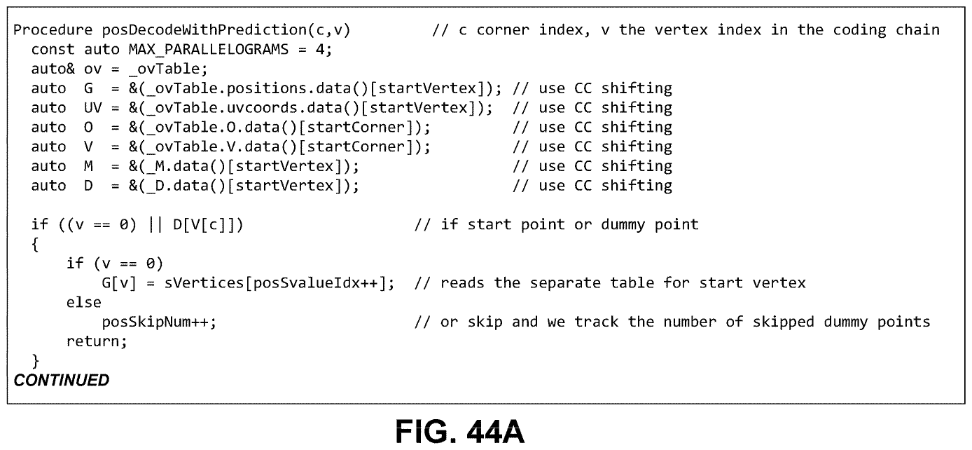

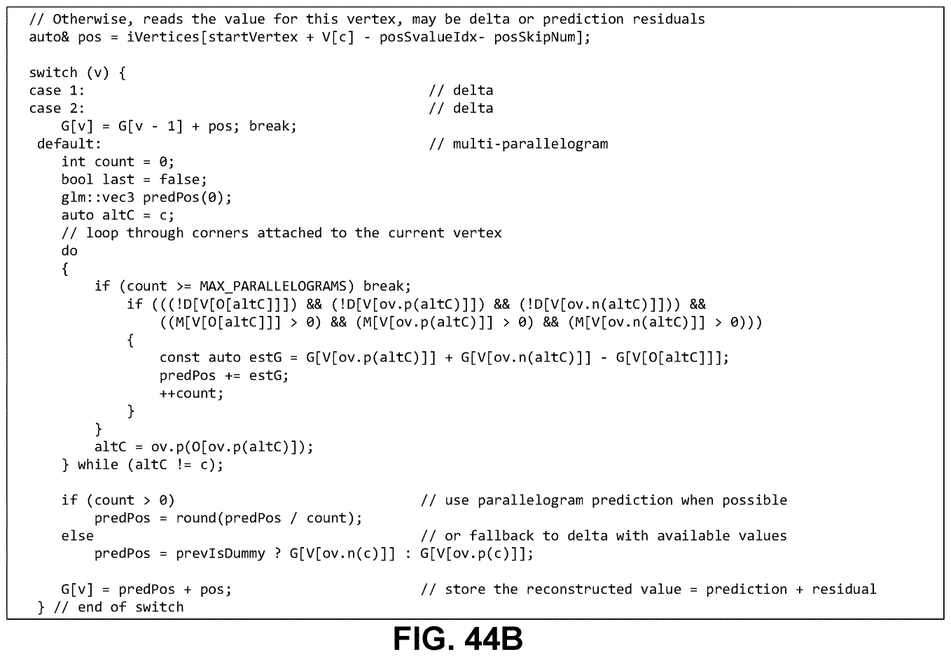

FIGS. 44A-44B illustrate an example of the procedure posDecodeWithPrediction. Table D indicates for each vertex if it is a dummy or not.

### Residual Coding of UV Coordinates Using Main Index Table.

The prediction encoding of UV coordinates using main index tables is extended the same way as for positions. The difference for some embodiments is the use of min stretch instead of multi-parallelogram for the prediction and that we do not sum up predictions (it is not multi-) but stop on the first valid (in the sense of prediction) neighbor in the triangle fan and compute the min stretch, as shown for example in FIG. 41. An example uvEncodeWithPrediction procedure shown in FIG. 43. An example prediction statement is depicted in FIGS. 44A-44B.

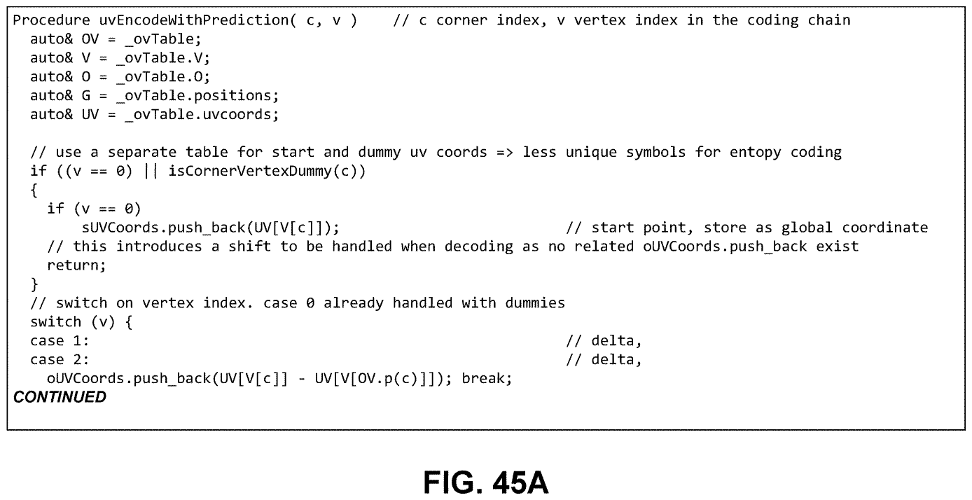

FIGS. 45A-45B illustrate an example of the procedure uvEncodeWithPrediction.

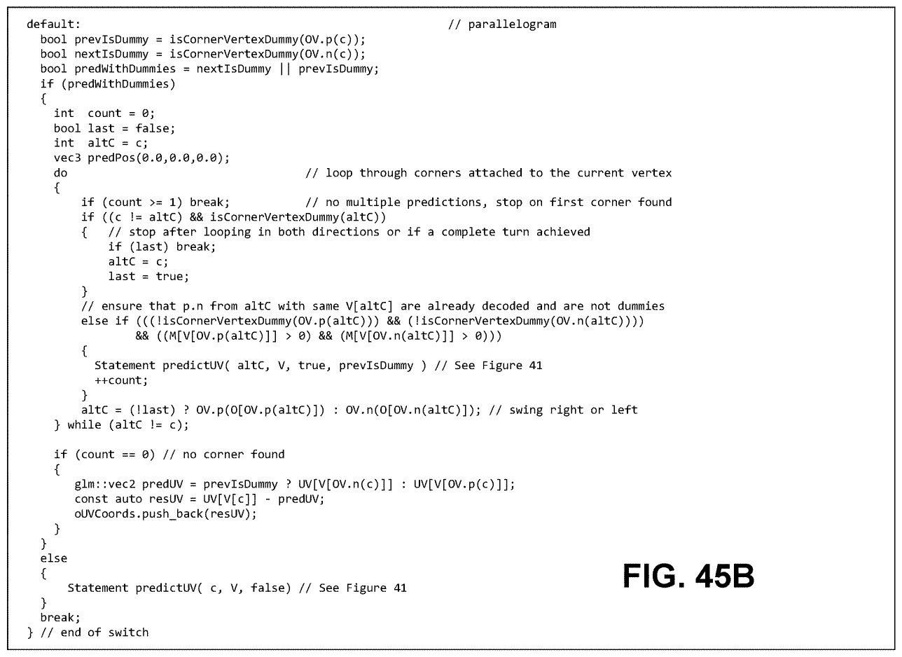

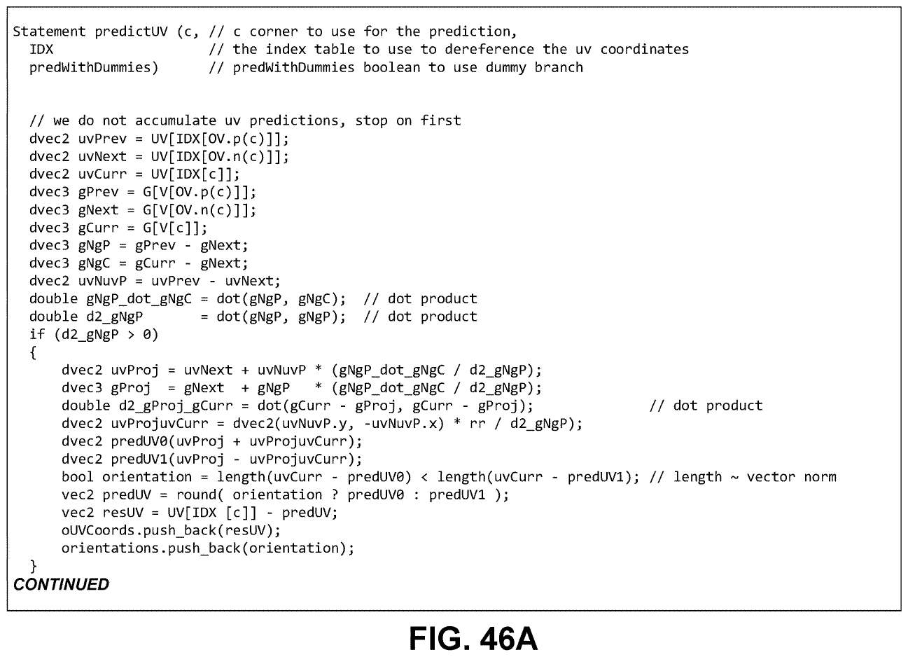

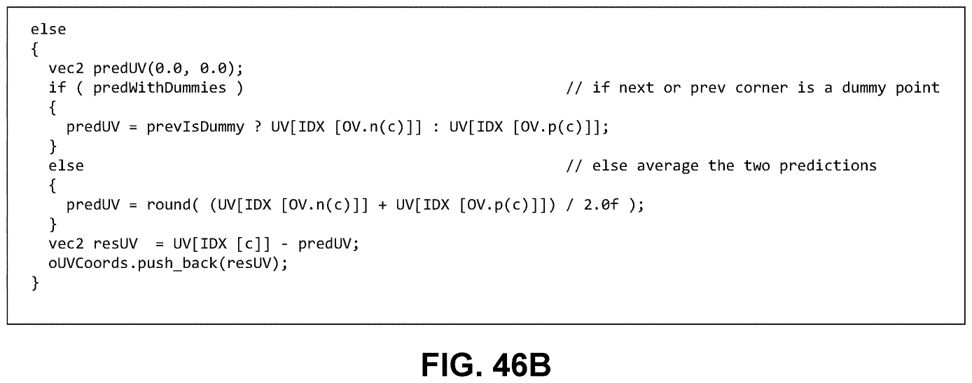

FIGS. 46A-46B illustrates an example of the statement predictUV. dvec2 and dvec3 are double precision vectors.

One can see in the predictUV procedure of FIGS. 44A-44B that we have one branch that uses prediction and two other paths that use fall back. The approach is based on using the geometry to make a first choice then performing the UV min stretch prediction or fall back to delta in case of dummies on the vertex chain or performs an average of previous and next corner UVs otherwise. Note that in the case of min stretch choice, example embodiments store the prediction residual (in table oUVCoords) and an orientation bit (in table orientations) that is used at decoding. In counterpart the two other paths do not store the orientation information.

As for the positions, the decoding is symmetrical. Example embodiments use tables shift for the handling of CCs and we use the same logical cases as for the positions. The input iUV is extracted as

$$iUV = iUVCoords [ startVertex + V [ c ] - uvSvalueIdx - uvSkipNum ] ;$$

which includes CC offset startVertex, start values in separate table uvSvalueIdx and uvSkips in case of dummy points. This extracted iUV can be a delta (case v=1 or v=2) or a residual otherwise. Example embodiments then perform the same prediction or fall backs as in UV encoding and compute back the final UV as for positions: UV[v]=predUV+iUV with predUV the predicted UV or the fall back. Residual coding of UV coordinates using a different index table.

When the model makes use of separate index tables for the UV coordinates, example embodiments handle the potential UV seams during the predictions (in addition to separate table for start UVs, multiple CCs and dummy points). When not using a separate index table the positions of the vertices located on the boundaries of UV patches are duplicated, and the mesh contains at least as many CCs as UV patches. This is why in previous sections we handle the UV as the positions, they have the same structure. In counterpart, in example embodiments that use a separate index table for the UV coordinates, it is possible to have a more “compact” geometry without CCs specific to UVs and handle the UV patch boundaries using the separate UV index table. The edge chains on the mesh where the UV coordinates are different on each side may be referred to as UV seams.

FIG. 47A illustrates handling UV seams using only a main index table. Duplicated positions (illustrated with dashed ovals) have different UV coordinates. FIG. 47B illustrates handling of UVs with separate index table and selection strategy for the corner cₚ used for the prediction of UV coordinates with separate index for corner c. The dashed line represents a UV seam, and vertices along the seam may have possibly identical positions and different UV coordinates for different sides of the seam.

Some example embodiments extend the UV predictor search strategy to support UV seams. This is performed in some such embodiments by storing specific codes in the TC and OTC tables to guide the algorithm.

Example embodiments perform a search strategy for a valid prediction corner as depicted in FIGS. 45A-45B. In this approach, the dummy points are handled implicitly, just checking if sibling corners already have reconstructed UV coordinates. The strategy to find a valid predictor cₚ for UVs of corner c is to search for the first triangle, in the part of the fan that is on the same side of the seam than the triangle of corner c, for which a maximum of UV coordinates have already been predicted. Example embodiments select the first corner that has two UVs already predicted, if none, the first that has one UV already predicted otherwise no prediction. For the search, we can first turn left then right direction or the opposite this does not matter but we need to use the same order at decoding. An example of a detailed procedure encode SeparateIndexAttributes to perform this work is illustrated in FIG. 46.

In some embodiments, the decoding, as illustrated in FIGS. 47A-47B, performs the same processing (using shifted tables) to recover the predicted values and then the final UV coordinates. Note that this stage does not make specific use if the isSeam table since this one was used during the edgebreaker decoding to create some valid TC and OTC tables that handles the separate indices. At this stage, the TC tables is used to find the UV indices per corner and the OTC table is used to detect UV seams. Example embodiments use −4 in OTC at encoding and −1 in OTC at decoding. This is because values between 0 and −4 are used for other purposes.

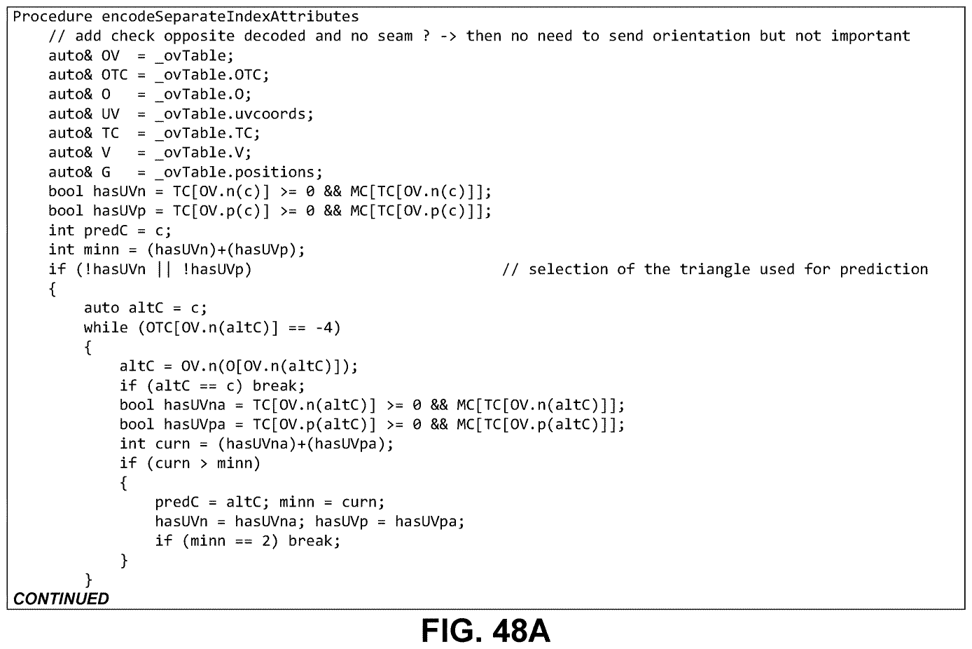

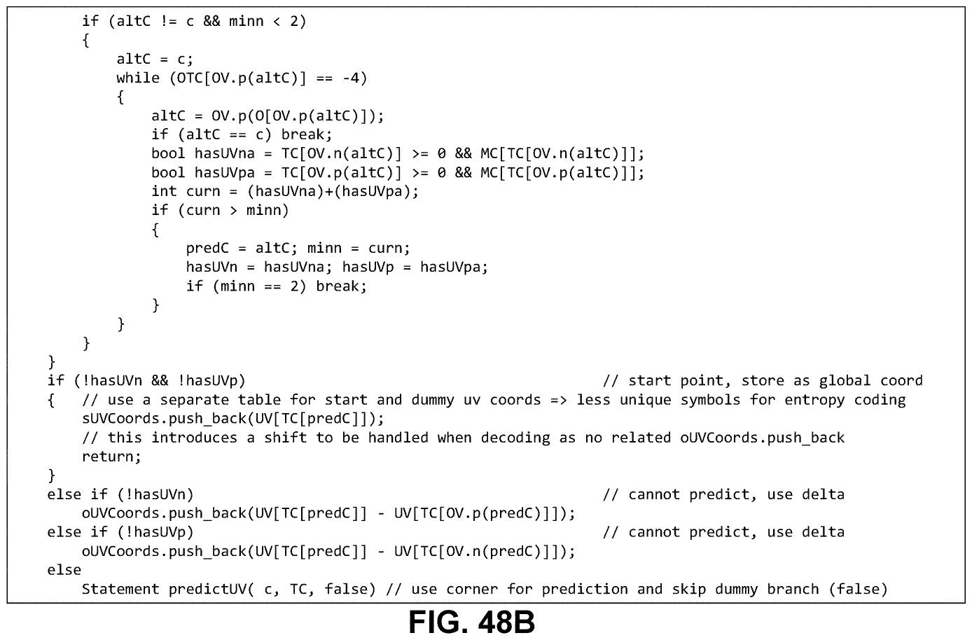

FIGS. 48A-48B illustrate an example of the procedure encodeSeparateIndexAttributes.

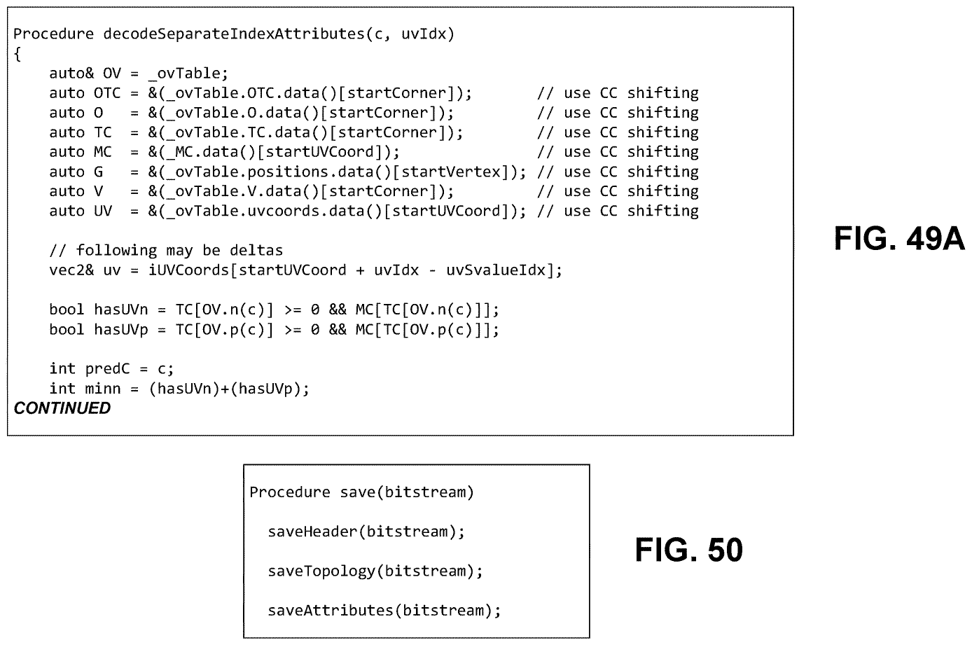

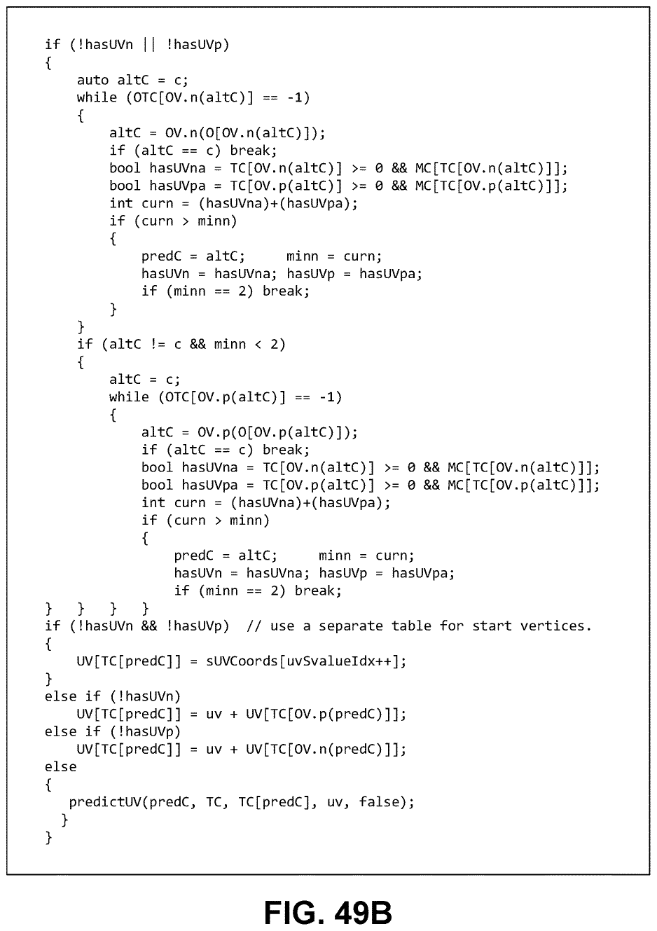

FIGS. 48A-49B illustrate examples of the procedure decodeSeparateIndexAttributes.

### Prediction of Per-Face Attributes.

Some example embodiments encode and decode colors or Ids per face. In some such embodiments, the per face attribute is coded according to the order of faces in the CLERS table. Each symbol of the table corresponds to a triangle. Example embodiments operate to directly encode the per face attributes during the connectivity encoding (see FIGS. 12 and 13) and connectivity decoding (see FIGS. 18 and 19) whenever we code/decode a new triangle (doing T=0 or T++). Then, example embodiments include adding at these steps the encoding of the triangle attribute in a table. Some embodiments add the value (color, Id, . . . ) directly in a dedicated table, e.g. by performing a delta coding with previous triangle in the table. Some embodiments use separate tables to handle the start triangles, similar to the techniques described herein for start vertices when coding per vertex attributes. Such embodiments may have more efficient entropy coding.

Example embodiments use the triangle sequence in the order of the CLERS table to encode delta values for per triangle colors (e.g., 8 bit rgb) or integers (e.g., group identifier, subdivision depth). Some more complex predictions could be envisioned using the same strategy, depending on the type of attribute.

An example of a mesh encoding method includes: obtaining information describing a mesh having a plurality of triangles, each triangle having an attribute; encoding the mesh as an ordered sequence of symbols in edgebreaker coding, each of the triangles corresponding to an associated one of the symbols; and encoding the attributes of the triangles, the attribute of a current triangle being encoded using a prediction based only on attributes of at least one triangle preceding the current triangle in the ordered sequence of symbols. For example, the attribute of each triangle may be encoded as a delta value relative to the preceding triangle in the sequence (the value of the attribute of the preceding triangle serving as the prediction).

A mesh decoding method according to some embodiments includes: obtaining an ordered sequence of symbols representing an edgebreaker coding of a mesh having a plurality of triangles, each triangle having an attribute; decoding the mesh; and decoding the attributes of the triangles, the attribute of a current triangle being decoded using a prediction based only on attributes of at least one triangle preceding the current triangle in the ordered sequence of symbols.

The prediction of per-vertex attributes may be particularly useful for mesh coding systems that handle per triangle groups specific adaptive subdivision. For instance, each triangle of the base mesh might receive an integer specifying the number of subdivisions it should receive to reconstruct the full mesh.

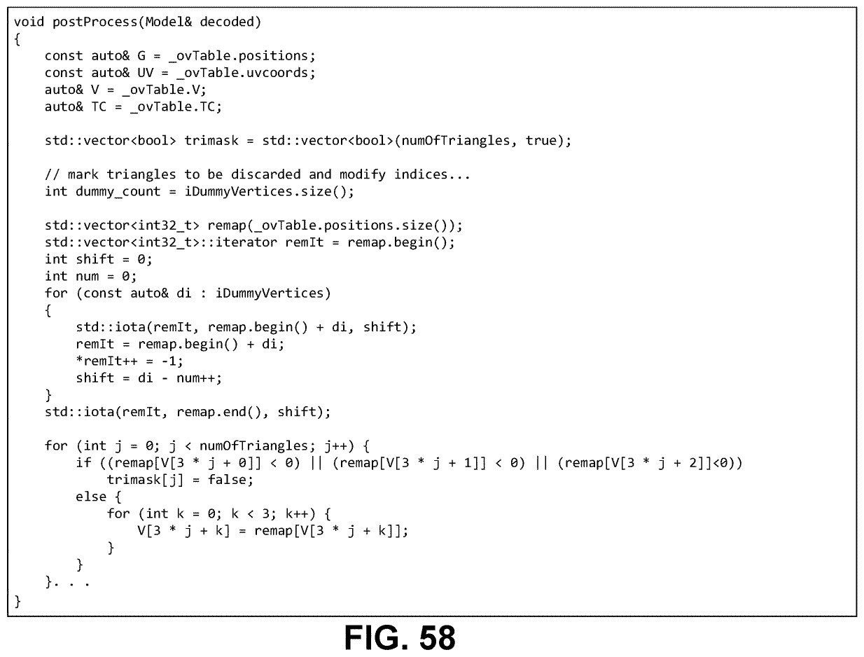

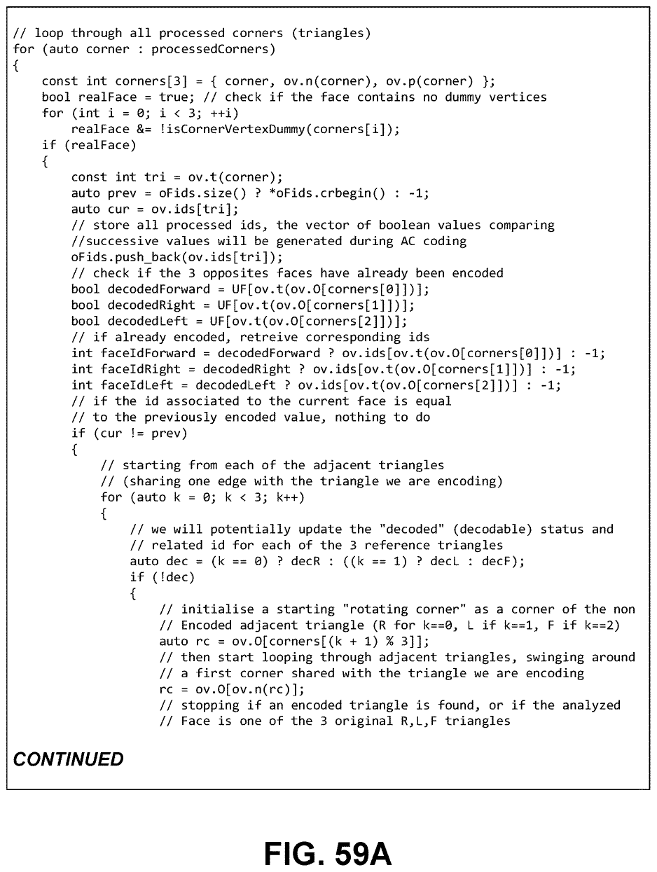

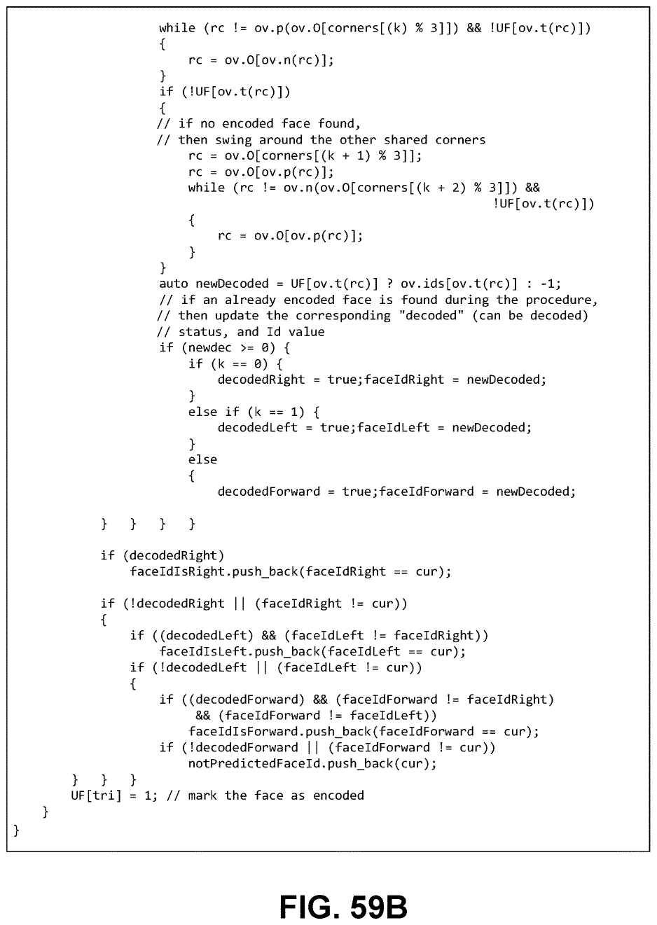

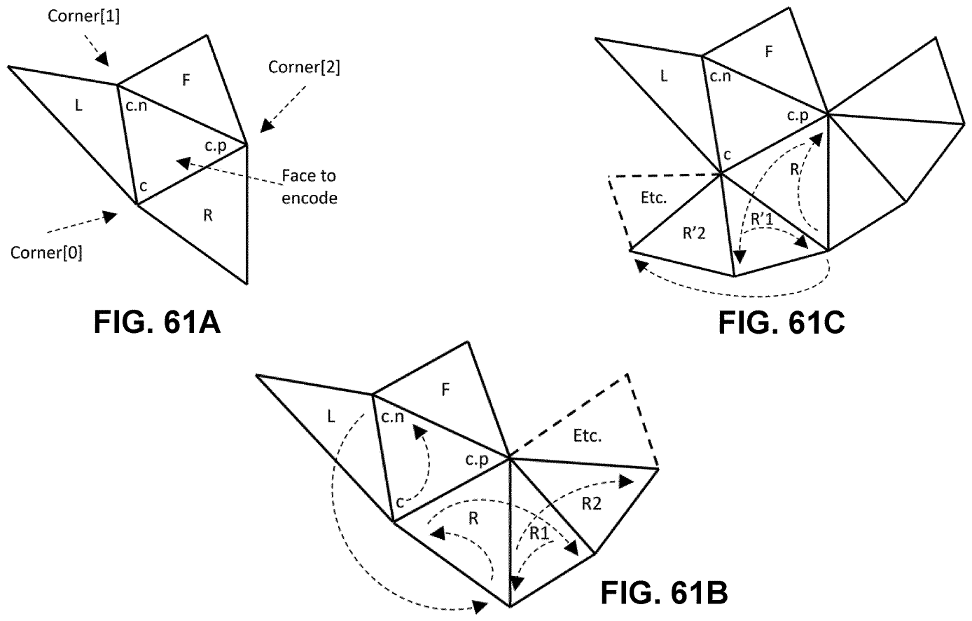

Some embodiments implement a technique (referred to here as variant A) for encoding Ids (e.g. material Ids) per face. An example of code for implementing variant A is provided in FIGS. 59A-59B. In such embodiments, for each corner processed during the traversal that defines a new triangle, the following actions may be performed:
A determination is made of whether the current corner defines an actual face or a dummy face (the face is dummy if one of its corners is associated to a dummy vertex).
A determination is made of whether the current Id is equal to the previous encoded Id, and the result of the comparison is stored in a Boolean vector faceIdEqualToPrevious whose final size is the number of triangles of the input mesh (before adding dummy vertices). If the current Id is equal to the previous encoded Id, then further encoding of the current Id is not required. If, however, the current Id is not equal to the previous Id, the following steps are performed for the coding of the current Id:
A determination is made of whether any of the faces opposite to each of the current face corners has already been encoded. The current triangle is defined by the following three corners: currentCorner, ov.n(currentCorner), ov.p(currentCorner). The “facing triangle” is defined as the one containing ov.O(currentCorner), The “right triangle” is the one containing ov.O[ov.n(currentCorner)], the “left” triangle is the one containing ov.O[ov.p(currentCorner)].
For each of those triangles (faces opposite to each of the corners of the current triangle, defined by a corner index, as shown in FIGS. 61A-61C), if it has not already been encoded, a loop is performed first through faces containing currentCorner=ov.O[ov.n(currentCorner)] stopping when finding a face that already has been encoded, until the considered face is not the current face for which we are encoding the Id value. If no previously encoded face has been found we restart and loop in the other direction, i.e. though faces containing currentCorner=ov.O[ov.p(currentCorner)].
This results in, for each corner corresponding to an actual face, three Boolean values (decodedRight, decodedLeft, decodedFacing), and for those values that are true we know the corresponding face Id values which already have been encoded (faceIdRight, faceIdLeft, faceIdFacing). When Boolean values are false, corresponding faceIdRight/Left/Facing values may be set to an invalid value (e.g. −1 if we consider only id values>=0).
Then the following process is performed:

```
if (decodedRight)
    faceIdIsRight.push_back(faceIdRight == currentFaceId);
if (!decodedRight | | (faceIdRight!= currentFaceId))
{
    if ((decodedLeft)&&(faceIdLeft != faceIdRight))
        faceIdIsLeft.push_back(faceIdLeft == currentFaceId);
    if (!decodedLeft | | (faceIdLeft!= currentFaceId))
    {
        if ( (decodedForward) && (faceIdForward!=
    faceIdRight) && (faceIdForward!= faceIdLeft))
            faceIdIsForward.push_back(faceIdForward ==
        faceIdForward);
        if (!decodedForward | | (faceIdForward!=
        currentFaceId))
            notPredictedFaceId.push_back(currentFaceId);
        }
    }
```

The face may then be marked as encoded.
This process results in four Boolean vectors (faceIdEqualToPrevious, faceIdIsRight, faceIdIsLeft, faceIdIsFacing) and a vector (notPredictedFaceId) containing values which are not predicted.

FIGS. 61A-61C illustrate an example of search order for corner[0]=c (the operation is repeated for corner[1]=c.n then for corner[2]=c.p). FIG. 61A illustrates a face for which an Id is to be coded and L,R,F adjacent triangles. (The three adjacent always exist since dummy points are used to fill holes.) FIG. 61B illustrates lookup in neighborhood looping in a first direction over R, R1, R2, etc. FIG. 61C illustrates a subsequent lookup in the other direction.

Some embodiments implement an alternative technique (referred to here as variant B) for encoding Ids per face. Such a technique may be implemented as follows:
Store information indicating whether the current id is equal to the previous in a first vector of Boolean values.
If it is not equal, store either the absolute value of the current Id, or a difference versus the previous one in a second vector of integer values.

Some embodiments implement an alternative technique (referred to here as variant C) for encoding Ids per face. Such a technique may be implemented as follows:
Store information indicating whether the current id is equal to the previous in a first vector of Boolean values.
If it is not equal, store information indicating whether the current id is equal to the most recently coded id that was different from the previous in a second vector of Boolean values.
If it is not equal, store either the absolute value of the current Id, or a difference versus the previous one in a third vector of integer values.

Using a larger number of most recently used values and coding indices pointing to those instead of absolute values may be performed in some embodiments, but it is not likely to lead to increased efficiency.

At least for some sample sets of meshes that are processed in the VDMC context, those alternative approaches (B and C) are less efficient than A, but still simpler to implement, and faster to execute.

An example of code for executing encoding using alternative A is illustrated in FIGS. 59A-59B. Decoding using alternative A (e.g. with a procedure decodePerFaceAttributes) is performed in a manner analogous to the encoding as illustrated in FIGS. 59A-59B.

In some embodiments, a mesh encoding method includes: obtaining information describing a mesh having a plurality of triangles, each triangle having an attribute (such as an Id); encoding the mesh as an ordered sequence of symbols in edgebreaker coding, each of the triangles corresponding to an associated one of the symbols; and encoding the attributes of the triangles, the attribute of a current triangle being encoded using a prediction based on attributes of at least one triangle adjacent to the current triangle in the mesh (such as the left, right, facing, and/or previous triangle).

In some such embodiments, the encoding of the attributes of the triangles includes encoding a plurality of Boolean vectors (such as the faceIdEqualToPrevious, faceIdIsRight, faceIdIsLeft, and/or faceIdIsFacing vectors), the plurality of Boolean vectors collectively indicating, for at least a plurality of the triangles, a corresponding triangle from which the respective attribute is predicted.

As described in greater detail below, arithmetic encoding of the plurality of Boolean vectors may also be performed.

In some embodiments, a mesh decoding method includes: obtaining an ordered sequence of symbols representing an edgebreaker coding of a mesh having a plurality of triangles, each triangle having an attribute; decoding the mesh; and decoding the attributes of the triangles, the attribute of a current triangle being decoded using a prediction based on attributes of at least one triangle adjacent to the current triangle in the mesh.

In some such embodiments, the decoding of the attributes of the triangles includes encoding a plurality of Boolean vectors (such as the faceIdEqualToPrevious, faceIdIsRight, faceIdIsLeft, and/or faceIdIsFacing vectors), the plurality of Boolean vectors collectively indicating, for at least a plurality of the triangles, a corresponding triangle from which the respective attribute is predicted.

As described in greater detail below, arithmetic decoding of the plurality of Boolean vectors may also be performed.

Entropy coding.

FIG. 50 illustrates an example of the procedure save, which relates to entropy coding and syntax writing. During the creation of the bitstream (see FIGS. 48A-48B), example embodiments first write some meta-data in a header, then save the topology payload, and finally save the attributes (positions, UV coordinates) payload. For both topology and attributes, some tables are entropy coded before save. Example entropy encodings are described in this section.

Example embodiments support two or more different arithmetic encoders, such as the Dirac coding or RANS coding, described in J. Duda, “Asymmetric numeral systems: entropy coding combining speed of Huffman coding with compression rate of arithmetic coding,” Arxiv 1311.2540, 2014. For some data, one or the other of these codecs may provide better compression. We also found that for some other tables, depending on the model that is being compressed, one or the other is better at compression. Example embodiments provide more than one arithmetic codec implementation guided by some options. Tables 6, below, summarizes for each type of data, which arithmetic coder is available for some embodiments. The following sections further detail the configuration/binarization used for some data tables depending on the type of arithmetic coding that is used.

### Arithmetic Coding of the CLERS Table.

When encoding a non-binary sequence of CLERS symbols, representing topological codes used to reconstruct the topology of mesh traversed using the edgebreaker algorithm, one or more of the following approaches may be used.

The selection of a preferred binarization process and the probability model selection for the related bins may depend on the specific nature of the sequence of symbols to encode, conditioned by the number of symbols (related to the number of faces in the mesh), and the topological structure of this mesh (e.g., the regularity of the structure of the considered mesh, potentially impacting the global symbols statistics but also the interrelations between successive symbols)

Some embodiments assign a variable length code to the set of symbols (e.g., 5 symbols ‘C’ ‘L’ ‘E’ ‘R’ ‘S’ for the basic edgebreaker), depending on the expected statistical distribution of those. One known selection is to assign {‘C’, 0, 1 bit}, {‘S’, 1, 3 bits}, {‘L’, 3, 3 bits}, {‘R’, 5, 3 bits}, {‘E’, 7, 3 bits}

$$C = 000$$

$$S = 001$$

$$L = 011$$

$$R = 101$$

$$E = 111$$

In some embodiments, when encoding using RANS, the CLERS table made of these codes is provided to the encoder as is.

In some embodiments, when encoding using Dirac coding, it is possible encode using several contexts (ctx). Some such embodiments encode b0 using ctx0, b1 using ctx1 and b2 using ctx2, when b0=0 then the 2 subsequent bits do not need to be coded.

In some embodiments, contexts are selected for each bin depending on the values of the previous bins for the current symbol, but also depending on the values of the preceding symbols. This is useful for CLERS sequences as there are strong correlations between successive symbols.

Example embodiments which use a global 5-bits (32 possible values) state that is defined using the 2 previous symbol values. Alternative embodiments use a simplified or extended state definition.

In some embodiments, one of 32 bit_0 contexts is selected for the encoding of the fist bit defining if the symbol is ‘C’ or not. If the symbol is not ‘C’, the second bit is encoded using one of the 32 contexts modelling values for bit_1. Then depending on the value of bit_1, two sets of 32 contexts are used to encode bit_2. Finally, the global state is updated considering the latest encoded symbol. In our current implementation the state has 3 bits for the latest values plus bit0 and bit3 from the previous, that is 5 bits of 32 states. All those states are not necessarily used in practice: using a simple mapping we would instantiate only 20 contexts as 5 values for the current symbol×4 possible states retained from the previous which is possible states. Then in this example the total number of used contexts would be 20×4=80 (4 for bit_0, bit_1, bit_2IFbit_1is0, bit_2Fbit_1is1)

When the number of symbols is not large, using many contexts may prove inefficient. Then, based on then number of symbols to encode, example embodiments operate to adjust the number of global states to use. For instance, instead of using a 32 bits global state (where 5×4=20 are useful states) example embodiments can limit it to 3 bits or 5 global states when capturing only the value of the latest symbol.

In a variant, an example embodiment operates to test multiple combinations, to encode using the selected combination, and to encode in the bitstream information indicating the combination that was selected.

Some embodiments operate to define a scheme that progressively uses more states (bootstrapping), copying appropriate states values to uninitialized states when transitioning the model based on e.g. the number of symbols encoded or other factors such as a specific trigger based on states values, statistics on input values (e.g. variance of the probability encoded bits), and the like.

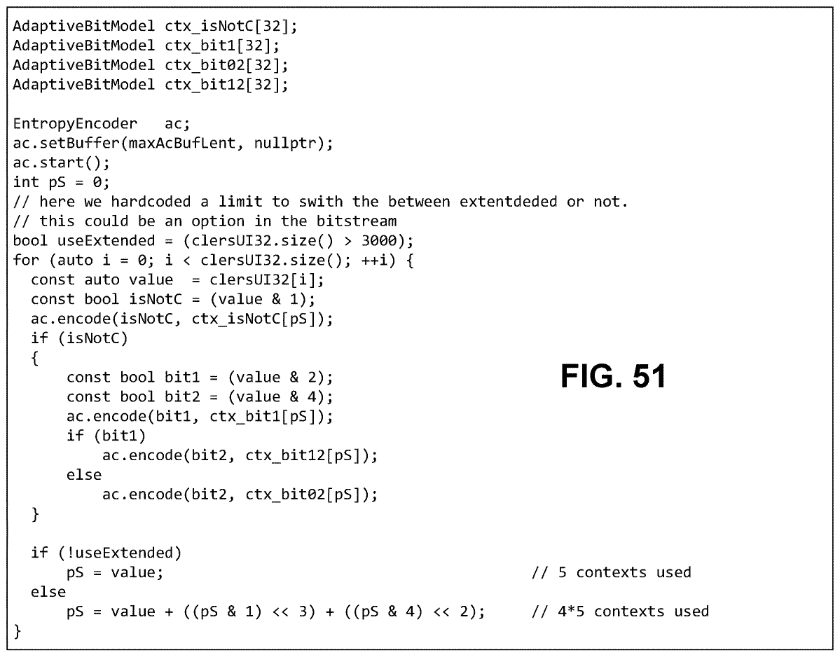

An example of pseudo code to control the Dirac encoder for the CLERS table is given in FIG. 51.

In a mesh decoding method according to an example embodiment, a bitstream is obtained that includes an entropy-encoded CLERS table representing connectivity of a connected component of a mesh. A sequence of bits is entropy decoded from the CLERS table, where the sequence of bits represents a sequence of symbols including at least one most-recently-decoded symbol. A current bit is entropy decoded from the CLERS table, wherein the current bit is decoded using a context determined based at least in part on the at least one most-recently-decoded symbol (e.g., based on the two most-recently decoded symbols). A mesh decoding apparatus according to some embodiments comprises one or more processors configured to perform such a method.

In some embodiments, the context is determined not only by the most-recently-decoded symbol but also by a most-recently-decoded bit in the sequence of bits. In some embodiments, the context is based further on two most-recently-decoded bits in the sequence of bits.

In a mesh encoding method according to some embodiments, a CLERS table is obtained, wherein the CLERS table represents the connectivity of at least one connected component of a mesh. A sequence of bits representing at least a portion of the CLERS table is encoded, where the sequence of bits representing a sequence of symbols from the CLERS table, including at least one most-recently-encoded symbol. The entropy encoding includes entropy encoding a current bit in the CLERS table, wherein the current bit is encoded using a context that is determined based at least in part on the at least one most-recently-encoded symbol (e.g., based on the two most-recently encoded symbols).

In some embodiments, the context is further based at least in part on a most-recently-encoded bit in the sequence of bits. In some embodiments, the context further based on two most-recently-encoded bits in the sequence of bits.

In some embodiments, the number of contexts used to decode bits of the CLERS table is determined based on the number of symbols in the CLERS table. In some such embodiments, the number of contexts is determined based on whether the number of symbols in the CLERS table is greater than a threshold (e.g. a threshold of 3000 symbols, as one option among other possibilities), a first number of contexts being used when the number of symbols is less than the threshold, and a second number of contexts being used when the number of symbols is greater than the threshold, the second number being greater than the first number. As one example among other possibilities, the first number may be five and the second number may be twenty.

### AC Coding of Attribute Residuals.

When coding vertex attributes such as positions or texture coordinates, example embodiments operate to predict those values and then encode only residuals. Absolute reference values may be coded separately to avoid reducing the performance of the arithmetic coder by spoiling the statistics.

When encoding using RANS, example embodiments provide the table made of these residuals to the encoder as is.

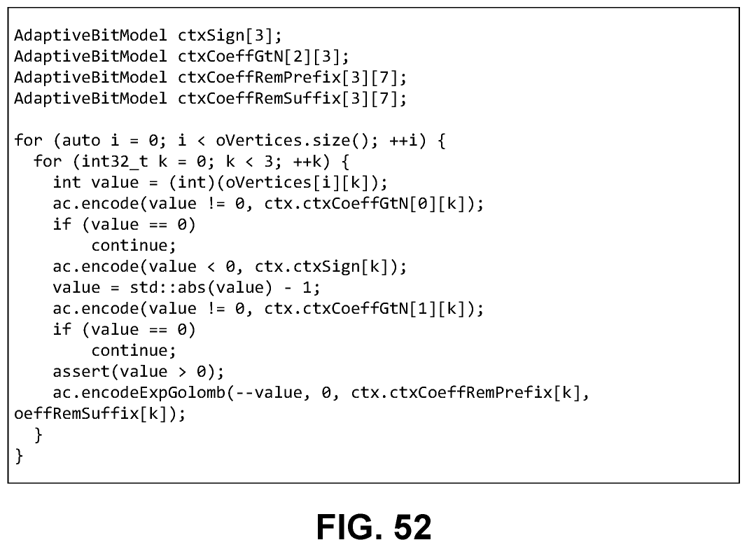

In some embodiments, when encoding using Dirac, some control over the contexts may be performed. Example embodiments a coding scheme is used for the arithmetic encoding of motion vectors, based on the Dirac arithmetic coder. The code illustrated in FIG. 52 provides an illustration reproducing part of the coding principle used for motion vectors in some embodiments.

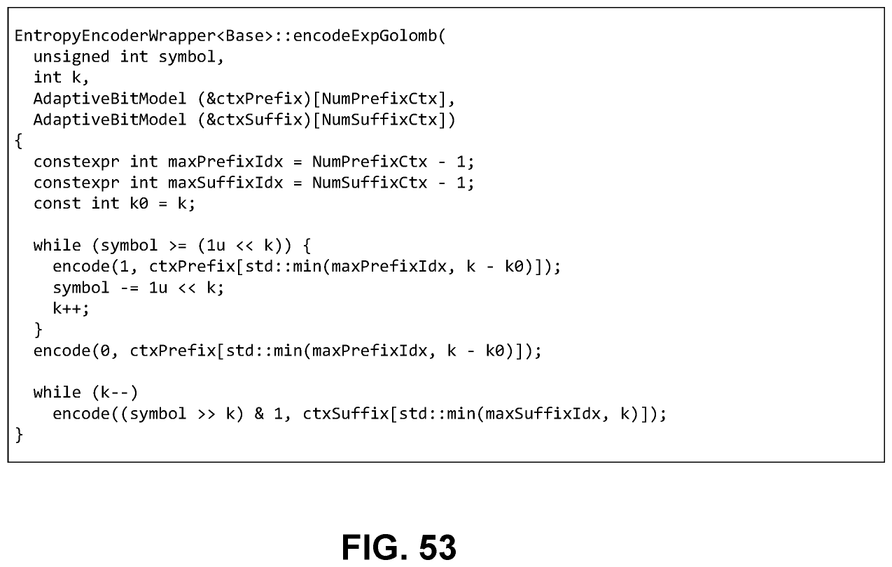

With this approach, to encode triplets of signed integer values (one per coordinate of a 3D position) example embodiments use 51 contexts. For each value we first encode is this value is 0 as one bit using a first context. If the value is not null, we encode the sign as one bit using a second context. Then we encode if the absolute value of the value to encode is 1 as one bit using a third context. If the absolute value of the value to encode is above 1, then the absolute value of the value to encode minus one is expGolomb encoded using 2×7 contexts, 7 for the exponent (prefix) part, 7 for the suffix part. This is merely one example, and different configurations may be used in other embodiments. In some embodiments, an offset or shift value is used in conjunction with the expGolomb encoding. Such encoding schemes may allow for better compression of distributions with large probabilities for values −1 0 +1 and adjust to distributions not conforming to the ideal distribution ideally handled by the expGolomb coding. More details on an example offset/shift are given in the example code for ExpGolomb coding as shown in FIG. 53.

This modelling may not be optimal for the distributions of position or other attributes residuals. Thus, some embodiments use a more elaborate modelling to achieve better results.

Some example embodiments proceed as follows (the given dimensioning values are examples only). In some embodiments, the threshold before falling back to expGolomb coding has been extended (this is set through the bias parameter). In an example embodiment:
1. Encode one bit to signal whether the value is 0.
2. Then if not 0, encode the sign as one bit. We are left with encoding newvalue=abs(initialvalue)− 1.
3. Then a code (e.g. a simple code) of max length bias is used to encode newvalue<bias, repeatedly repeating 0 and 1 when the bit count is equal to the value to encode and stopping after bias values.
4. Then if the last bit transmitted was 0 the value is >=bias, we encode (newvalue−bias) using biased exp-golomb coding.

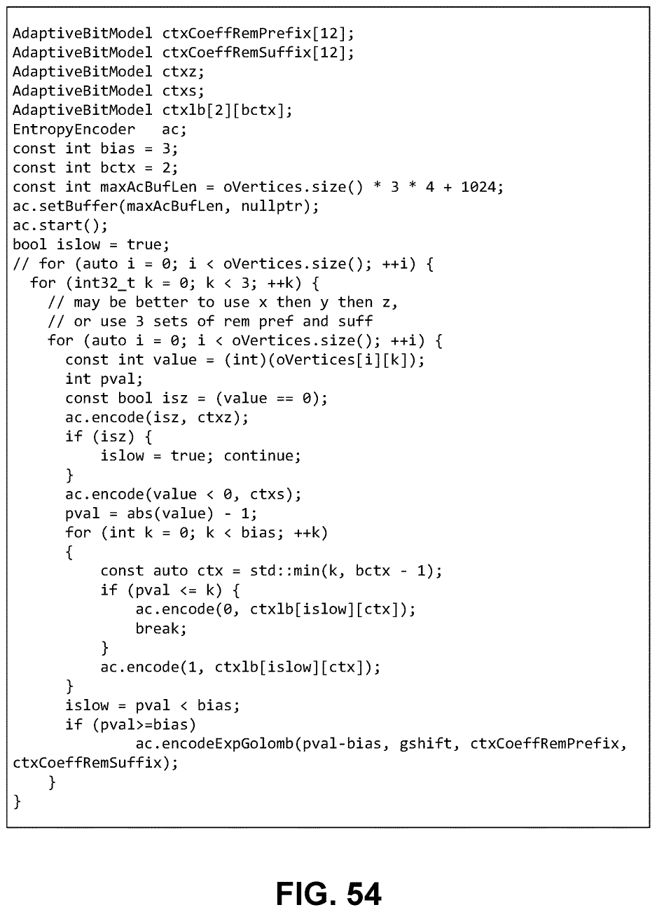

The contexts in step 3 may be conditioned by the fact that the previous coded value has an absolute value smaller than bias. Their number can be limited so that it can be any value from 1 to bias. schematic example of the code for some embodiments is depicted in FIG. 54. In this embodiment, the performances are impacted by the looping order, per component/per residual. Depending on the predictor used and the kind of data an optimal order may be selected (better to loop through values assigned to one component before going to another component for positions with our parallelogram predictor), better to go through components first for texture coordinates and stretch minimization prediction. If states are duplicated per component there is no such ambiguity, but performances/complexity may be impacted.

In some embodiments, a mesh encoding method includes obtaining attribute information representing prediction residuals of attributes of vertices of a triangular mesh. The attribute residuals are entropy encoded in a bitstream, wherein for at least one attribute of at least one vertex, the entropy encoding comprises: encoding a first bit indicating whether the residual is zero; encoding a second bit indicating a sign of the residual; and encoding a sequence of bits, wherein an absolute value of the residual is determined based at least in part on a length of the sequence.

In some embodiments of a mesh decoding method, attribute information is obtained from a bitstream, where the attribute information represents prediction residuals of attributes of vertices of a triangular mesh. Entropy decoding is performed of the attribute residuals. For at least one attribute of at least one vertex, the entropy decoding includes decoding a first bit indicating whether the residual is zero; decoding a second bit indicating a sign of the residual; decoding a sequence of bits, wherein an absolute value of the residual is determined based at least in part on a length of the sequence; and reconstructing the attribute of the vertex based at least in part on the determined residual.

In some embodiments, the sequence of bits ends in a predetermined stop bit. For example, the sequence of bits may be zero or more “zero” bits, terminated by “one” bit acting as a stop bit. Or, the sequence of bits may be zero or more “one” bits, terminated by a “zero” bit acting as a stop bit. In some case, the absolute value of the residual is determined as the length of the sequence.

In some embodiments, the entropy decoding further comprises decoding a codeword using exponential Golomb coding, wherein an absolute value of the residual value is determined based at least in part on the codeword. In some such embodiments, the codeword is decoded in response to a determination that the sequence of bits has a predetermined maximum length and does not end in the predetermined stop bit. In some such embodiments, the absolute value of the residual is determined as a sum of a value represented by the codeword and a bias value.

The value of an attribute of a vertex may be reconstructed by obtaining a prediction of the attribute of the vertex and adding the determined residual value to the prediction of the attribute. The attribute may be, for example, a UV coordinate, a position coordinate, or another attribute type.

### Entropy Coding of Per Face Material Attributes or Other Attributes.

In some embodiments, when encoding a materialID attributes, or faceID values that are assigned so that large spans of contiguous triangles share common values using a encoding scheme such as detailed above, arrays of values defined by the encoding process may be arithmetically coded using the following scheme. The encoding/prediction process results in
Four Boolean vectors: faceIdEqualToPrevious, faceIdIsRight, faceIdIsLeft, faceIdIsFacing.
A vector notPredictedFaceId containing values which are not predicted.

The four Boolean vectors are arithmetically encoded using four separate contexts.

The vector containing unsigned face Id values is encoded using exponential Golomb coding and a number of contexts for encoding the suffix and prefix part. Those numbers may be adjusted, taking into account the range of faceId values, so as to balance the complexity/performance trade off. As an example, both prefix and suffix coding may use as many contexts as the number of bits used to represent the complete set of Id values. For values ranging from 0 to 255 we can decide to use 8 contexts for both.

In some embodiments, the exponential Golomb coding may use a optimized “shift” parameter as in previous examples.

In some embodiments, where input face ID or material ID values are not unsigned, an additional parameter may be added to translate the range of values so that translated values are all positive. Alternatively, some embodiments convert values to a positive range using:

$$y = 2 * x if x >= 0 ,$$

$$y = 2 * x - 1 , if x < 0$$

or any similar bijective transform converting the id range to positive values.

In some embodiments, the five vectors may be encoded separately, resulting in five coded arrays of bytes.

In some embodiments, the number of elements coded into each of those vectors (the original vector sizes) may be signaled. The coded byte array sizes enables decoding of each of those in parallel.

In some alternative embodiments, all the information is encoded into a single byte array using the multiple contexts, and decoding is done progressively, selecting contexts appropriately by performing contexts selection during the decoding process mirroring selections at the encoding stage.

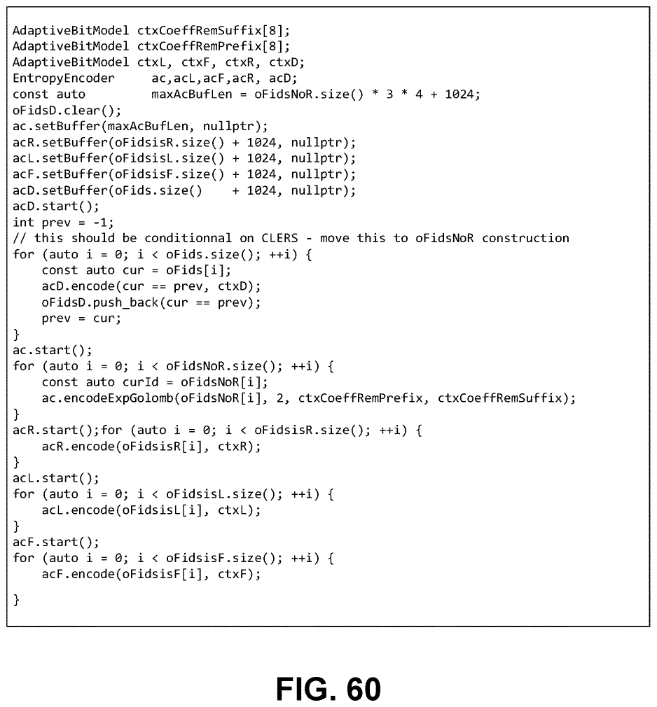

An example of Dirac AC entropy coding for coding of per-face material IDs is illustrated in FIG. 60.

In a mesh decoding method according to some embodiments, a CLERS table representing an edgebreaker encoding of a topology of a triangular mesh is obtained from a bitstream. The topology of the triangular mesh is reconstructed from the CLERS table. Ordered attribute information representing attributes of respective faces in the triangular mesh is obtained from the bitstream. The ordered attribute information is decoded to determine, for each of the faces, an attribute value of the respective face.

In some embodiments of a mesh encoding method, information is obtained describing a topology of a triangular mesh, and information is obtained indicating, for each face in the triangular mesh, an attribute value of the respective face. A CLERS table is encoded in a bitstream representing an edgebreaker encoding of the topology. Attribute information is encoded in the bitstream indicating, for each of the faces, the attribute value of the respective face.

In some embodiments, the ordered attribute information comprises at least a first vector, the first vector comprising an entry for each of a plurality of the faces, each entry in the first vector being a Boolean value indicating whether the attribute value of a respective current face is the same as an attribute value of a most-recently-decoded face.

In some embodiments, the ordered attribute information further comprises at least a second vector, the second vector comprising an entry for each of a plurality of the faces, each entry in the second vector being a Boolean value indicating whether the attribute of a respective current face is the same as an attribute value of a neighboring face in a first direction from the current face. In some such embodiments, the second vector includes entries only for faces that do not have an attribute value that is determined by the first vector.

In some embodiments, the ordered attribute information further comprises at least a third vector, the third vector comprising an entry for each of a plurality of the faces, each entry in the third vector being a Boolean value indicating whether the attribute of a respective current face is the same as an attribute value of a neighboring face in a second direction from the current face. In some such embodiments, the third vector includes entries only for faces that do not have an attribute value that is determined by the first vector or the second vector.

In some embodiments, the ordered attribute information further comprises at least a fourth vector, the fourth vector comprising an entry for each of a plurality of the faces, each entry in the fourth vector being a Boolean value indicating whether the attribute of a respective current face is the same as an attribute value of a neighboring face in a third direction from the current face. In some such embodiments, the fourth vector includes entries only for faces that do not have an attribute value that is determined by the first vector, the second vector, or the third vector.

In some embodiments, the ordered attribute information further comprises at least a fifth vector, the fifth vector comprising an entry for each of a plurality of the faces, each entry in the fourth vector including an attribute value of a respective current face. In some such embodiments, the fifth vector includes entries only for faces that do not have an attribute value that is determined by the first vector, the second vector, the third vector, or the fourth vector.

In some embodiments, the first direction is a rightward direction, the second direction is a leftward direction, and the third direction is a forward direction, e.g. relative to a directional scheme known to both the encoder and decoder. Different embodiments, however, may arrange these directions differently.

In some embodiments, the different vectors may be entropy coded using different contexts. In one example, the first vector is entropy coded using a first context, and the second vector is entropy coded using a second context different from the first context. In another example, the first vector is entropy coded using a first context, the second vector is entropy coded using a second context different from the first context, and the fifth vector is entropy coded using a fifth context different from the first and second contexts.

In some embodiments, the attribute value of each face is an integer value. In some embodiments, the attribute value of each face is a face ID value. In some embodiments, the attribute value of each face identifies a color. In some embodiments, the attribute value of each face identifies a material.

### Example Low-Level Syntax.

This section describes a syntax that is used in some example embodiments.

The syntax of an example bitstream structure is shown in Table 1.

TABLE 1

| | | | |
|---|---|---|---|
| CFG_INFO | DATA_HEADER | DATA_TOPOLOGY | DATA_ATTRIBUTES |

An example attributes bitstream (DATA_ATTRIBUTES) according to some embodiments is shown in Table 2.

TABLE 2

| | | | |
|---|---|---|---|
| Positions | UV coordinates | Normal vectors | Colors |
| | [optional] | [optional] | [optional] |

An example configuration information bitstream (CFG_INFO) according to some embodiments is shown in Table 3.

TABLE 3

| Name | Values | Size |
|---|---|---|
| CFG_CODEC_TYPE | In [Forward] | 2b |
| CFG_ENCODING_TYPE | In [Ascii, binary] | 1b |
| CFG_POS_PRED | Positions prediction mode in: | 2b |
| | [none, para, mpara] | |
| CFG_UV_PRED | UV coordinates prediction mode in: | 2b |
| | [none, para, stretch] | |
| CFG_PRED_CODER | Arithmetic coder used to encode predictions in | 2b |
| | [dirac, dirac_alt, rans] | |
| CFG_TOPO_CODER | Arithmetic coder used to encode CLERS table in | 2b |
| | [dirac, rans] | |
| CFG_INT_ATTR | Use internal quantization (false) or not (true). | 1b |
| CFG_QP | Positions quantization range in [7, 16] | 8b |
| CFG_QT | UV coordinates quantization range in [7, 16] | 8b |
| CFG_QN | Normal vectors quantization range in [7, 16] | 8b |
| CFG_QC | Color quantization range in [7, 8] | 1b |
| CFG_SEPARATE_UV_INDEX | True if separate index table is used | 1b |
| | for YV coordinates. | |
| And so on for NORMALS | | |
| then COLORS per | | |
| vertex . . . | | |
| CFG_DEDUPLICATE_POS | True if information is added to enable | 1b |
| | vertex position deduplication | |

An example data header information bitstream (DATA_HEADER) according to some embodiments is shown in Table 4.

TABLE 4

| Name | Values | Size |
|---|---|---|
| If (CFG_INT_ATTR=false){ | // quantization information if needed | |
| If ( CFG_QP >=7 ){ | | |
| DATA_MIN_POS_X | Minimum x position of the model | 32b float |
| | bounding box | |
| DATA_MIN_POS_Y | Minimum y position of the model | 32b float |
| | bounding box | |
| DATA_MIN_POS_Z | Minimum z position of the model | 32b float |
| | bounding box | |
| DATA_MAX_POS_X | Maximum x position of the model | 32b float |
| | bounding box | |
| DATA_MAX_POS_Y | Maximum y position of the model | 32b float |
| | bounding box | |
| DATA_MAX_POS_Z | Maximum z position of the model | 32b float |
| | bounding box | |
| } | | |
| If ( CFG_QT>=7){ | | |
| DATA_MIN_UV_X | Minimum x position of the UV | 32b float |
| | coordinates bounding box | |
| DATA_MIN_UV_Y | Minimum y position of the UV | 32b float |
| | coordinates bounding box | |
| DATA_MAX_UV_X | Maximum x position of the UV | 32b float |
| | coordinates bounding box | |
| DATA_MAX_UV_Y | Maximum y position of the UV | 32b float |
| | coordinates bounding box | |
| } | | |
| And so on for NORMALS then COLORS | | |
| per vertex... | | |
| } | | |
| DATA_VERTEX_COUNT | Number of predicted vertices | UInt16 |
| If (CFG_SEPARATE_UV_INDEX = 1){ | | |
| DATA_UVCOORD_COUNT | Number of predicted UV coordinates | UInt16 |
| Else { | | |
| DATA_UVCOORD_COUNT | = DATA_VERTEX_COUNT | |
| } | | |
| DATA_NORMAL_COUNT | Number of predicted normal values | UInt16 |
| | = DATA_VERTEX_COUNT or 0 | |
| | (Useless?) | |
| DATA_COLOR_COUNT | Number of predicted color values | UInt16 |
| | = DATA VERTEX_COUNT or 0 | |
| | (Useless?) | |
| DATA_TRIANGLE_COUNT | Number of encoded triangles (i.e. size of | UInt16 |
| | the CLERS table). | |
| | (not used in some embodiments as it can | |
| | be determined by number of CLERS | |
| | symbols + number of CC) | |
| | NOTE that this is the number of encoded | |
| | triangles, including dummy triangles | |
| | connected to dummy points | |
| DATA_CLERS_TABLE_SIZE | Number of symbols in the CLERS table | UInt16 |
| DATA_HANDLE_TABLE_SIZE | Size of the handle table (two values per | |
| | handle). | |
| DATA_CC_COUNT | Number of connected components | |
| DATA_HANDLE_SIZE_TABLE_SIZE | Size of the table storing the sizes of the | |
| | handle table of each component | |
| DATA_DUMMY_POINT_COUNT | Number of virtual dummy points | |
| | introduced into the mesh (= size of the | |
| | dummy points index table) | |

An example data topology bitstream (DATA_TOPOLOGY) according to some embodiments is given in Table 5.

TABLE 5

| Name | Values | Size |
|---|---|---|
| If (CFG_TOPO_CODER = DIRAC){ | | |
| DATA_CLERS_DIRAC_BYTE_COUNT | Number of bytes used to | UInt32 |
| | store the Dirac entropy | |
| | coded table of CLERS | |
| DATA_CLERS_DIRAC_BYTES | Dirac entropy coded table | DATA_CLERS_DIRAC_ |
| | of CLERS | BYTE_COUNT |
| | | UInt32 |
| } | | |
| If ( CFG_TOPO_CODER = RANS){ | | |
| DATA_CLERS_RANS_BYTE_COUNT | Number of bytes used to | UInt32 |
| | store the RANS entropy | |
| | coded table of CLERS | |
| DATA_CLERS_RANS_BYTES | RANS entropy coded table | DATA_CLERS RANS_ |
| | of CLERS | BYTE_COUNT |
| | | UInt32 |
| } | | |
| If (CFG_SEPARATE_UV_INDEX = 1){ | | |
| DATA_UV_SEAMS_TABLE_SIZE | Size of the array of Boolean | UInt32 |
| | indicating seams per edges | |
| DATA_UV_SEAMS | Byte count of the entropy | UInt32 |
| RANS_BYTE_COUNT | coded table of Boolean UV | |
| | seams indications | |
| DATA_UV_SEAMS_TABLE | AC coded array of boolean | DATA_UV_SEAMS_ |
| | | TABLE_SIZE*1b |
| } | | |
| (Other attributes may similarly be coded with | | |
| separate indices.) | | |
| DATA_HANDLES_TABLE | Array of unsigned integers | DATA_HANDLE_TABLE_ |
| | describing handles, one | SIZE |
| | handle per two consecutive | VarUInt |
| | values. | |
| DATA_HANDLE_COUNT_TABLE | Array of unsigned integers, | DATA_HANDLE_COUNT_ |
| | Handle sizes where two | TABLE_SIZE |
| | values per handle, first one | VarUInt |
| | is cc-component, second is | |
| | handle count in this | |
| | component. | |
| | Those value are | |
| | delta+varint encoded. | |
| DATA DUMMY_POINTS_TABLE | Array of data defining | DATA_DUMY_ |
| | dummy point indices, each | POINT_COUNT |
| | value being delta coded as | VarUInt |
| | follows. Let i be the index | |
| | of the dummy point in the | |
| | table of dummy points | |
| | indices named Dummy. | |
| | If (i > 0) ? | |
| | Value[i]=Dummy[i] - | |
| | Dummy [i - 1] | |
| | Else | |
| | Value[i]Dummy[0]; | |
| If (CFG_DEDUPLICATE_POS = 1){ | | |
| DATA_DEDUP_POS_COUNT | number of duplicated | VarUInt |
| | vertices is the sum of the | |
| | number of original vertices | |
| | that have been split, and the | |
| | number of vertices added | |
| | during the process of | |
| | duplication to fix the | |
| | manifoldness of the mesh | |
| DATA_DEDUP_POS_OFFSET_DELTA | Triangle index where the | DATA_DEDUP_POS_ |
| | added vertex when | COUNT |
| | decoding is a duplicate. | VarUInt |
| | For the first triangle of each | |
| | connected component there | |
| | are 3 vertices sharing the | |
| | same triangle index. Those | |
| | are discriminated using the | |
| | position01 info. | |
| DATA_DEDUP_POS_INDEX | index common to all | DATA_DEDUP_POS_ |
| | duplicated vertices sharing | COUNT |
| | the same parent in the | VarUInt |
| | original mesh before | |
| | splitting | |
| DATA_DEDUP_POS_01_SIZE | Size in bytes of the AC | VarUInt |
| | coded | |
| | DATA DEDUP_POS_01 | |
| | TABLE | |
| DATA_DEDUP_POS_01_TABLE | Table gathering the | 2*DATA_CC_COUNT |
| | duplicated status of the 2 | 1b (Boolean) |
| | first vertices (index 0 or 1, | AC coded |
| | hence _01) of each | |
| | connected component | |
| } | | |

Table 6 illustrates an example of a data position attributes bitstream according to some embodiments.

TABLE 6

| Name | Values | Size |
|---|---|---|
| DATA_POS_START_COUNT= | Number of start positions. | UInt16 |
| DATA_CC_COUNT | | |
| DATA_POS_START_TABLE | Array of data defining per | 3*DATA_POS _ |
| | connected component start | START_COUNT |
| | positions. 3 int values per | VarUInt |
| | position. Delta encoded. | |
| | Using variable Uint | |
| | encoding | |
| If ( CFG_PRED_CODER = DIRAC){ | | |
| DATA_POS_PRED_TABLE_AC_SIZE | Size in bytes of the AC | UInt32 |
| | encoded predicted positions | |
| | residuals | |
| DATA_POS_PRED_TABLE | Array of data defining per | 3* |
| | position residuals (3 | DATA_VERTEX_ |
| | residuals per non start, non | COUNT * Int |
| | dummy position). | AC Coded |
| } | | |
| If (CFG_PRED_CODER = RANS){ | | |
| DATA_POS_PRED_TABLE_AC_SIZE | Size in bytes of the AC | UInt32 |
| | encoded predicted positions | |
| | residuals | |
| DATA_POS_PRED_TABLE | Array of data defining per | 3* |
| | position residuals (3 | DATA_VERTEX_ |
| | residuals per non start, non | COUNT * Int |
| | dummy position). | AC Coded |
| } | | |

Table 7 illustrates an example UV coordinate attributes bitstream according to some embodiments.

TABLE 7

| Name | Values | Size |
|---|---|---|
| If (separateUVindex){ | | |
| DATA_UV_START_COUNT | Number of start texture | UInt16 |
| | coordinates. | |
| } Else { | | |
| DATA_UV_START_COUNT= | | |
| DATA POS_START_COUNT | | |
| } | | |
| DATA_UV_START_TABLE | Array of data defining start | 2*DATA_UV_START_ |
| | UV values (UV where no | COUNT |
| | prediction/residuals). 2 int | VarUInt |
| | values per UV. Delta | |
| | encoded. Using variable | |
| | Uint encoding | |
| If (CFG_PRED_CODER = DIRAC){ | | |
| DATA_UV_PRED_TABLE_AC SIZE | Size in bytes of the AC | UInt32 |
| | encoded predicted UV | |
| | residuals | |
| DATA_UV_PRED_TABLE | Array of data defining per | DATA_UVCOORD_ |
| | position residuals (2 | COUNT*Int |
| | residuals per non start, non | AC Coded |
| | dummy UV). | (To be detailed) |
| } | | |
| If (CFG_PRED_CODER = RANS){ | | |
| DATA_UV_PRED_TABLE_AC_SIZE | Size in bytes of the AC | UInt32 |
| | encoded predicted UV | |
| | residuals | |
| DATA_UV_PRED_TABLE | Array of data defining per | 2*DATA_UVCOORD_ |
| | position residuals (2 | COUNT*Int |
| | residuals per non start, non | AC Coded |
| | dummy UV). | (To be detailed) |
| } | | |
| DATA_UV_STRETCH_ORIENTATION_ | Number of bits defining the | UInt32 |
| COUNT | orientation selection when | |
| | UV stretch prediction can | |
| | be estimated. | |
| DATA_UV_STRETCH_ORIENTATION_ | Size in bytes of the AC | UInt16 |
| TABLE_AC_SIZE | encoded stretch orientation. | |
| | Various embodiments may | |
| | use Rans and/or Dirac | |
| | coding | |
| DATA_UV_STRETCH_ORIENTATION | Array of Boolean values | DATA_UV_STRETCH_ |
| TABLE | defining the selected | ORIENTATION_ |
| | orientation when UV are | COUNT*1b |
| | stretch predicted | AC Coded |

### Example Extended Syntax.

An example extended syntax that may be used in some embodiments is provided in Appendix A. The syntax elements described in Appendix A, and their associated semantics, are provided as examples only. The present disclosure contemplates variations and extensions of the syntax elements described in Appendix A.

### Performance.

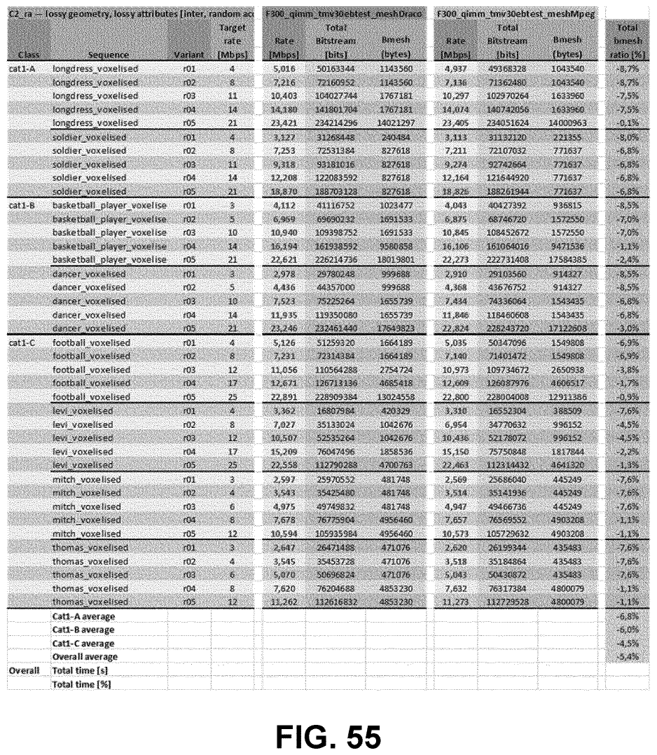

Performance of an example embodiment of the overall compression as described herein in the context of V-DMC were compared against comparable compression using Google Draco. See results of figure which shows compression gains for the base mesh coding. FIG. 55 illustrates compression performance of an encoding method as described herein as comparted to Google Draco for the encoding of base mesh in V-DMC. Results for each CTC test sequence each averaged over 300 frames. PSNRs are not presented since they are not impacted. The results show an overall average gain of 5.4% over Draco rates.

### Example System Hardware.

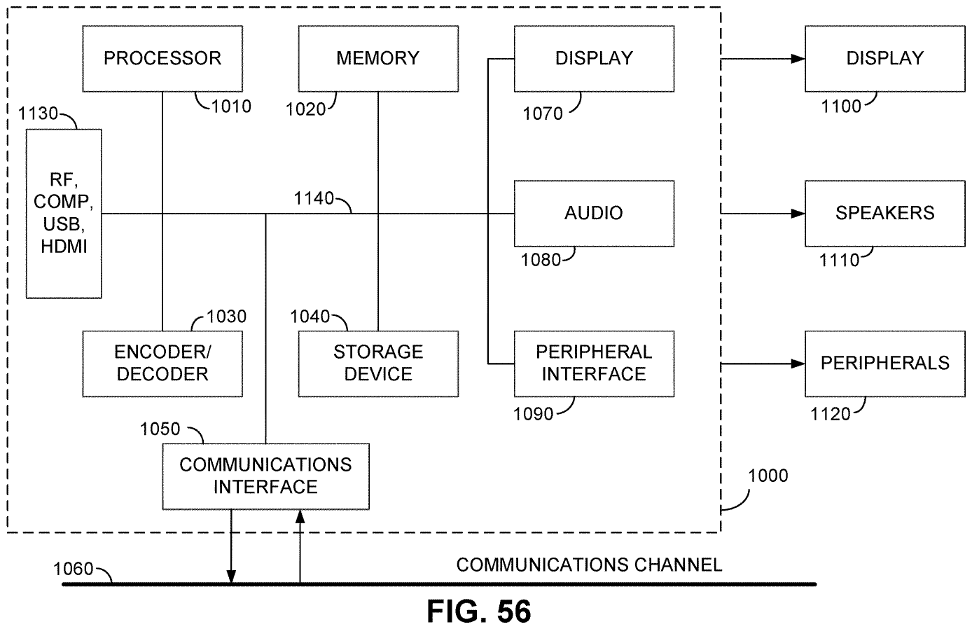

Example embodiments of encoders and/or decoders (collectively coders) configured to implement embodiments described herein may be implemented using systems such as the system of FIG. 56. FIG. 56 is a block diagram of an example of a system in which various aspects and embodiments are implemented. System 1000 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or WC (Versatile Video Coding, a new standard being developed by JVET, the Joint Video Experts Team).

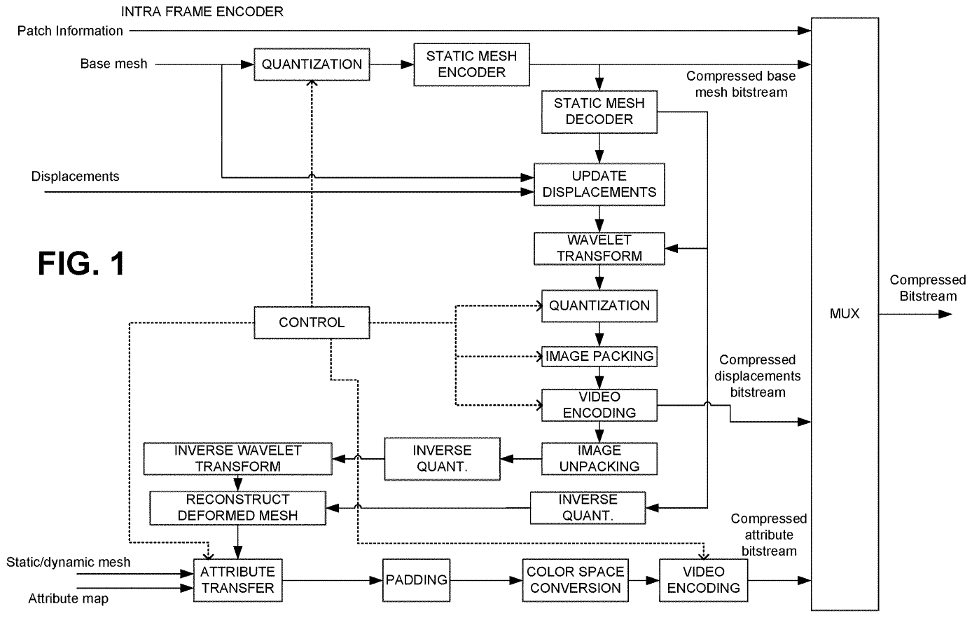

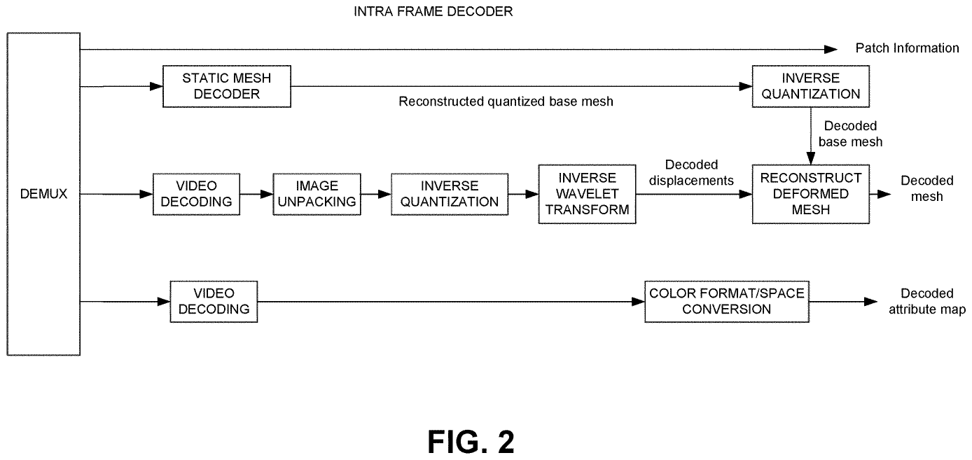

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1C, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the Inter-IC (12C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

### Additional Embodiments

A mesh encoding method according to some embodiments comprises: encoding a first connected component of a mesh with edgebreaker coding; after encoding the first connected component of the mesh, identifying an uncoded corner in the mesh; and encoding a second connected component of the mesh using the identified uncoded corner as an entry corner.

A mesh encoding method according to some embodiments comprises: identifying at least one non-manifold edge in a mesh; duplicating vertices along the non-manifold edge to separate the non-manifold edge into at least two manifold edges; stitching together two of the at least two manifold edges; and after stitching together two of the at least two manifold edges, encoding the mesh using edgebreaker coding.

A mesh encoding method according to some embodiments comprises: identifying at least one non-manifold edge in a mesh, the non-manifold edge being defined by parent vertices; preprocessing the mesh by duplicating parent vertices along the non-manifold edge to separate the non-manifold edge into at least two manifold edges, each manifold edge being defined by child vertices, each child vertex being duplicated from a respective parent vertex; encoding the preprocessed mesh into a bitstream using edgebreaker coding; and providing in the bitstream information identifying, the parent vertex of the child vertices.

A mesh decoding method according to some embodiments comprises: obtaining from a bitstream information defining a plurality of connected components of an edgebreaker-coded non-manifold mesh; obtaining from the bitstream information associating child vertices with parent vertices; at least partially decoding at least two of the connected components, each of the connected components having child vertices associated with respective parent vertices; and deduplicating the child vertices to reconstruct the non-manifold mesh.

A mesh encoding method according to some embodiments comprises: preprocessing a mesh having a hole by creating a dummy vertex, the dummy vertex being connected to each vertex along a perimeter of the hole; encoding the preprocessed mesh in a bitstream with edgebreaker coding; encoding in the bitstream information identifying the dummy vertex; and encoding at least one attribute for each of a plurality of vertices in the preprocessed mesh, wherein the attribute is not encoded for the dummy vertex.

A mesh decoding method according to some embodiments comprises: obtaining from a bitstream information encoding a mesh; obtaining from the bitstream information identifying at least one dummy vertex in the mesh; and decoding from the bitstream attribute information for a plurality of vertices in the mesh, wherein attribute information is not decoded for the at least one dummy vertex.

In some embodiments, decoding attribute information for a plurality of vertices comprises predicting attribute information for a plurality of the vertices, wherein no attribute information is predicted for the dummy points.

Some embodiments further comprise removing the dummy points.

A mesh encoding method according to some embodiments comprises: encoding a connectivity of a mesh; entropy encoding a first table of starting point positions of vertices in the mesh; and separately entropy encoding a second table of point residuals of vertices in the mesh.

A mesh decoding method according to some embodiments comprises: decoding information indicating connectivity of a mesh; entropy decoding a first table of starting point positions of vertices in the mesh; and separately entropy decoding a second table of point residuals of vertices in the mesh.

A mesh encoding method according to some embodiments comprises: obtaining information defining a mesh having a plurality of connected components (CCs), each vertex in a CC having a unique global-scope index; for each CC, shifting the indices of the vertices in the CC from the global-scope index to a CC-scope index; and encoding each of the CCs using the CC-scope indices.

A mesh decoding method according to some embodiments comprises: obtaining information encoding a plurality of connected components (CCs), each vertex in a CC having a respective CC-scope index; decoding each of the CCs; and for each of the vertices, shifting the index of the vertex from the CC-scope index to a global-scope index.

A mesh encoding method according to some embodiments comprises: obtaining information describing a mesh having a plurality of triangles, each triangle having an attribute; encoding the mesh as an ordered sequence of symbols in edgebreaker coding, each of the triangles corresponding to an associated one of the symbols; and encoding the attributes of the triangles, the attribute of a current triangle being encoded using a prediction based only on attributes of at least one triangle preceding the current triangle in the ordered sequence of symbols.

A mesh decoding method comprising: obtaining an ordered sequence of symbols representing an edgebreaker coding of a mesh having a plurality of triangles, each triangle having an attribute; decoding the mesh; and decoding the attributes of the triangles, the attribute of a current triangle being decoded using a prediction based only on attributes of at least one triangle preceding the current triangle in the ordered sequence of symbols.

A mesh encoding method according to some embodiments comprises: obtaining information describing a mesh having a plurality of triangles, each triangle having an attribute; encoding the mesh as an ordered sequence of symbols in edgebreaker coding, each of the triangles corresponding to an associated one of the symbols; and encoding the attributes of the triangles, the attribute of a current triangle being encoded using a prediction based on attributes of at least one triangle adjacent to the current triangle in the mesh.

In some embodiments, encoding the attributes of the triangles includes encoding a plurality of Boolean vectors, the plurality of Boolean vectors collectively indicating, for at least a plurality of the triangles, a corresponding triangle from which the respective attribute is predicted.

Some embodiments further include performing arithmetic coding of the plurality of Boolean vectors.

In some embodiments, the attribute is an identifier.

A mesh decoding method according to some embodiments comprises: obtaining an ordered sequence of symbols representing an edgebreaker coding of a mesh having a plurality of triangles, each triangle having an attribute; decoding the mesh; and decoding the attributes of the triangles, the attribute of a current triangle being decoded using a prediction based on attributes of at least one triangle adjacent to the current triangle in the mesh.

In some embodiments, decoding the attributes of the triangles includes decoding a plurality of Boolean vectors, the plurality of Boolean vectors collectively indicating, for at least a plurality of the triangles, a corresponding triangle from which the respective attribute is predicted.

In some embodiments, decoding the plurality of Boolean vectors comprises arithmetic decoding of the plurality of Boolean vectors.

In some embodiments, the attribute is an identifier.

An apparatus according to some embodiments comprising one or more processors, the apparatus being configured to perform any of the methods described herein.

An apparatus according to some embodiments comprises at least one processor and a computer-readable medium storing instructions for performing any of the methods described herein.

Some embodiments include a computer-readable medium (e.g. a non-transitory medium) storing instructions for performing any of the methods described herein.

Some embodiments include a computer-readable medium storing a mesh encoded according to any of the methods described herein.

Some embodiments include a signal conveying a mesh encoded according to any of the methods described herein.

Some example embodiments provide for a lossless mode capable of reconstructing meshes with “bad” connectivity, allowing for lossless recreation of non-manifold surfaces if desired.

Some example embodiments provide support for holes and boundaries, through “virtual” dummy points that are coded without coding of the attributes of the dummy points.

Some example embodiments provide support for multiple connected components (CCs).

Some embodiments provide an extension of multi-parallelogram prediction for geometry to support virtual dummy points.

Some embodiments add support for texture coordinates encoding using unique index table separate index tables. Some such embodiments provide an extension of stretch predictions to support dummy points and separate index tables when needed.

Some embodiments provide specific binarization schemes and AC context handling for use with Dirac arithmetic coding.

Some embodiments include support for per face attributes (identifiers or colors), coded using the triangle chain.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

### APPENDIX A

### 1. Introduction

A mesh set of vertices may be 3D positions, with a set of attributes attached, and related connectivity (NOTE position connectivity may not be identical to per attribute connectivity).

Attributes may be per face or per vertex. A vertex may have multiple attribute values depending on the face considered, attribute values may be shared per face. When attribute values are not systematically shared per vertex, then the attribute connectivity is different from the vertex connectivity.

CLERS is set of symbols used to describe the topology of a (single component) mesh. C=(add triangle without additional attachment), L=left, R=right, S=split, E=end. These symbols are sufficient to describe holes and handles, not applicable to non-manifold meshes.

### 2. Syntax and Semantics

### 2.1. Specification of Syntax Functions and Descriptors

ae(v): context-adaptive arithmetic entropy-coded syntax element.
vu(v): unsigned integer using a variable number of bytes as groups of 8 bits. The parsing process for this descriptor is specified by the return values of the functions read_bits(1) followed by readbits(7). The second value is appended to the resulting bit sequence and the process iterated while the first value equals 1. In particular, the parsing process for this descriptor is specified as follows:

```
vu(v) {
            value = 0
            do {
                  continue = read_bits( 1)
                  partial_value = read_bits( 7)
                  value = ( value << 7 ) | partial_value
            }
            while( continue )
            return value
}
```

vi(v): signed integer using a variable number of bytes as groups of 8 bits. The parsing process for this descriptor is specified by the return values of the functions read_bits(1) followed by readbits(7). The second value is appended to the resulting bit sequence and the process iterated while the first value equals 1. The resulting bit sequence interpreted as an unsigned integer is assigned to a signed integer value considering that syntax elements have been mapped to unsigned integers by ordering those by their absolute value in increasing order and representing the positive value for a given absolute value with the highest coded value. Table A.1 provides the assignment rule. In particular, the parsing process for this descriptors specified as follows:

```
vi(v) {
            value = 0
            do {
                  continue = read_bits( 1)
                  partial_value = read_bits( 7 )
                  value = ( value << 7 ) | partial_value
            }
            while( continue )
            is_positive = ! ( value & 1 )
            value = ( value >> 1 )
            if (is_positive)
                  return value
            else
                  return −( value + 1 )
}
```

TABLE A.1
Assignment of syntax element to codeNum

| codeNum | syntax element value |
|---|---|
| 0 | 0 |
| 1 | −1 |
| 2 | 1 |
| 3 | −2 |
| 4 | 2 |
| 5 | −3 |
| 6 | 3 |
| k | ((k + 1)/2) * (−1)^{k} |

### Notes

A limit is specified in number of bytes to avoid definition of very large values vu32(v) for max 32 bits 4 bytes.

Either code up to 32 bits using max 5 bytes, or code using max 4 bytes values on 7*3±8=29 bits

### 2.2. Mesh Syntax

### 2.2.1. General Mesh Coding Syntax

### Notes

Here, header information may be static for a whole sequence

| mesh_coding( ) { | Descriptor |
|---|---|
| mesh_coding_header( ) | |
| mesh_position_coding_payload( ) | |
| mesh_attributes_coding_payload( ) | |
| } | |

### 2.2.2. Mesh Coding Header Syntax

| mesh_coding_header( ) { | Descriptor |
|---|---|
| mesh_codec_type | u(2) |
| mesh_position_encoding_parameters( ) | |
| mesh_position_dequantize_parameters( ) | |
| mesh_attribute_count | u(3) |
| for( i=0; i<mesh_attribute_count; i++ ){ | |
| mesh_attribute_type[ i ] | u(3) |
| mesh_attribute_per_face[ i ] (†) | u(1) |
| if( !mesh_attribute_per_face[ i ]) (†) | |
| mesh_attribute_has_separate_index[ i ] (†) | u(1) |
| mesh_attribute_depth_minus1[ i ] (†) | u(4) |
| mesh_attribute_encoding_parameters ( i ) | |
| mesh_attribute_dequantize_parameters ( i ) | |
| } | |
| length_alignment( ) | |
| } | |

Features marked with a dagger (t) may be excluded in some embodiments. mesh_codec_type indicates the identifier selected codec method. Table A.2 describes the list of supported methods.

TABLE A.2
Mesh codec types

| mesh_codec_type | Identifier | Codec Type |
|---|---|---|
| 0 | CODEC_TYPE_FORWARD | Forward |
| 1 . . . 3 | CODEC_TYPE_RESERVED | Reserved |

NOTE—Forward traversal only implemented in the current version, could be extended with e.g. Reverse traversal or other high level variants.

mesh_attribute_count indicate the number of encoded attributes.

mesh_attribute_type[i] indicates the attribute type of the i-th attribute where i is in the range 0 to 7. Table A.3 describes the list of supported attributes.

TABLE A.3
Mesh attributes types

| mesh_attribute_type | | Attribute |
|---|---|---|
| [i] | Identifier | type |
| 0 | MESH_ATTR_TEXCOORD | Texture |
| | | coordinate |
| 1 | MESH_ATTR_NORMAL | Normal |
| 2 | MESH_ATTR_COLOR | Color |
| 3 | MESH_ATTR_MATERIAL_ID | Material ID |
| 4 | MESH_ATTR_GENERIC | Generic |
| 5 . . . 7 | MESH_ATTR_RESERVED | Reserved |
| 8 | MASH_ATTR_UNSPECIFIED | Unspecified |

NOTE—Generic attributes will have their number of components specified by the value of the corresponding mesh_attribute_generic_num_components_minus1[index]. Other attributes have a fixed number of components.

### 2.2.3. Mesh Position Encoding Parameters Syntax

| mesh_position_encoding_parameters( ) { | Descriptor |
|---|---|
| mesh_position_depth_minus1 | u(4) |
| mesh_position_deduplicate | u(1) |
| mesh_clers_symbols_encoding_method | ue(v) |
| mesh_position_prediction_method | ue(v) |
| mesh_position_residuals_encoding_method | ue(v) |
| } | |

mesh_position_depth_minus1 plus 1 specifies the number of bits used to represent 3d position coordinates.
NOTE—3d positions coordinates are coded using 1 to 16 bits. However the usage of very small depths such as 1 bit ot 2 bits for instance is extremely unlikely.

mesh_position_deduplicate equal to 1 specifies that vertex de-duplication is applied (In some embodiments and/or under some conditions, de-duplication may not be applied).
NOTE—some example embodiments use general sizing information (i.e. the size of some information required to deduplicate) at a lower level, but would not be as flexible.

mesh_clers_symbols_encoding_method specifies the method used to encode

mesh_clers_symbol[i] values. Table A.4 describes the list of supported methods.

TABLE A.4
Mesh CLERS symbol encoding methods

| mesh_clers_symbols_en- | | Encoding |
|---|---|---|
| coding_method | Identifier | Method |
| 0 | MESH_CLERS_{—} | Default |
| | AC_DEFAULT | |
| >1 | MESH_CLERS_{—} | Reserved |
| | AC_RESERVED | |

NOTE—We therefore use 1 bit while only the default method is selectable. When other methods are added they should provide significant gain so that the overhead of ue(v) encoding will be negligible. The number of allowed encoding methods can then be extended with no limits without compromising the bitstream size nor the parsing. The same approach is used for all prediction and encoding methods selections.

mesh-position-prediction_method specifies the method used to predict vertex positions and compute residuals mesh_position_residual[i][j]. Table A.5 describes the list of supported methods.

TABLE A.5
Mesh position prediction methods

| mesh_position_pre- | | Prediction |
|---|---|---|
| diction_method | Identifier | Method |
| 0 | MESH_POSITION_MPARA | Multiple |
| | | Parallel- |
| | | ograms |
| >1 | MESH_POSITION_RESERVED | Reserved |

mesh_position_residuals_encoding_method specifies the method used to encode mesh_position_residual[i][j] values. Table A.6 describes the list of supported methods.

TABLE A.6
Mesh position residuals encoding methods

| mesh_position_resid- | | Encoding |
|---|---|---|
| uals_encoding_method | Identifier | Method |
| 0 | MESH_POSITION_{—} | Default |
| | AC_DEFAULT | |
| >1 | MESH_POSITION_{—} | Reserved |
| | AC_RESERVED | |

### 2.2.4 Mesh Position Dequantize Parameters Syntax

| mesh_position_dequantize_parameters( ) { | Descriptor |
|---|---|
| mesh_position_dequantize | u(1) |
| if(mesh_position_dequantize) { | |
| for(i=0; i< 3; i++ ){ | |
| mesh_position_min [ i ] | fl(32) |
| mesh_position_max [ i ] | fl(32) |
| } | |
| } | |
| } | |

mesh_position_dequantize equal to 1 specifies that the decoded 3d position shall be dequantized using bounding box information. mesh_position_dequantize equal to 0 specifies that decoded attributes are (quantized) unsigned integers.

mesh_position_min[i] specifies the minimum value of the dequantized i-th components of 3d positions. A quantized position i-th component value of 0 will be mapped to mesh_position_min[i] after dequantization.
NOTE—mesh_position_min[i] and mesh_position_min[j] are defined as fl(32) values. fl(32) are defined and used in 23090-5 for the description of viewport camera parameters and viewport position.

mesh_position_max[i] specifies the maximum value of the dequantized i-th components of 3d positions. A quantized position i-th component value of 2^{mesh_position_depth_minus1+1}−1 will be mapped to mesh_position_max[i] after dequantization.

### 2.2.5. Mesh Attributes Encoding Parameters Syntax

| mesh_attribute_encoding_parameters( index ) { | Descriptor |
|---|---|
| mesh_attribute_per_face[ index ] | u(1) |
| if( !mesh_attribute_per_face[ index ]) | |
| mesh_attribute_has_separate_index[ index ] | u(1) |
| mesh_attribute_depth_minus1[ index ] | u(4) |
| mesh_attribute_prediction_method[ index ] | ue(v) |
| mesh_attribute_residuals_encoding_method[ index ] | ue(v) |
| } | |

mesh_attribute_per_face[i] equal to 1 indicates that the i-th attribute has values defined per face. mesh_attribute_per_face[i] equal to 0 indicates that the i-th attribute has values defined per vertex.
NOTE—When attributes are defined per face there is no index ambiguity. When attributes are defined per vertex they can each have their own set of indices.

mesh_attribute_has_separate_index[i] specifies if the i-th attribute as a specific index sequence attached. (When no separate index is defined, any other attribute may be used as reference if not using the position index).

mesh_attribute_depth_minus1[i] plus 1 specifies the number of bits used to represent the components of the i-th attribute.

mesh_attribute_prediction_method[i] specifies the method used to predict the i-th attribute values and compute residuals mesh_attribute_residual[i][j][k]. Table A.7 describes the list of supported methods for attributes with mesh_attribute_type equal to MESH_ATTR_TEXCOORD, Table A.8 for attributes with mesh_attribute_type equal to MESH_ATTR_NORMAL, Table A.9 for attributes with mesh_attribute_type equal to MESH_ATTR_COLOR, Table A.10 for attributes with mesh_attribute_type equal to MESH_ATTR_MATERIAL_ID, Table A.11 for attributes with mesh_attribute_type equal to MESH_ATTR_GENERIC.

TABLE A.7
Mesh attibute prediction methods for
MESH_ATTR_TEXCOORD type attributes

| mesh_attribute_pre- | | Prediction |
|---|---|---|
| diction_method | Identifier | Method |
| 0 | MESH_TEXCOORD_STRETCH | Stretch |
| >1 | MESH_TEXCOORD_RESERVED | Reserved |

TABLE A.8
Mesh attibute prediction methods for
MESH_ATTR_NORMAL type attributes

| mesh_attribute_pre- | | Prediction |
|---|---|---|
| diction_method | Identifier | Method |
| 0 | MESH_NORMAL_DEFAULT | Default |
| >1 | MESH_NORMAL_RESERVED | Reserved |

TABLE A.9
Mesh attibute prediction methods for
MESH_ATTR_COLOR type attributes

| mesh_attribute_pre- | | Prediction |
|---|---|---|
| diction_method | Identifier | Method |
| 0 | MESH_COLOR_DEFAULT | Default |
| >1 | MESH_COLOR_RESERVED | Reserved |

TABLE A.10
Mesh attibute prediction methods for
MESH_ATTR_MATERIAL_ID type attributes

| mesh_attribute_pre- | | Prediction |
|---|---|---|
| diction_method | Identifier | Method |
| 0 | MESH_MATERI- | Default |
| | ALID_DEFAULT | |
| >1 | MESH_MATERI- | Reserved |
| | ALID_RESERVED | |

TABLE A.11
Mesh attibute prediction methods for
MESH_ATTR_GENERIC type attributes

| mesh_attribute_pre- | | Prediction |
|---|---|---|
| diction_method | Identifier | Method |
| 0 | MESH_GENERIC_DEFAUT | Default |
| >1 | MESH_GENERIC_RESERVED | Reserved |

mesh_attribute-residuals_encoding_method[i] specifies the method used to encode values in the mesh_attribute_residual[i] array. Table A.12 describes the list of supported methods for attributes with mesh_attribute_type equal to MESH_ATTR_TEXCOORD, Table A.13 for attributes with mesh_attribute_type equal to MESH_ATTR_NORMAL, Table A.14 for attributes with mesh_attribute_type equal to MESH_ATTR_COLOR, Table A.15 for attributes with mesh-attribute type equal to MESH_ATTR_MATERIAL_ID, Table A.16 for attributes with mesh_attribute type equal to MESH_ATTR_GENERIC.
NOTE—While a default prediction method has been implemented for attributes of type MESH_ATTR_TEXCOORD and MESH-ATTR-MATERIAL-ID, default prediction methods still have to be implemented for other attribute types.

TABLE A.12
Attribute residuals encoding methods for
MESH_ATTR_TEXCOORD type attributes

| mesh_attribute_resid- | | Encoding |
|---|---|---|
| uals_encoding_method | Identifier | Method |
| 0 | MESH_TEXCOORD_{—} | Default |
| | AC_DEFAULT | |
| >1 | MESH_TEXCOORD_{—} | Reserved |
| | AC_RESERVED | |

TABLE A.13
Attribute residuals encoding methods for
MESH_ATTR_NORMAL type attributes

| mesh_attribute_resid- | | Encoding |
|---|---|---|
| uals_encoding_method | Identifier | Method |
| 0 | MESH_NOR- | Default |
| | MAL_AC_DEFAULT | |
| >1 | MESH_NOR- | Reserved |
| | MAL_AC_RESERVED | |

TABLE A.14
Attribute residuals encoding methods for
MESH_ATTR_COLOR type attributes

| mesh_attribute_resid- | | Encoding |
|---|---|---|
| uals_encoding_method | Identifier | Method |
| 0 | MESH_CO- | Default |
| | LOR_AC_DEFAULT | |
| >1 | MESH_CO- | Reserved |
| | LOR_AC_RESERVED | |

TABLE A.15
Attribute residuals encoding
methods for MESH_ATTR_{—}
MATERIAL_ID type attributes

| mesh_attribute_resid- | | Encoding |
|---|---|---|
| uals_encoding_method | Identifier | Method |
| 0 | MESH_MATERI- | Default |
| | ALID_AC_DEFAULT | |
| >1 | MESH_MATERI- | Reserved |
| | ALID_AC_RESERVED | |

TABLE A.16
Attribute residuals encoding methods for
MESH_ATTR_GENERIC type attributes

| mesh_attribute_resid- | | Encoding |
|---|---|---|
| uals_encoding_method | Identifier | Method |
| 0 | MESH_GENER- | Default |
| | IC_AC_DEFAULT | |
| >1 | MESH_GENER- | Reserved |
| | IC_AC_RESERVED | |

### 2.2.6. Mesh Attributes Dequantize Parameters Syntax

### Notes

In some embodiments, looping may be revised for efficiency so as to enable alignment of fl(32) values. Such embodiments may then loop over attribute indices to define

mesh_attribute_dequantize[index] and mesh_attribute_num_components_minus1[index] and a NumComponents[index], then over mesh attribute min mesh attribute max values.

| mesh_attribute_dequantize_parameters( index ) { | Descriptor |
|---|---|
| mesh_attribute_dequantize[ index ] | u(1) |
| if(mesh_attribute_dequantize[ index ]) | |
| if(mesh_attribute_type[ index] == MESH_ATTR_TEXCOORD ) | |
| NumComponents[ index ] = 2 | |
| else if(mesh_attribute_type[ index ] == MESH_ATTR_NORMAL ) | |
| NumComponents[ index ] = 3 | |
| else if(mesh_attribute_type[ index ] == MESH_ATTR_COLOR ) | |
| NumComponents[ index ] = 3 | |
| else if(mesh_attribute_type[ index ] == MATERIAL_ID ) | |
| NumComponents[ index ] = 1 | |
| else if(mesh_attribute_type[ index ] == GENERIC ) { | |
| mesh_attribute_ num_components_minus1[ index ] | u(2) |
| NumComponents[ index ] = | |
| mesh attribute_num_components_minus1[ index ]+1 | |
| } | |
| for( j=0; j< NumComponents[ index ]; j++ ){ | |
| mesh_attribute_min[ index ][ j ] | fl(32) |
| mesh_attribute_max[ index ][ j ] | fl(32) |
| } | |
| } | |
| } | |

mesh_attribute_dequantize[i] equal to 1 specifies that the decoded attribute shall be PPOT dequantized using bounding box information, mesh_attribute_dequantize[i] equal to 0 specifies that decoded attributes are (quantized) unsigned integers.

mesh_attribute_num_components_minus1[index] plus 1 specifies the number of components of the index-th attribute when mesh_attribute_type[index] is equal to MESH_ATTR_GENERIC.

mesh_attribute-min[index][j] specifies the minimum value of the dequantized j-th components of the i-th attribute. A quantized index-th attribute j-th component value of 0 will be mapped to mesh_attribute_min[index][j] after dequantization.

mesh_attribute_max[index][j] specifies the maximum value of the dequantized j-th components of the i-th attribute. A quantized index-th attribute j-th component value of 2 ^{mesh_attribute_depth_minus1[index]+1}−1 will be mapped to mesh_attribute_max[index][j] after dequantization.

### 2.2.7. Mesh Position Coding Payload Syntax

### Notes

When arithmetic coding is used i.e. using ae(v) descriptors, in the general case we specify the coded length in bytes so as to enable parallel decoding, otherwise sequential parsing would be called for.

| mesh_position_coding_payload( ) { | Descriptor |
|---|---|
| mesh_vertex_count | vu(v) |
| mesh_clers_count | vu(v) |
| mesh_cc_count | vu(v) |
| mesh_dummy_vertex_count | vu(v) |
| for( i=0; i<mesh_dummy_vertices_count; i++ ){ | |
| mesh_dummy_index_delta[ i ] | vu(v) |
| } | |
| mesh_cc_with_handles_count | vu(v) |
| NumHandles = 0 | |
| for( i=0; i<mesh_cc_with_handles_count; i++ ){ | |
| mesh_handles_cc_offset[ i ] | vu(v) |
| mesh_handles_count[ i ] | vu(v) |
| NumHandles += mesh_handles_count[ i ] | |
| } | |
| for( i=0; i<NumHandles; i++ ){ | |
| mesh_handle_index_first_delta[ i ] | vi(v) |
| mesh_handle_index_second_delta[ i ] | vi(v) |
| } | |
| mesh_coded_handle_index_second_shift_size | vu(v) |
| for( i=0; i<NumHandles; i++ ){ | |
| mesh_handle_index_second_shift[ i ] | ae(v) |
| } | |
| length_alignment( ) | |
| mesh_coded_clers_symbols_size | vu(v) |
| for( i=0; i<mesh_clers_count; i++ ){ | |
| mesh_clers_symbol[ i ] | ae(v) |
| } | |
| length_alignment( ) | |
| for( i=0; i<mesh_cc_count; i++ ){ | |
| for( j=0; j< 3; j++ ){ | |
| mesh_position_start_delta[ i ][ j ] (†) | vi(v) |
| mesh_position_start[ i ][ j ] | u(v) |
| } | |
| } | |
| length_alignment( ) | |
| mesh_coded_position_residuals_size | vu(v) |
| NumPredictedPositions = mesh_vertex_count - mesh_cc_count | |
| for( i=0; i<NumPredictedPositions; i++ ){ | |
| for(j=0; j< 3; j++ ){ | |
| mesh_position_residual[ i ][ j ] | ae(v) |
| } | |
| } | |
| length_alignment( ) | |
| if( mesh_position_deduplicate ) | |
| mesh_position_deduplicate_information( ) | |
| } | |

Features marked with a dagger (t) may be excluded in some embodiments.

### Note

Some embodiments provide a split into topo payload, then per attribute payload, for each attribute including positions as sequence of syntax elements quite similar.

mesh_vertex_count specifies the number of vertices in the decoded mesh.
NOTE—mesh_vertex_count does not include dummy points which are inserted during the topology reconstruction and removed in the subsequence mesh cleaning phase.

mesh_clers_count specifies the number of encoded CLERS symbols.
NOTE—The first symbol of each per connected component sequence of symbols is not coded. After topology reconstruction the number of triangles is (mesh_clers_count+mesh_cc_count). After mesh cleaning an unspecified number of triangles connected to dummy points are removed.

mesh_cc_count specifies the number of connected components comprised in the coded mesh.

mesh_dummy_vertex_count specifies the number of dummy vertices inserted to close holes in the reconstructed topology.
NOTE—mesh_dummy_vertex_count>=mesh_cc_count. Some embodiments include features to encode (mesh_dummy_vertex_count−mesh_cc_count).

mesh_dummy_index_delta[i] specifies the difference between the values of the i-th dummy point index and the (i−1)-th dummy point index when i is greater than 0. When i equals 0 mesh_dummy_index_delta[0] specifies the value of the index of the first dummy point.

mesh_cc_with_handles_count specifies the number of connected components with non zero handle count.

mesh_handles_count[i] specifies the number of handles comprised in the i-th connected component with non zero handle count.

mesh_handles_cc_offset[i] specifies the difference between the values of the connected component index of the i-th connected component with non zero handle count and the (i−1)-th connected component with non zero handle count when i is greater than 0. When i equals 0 mesh_handles_cc_offset[0] specifies the connected component index of the first connected components with non zero handle count.

mesh_handle_index_first_delta[i] specifies the difference between the triangle index of the i-th handle origin and the (i−1)-th handle origin when i is greater than 0. When i equals 0 mesh_handle_index_first_delta[0] specifies the triangle index of the first handle origin.

mesh_handle_index_second_delta[i] specifies the difference between the triangle index of the i-th handle destination and the (i−1)-th handle destination when i is greater than 0. When i equals 0 mesh_handle_index_second_delta[0] specifies the triangle index of the first handle destination.

mesh_coded_handle_index_second_shift_size specifies the size in bytes of the arithmetically coded sequence of mesh handle index_second_shift values, including the final byte alignment.

mesh_handle_index_second_shift[i] specifies the shift to apply when computing the corner index associated with the i-th handle destination.
NOTE—handle indices are relative to a triangle/face index as related corner indices can be deduced implicitly. The corner index of the fist handle is conforming to (3*T+0). The corner index of the second handle f index is conforming to either 3*T+1) or (3*T+2). mesh_handle_index_second_shift[i] is used to discriminate those two cases.

mesh_coded_clers_symbols_size specifies the size in bytes of the arithmetically coded sequence of CLERS symbols, including the final byte alignment.
NOTE—specifying mesh_coded_clers_symbols_size explicitly enables to pursue parsing and decode CLERS symbols in parallel.

mesh_clers_symbol[i] specifies the value of the i-th CLERS symbol.

mesh_position_start_delta[i][j] specifies the difference between the value of the j-th component of the first position of the i-th connected component and the value of the j-th component of the first position of the (i−1)-th connected component when i is greater than 0. When i equals 0 mesh_position_start_delta[0][j] specifies the value of the j-th component of the first position of the first connected component. This feature may be excluded in some embodiments.

mesh_position_start[i][j] specifies the value of the j-th component of the first position of the i-th connected component as an unsigned integer coded using mesh_position_depth_minus1+1 bits.
NOTE—Using mesh_position_start_delta[i][j] and vi(v) description enables fast parsing, but using mesh_position_start[i] [j] and u(v) is more compact in the general case. We then select to use the u(v) encoding.

mesh_coded_position_residuals_size specifies the size in bytes of the arithmetically coded sequence of positions residuals, including the final byte alignment.
NOTE—specifying mesh_coded_position_residuals_size explicitly enables to pursue parsing and decode (predicted) position residuals in parallel.

mesh_position_residual[i][j] specifies the value of the prediction residual associated with the j-th component of the i-th predicted position.
NOTE—some flexibility is to be added as the optimal loop ordering, eg per residual, then per component, could vary depending on the prediction method and the AC encoding scheme defined. This is also true for attribute residuals mesh_attribute_residual[i][j][k] in 2.2.9.

### 2.2.8 Mesh Position Deduplicate Information Syntax

### Notes

In some embodiments it may be preferrable to signal at a higher level to avoid the alignment costs

| mesh_position_deduplicate_information( ) { | Descriptor |
|---|---|
| if( mesh_position_deduplicate_method == MESH_POSITION_DEDUP_DEFAULT) { | |
| mesh_position_deduplicate_count | vu(v) |
| if( mesh_position_deduplicate_count > 0 ){ | |
| NumSplitVertex = 0 | |
| for( i=0; i< mesh_position_deduplicate_count; i++ ){ | |
| mesh_position_deduplicate_idx[ i ] | vu(v) |
| NumSplitVertex = Max(NumSplitVertex, | |
| mesh position_deduplicate_idx[ i ]+1) | |
| } | |
| mesh_position_deduplicate_start_positions | vu(v) |
| NumPositionStart = mesh_position_deduplicate_start_positions | |
| NumAddedDuplicatedVertex = mesh_position_deduplicate_count − | |
| NumSplitVertex | |
| NumVertices = NumPositionStart + NumPredictedPositions | |
| + NumAddedDuplicatedVertex + mesh_virtual_vertex_count | |
| mesh_position_is_duplicate_size | vu(v) |
| for( i=0; i< Num Vertices; i++ ){ | |
| mesh_position_is_duplicate_flag[ i ] | ae(v) |
| } | |
| length_alignment( ) | |
| } else { | |
| NumPositionStart = mesh_cc_count; | |
| } | |
| } | |
| else if mesh_position_deduplicate_method == MESH_POSITION_DEDUP_NONE) | |
| NumPositionStart = mesh_cc_count; | |
| } | |

mesh_position_dedup_encoding_method specifies the method used to encode deduplication information. Table A.17 describes the list of supported methods.
NOTE—Not set at the header level to enable per frame selection as the optimal method may vary from frame to frame. We could also define a default method at the upper level and there select either the default or point to a specific method.

TABLE A.17
Mesh position deduplication information encoding methods

| mesh_position_dedu- | | Deduplication |
|---|---|---|
| plicate_method | Identifier | Method |
| 0 | MESH_POSI- | None |
| | TION_DEDUP_NONE | |
| 1 | MESH_POSI- | Default |
| | TION_DEDUP_DEFAULT | |
| >1 | MESH_POSI- | Reserved |
| | TION_DEDUP_RESERVED | |

mesh_position_deduplicate_count specifies the number of duplicated vertices.
NOTE—The number of duplicated vertices is the sum of the number of original vertices that have been splitted, and the number of vertices added during the process of duplication to fix the manifoldness of the mesh.

mesh_position_deduplicate_idx[i] specifies a value that is common to duplicated vertices sharing a common parent. mesh_position_deduplicate_idx[i] values range from 0 to the number of original vertices that have been splitted minus one.

mesh_position_deduplicate_start positions specifies the size of the mesh_position_start array.
NOTE—Duplicated positions may be placed on the first position of a connected component. In such a case the size of the first dimension of the mesh_position_start array array may be less than the number of connected components. In some embodiments, this may be replaced with a delta value, counting the number connected component for which a start value is not coded.

mesh_position_is_duplicate_size [i] specifies the size in bytes of the arithmetically coded sequence of binary duplicate indications mesh_position_is_duplicate_flag[i], including the final byte alignment.

mesh_position_is_duplicate_flag[i] equal to 1 specifies that the i-th decoded vertex is a duplicated vertex.

### 2.2.9. Mesh Attribute Coding Payload Syntax

NOTES: Length_alignment( ) is added to enable fast parsing, and to enable fast parsing of AC coded sections.

NumComponents may be defined as in 2.2.6 according to mesh_attribute_type[l i].

| mesh_attribute_coding_payload( ) { | Descriptor |
|---|---|
| for( i=0; i<mesh_attribute_count; i++ ){ | |
| /* here testing mesh_attribute_per_face_flag[ i ] is redundant as when set to 1 */ | |
| /* mesh_attribute_separate_index_flag should be set to its default value 0 */ | |
| if( !mesh_attribute_per_face flag[ i ] && mesh_attribute_separate_index_flag[ i ]) | |
| { | |
| mesh_attribute_seams_ count[ i ] | vu(v) |
| mesh_coded_attribute_seams_ size[ i ] | vu(v) |
| for( j=0; j< mesh_attribute_seams_count[ i ]; j++ ){ | |
| mesh_attribute_seam[ i ][ j ] | ae(v) |
| } | |
| length_alignment( ) | |
| } | |
| if (mesh_attribute_separate_index_flag[ i ]){ | |
| mesh_attribute_start_count[ i ] | vu(v) |
| NumAttributeStart[i] = mesh_attribute_start_count[ i ] | |
| } else if (mesh_attribute_reference_index_plus1[ i ] > 0){ | |
| NumAttributeStart[i] = | |
| NumAttributeStart[mesh_attribute_reference_index_plus1[ i ] - | |
| 1] | |
| } else { | |
| NumAttributeStart[i] = NumPositionStart | |
| } | |
| for( j=0; j< mesh_attribute_start_count[ i ]; j++ ){ | |
| for( k=0; k< NumComponents[ i ]; k++ ){ | |
| mesh_attribute_start [ i ][ j ][ k ] | u(v |
| } | |
| } | |
| length_alignment( ) | |
| mesh_attribute_residuals_count[ i ] | vu(v) |
| if( mesh attribute_residuals_count[ i ] ){ | |
| mesh_coded_attribute_residuals_size[ i ] | vu(v) |
| for( j-0; j<mesh_attribute_residuals_count[ i ]; j++ ){ | |
| for( k=0; k< NumComponents[ i ]; k++ ){ | |
| mesh_attribute_residual[ i ][ j ][ k ] | ae(v) |
| } | |
| } | |
| length_alignment( ) | |
| } | |
| if (mesh_attribute_separate_index_flag[ i ]) | |
| mesh_attribute_deduplicate_info( i ) | |
| /* extra data dependent on the selected prediction scheme */ | |
| Attribute Type = mesh_attribute_type[ i ] | |
| AttributePredictionMethod = mesh_attribute_prediction_method[ i ] | |
| mesh_attribute_extra_data( i, AttributeType, AttributePredictionMethod ) | |
| } | |
| length_alignment( ) | |
| } | |

mesh_attribute_seams_count[i] specifies the size of the i-th attribute mesh_attribute_seam array.

mesh_coded_attribute_seams_size[i] specifies the size iₙ bytes of the arithmetically coded sequence of binary seam indications mesh_attribute_seam[i][j], including the final byte alignment.

mesh_attribute_seam[i][j] specifies the value of the j-th binary seam indication of the i-th attribute.

mesh_attribute_start_count[i] specifies the size of the mesh_attribute_start_delta[i] array containing attribute value which are not predicted.

mesh_attribute_start_delta[i][j][k] specifies the difference between the value of the k-th component of j-th value not predicted for the i-th attribute and the value of the k-th component of (j−1)-th value not predicted for the i-th attribute when j is greater than 0. When j equals 0 mesh_attribute_start_delta[i][0][k] specifies the value of the k-th component of j-th value not predicted for the i-th attribute. This feature may be excluded in some embodiments.

mesh_attribute_start[i][j][k] specifies the value of the k-th component of j-th value not predicted for the i-th attribute and the value of the k-th component as an unsigned integer coded using mesh_attribute_depth_minus1[i]+1 bits.

mesh_coded_attribute_residuals_count[i] specifies the size of the mesh_attribute_residual[i] array containing residual values for the NumComponents[i] components of the i-th attribute.

mesh_coded_attribute_residuals_size[i] specifies the size in bytes of the arithmetically coded sequence of the i-th attribute residuals mesh_attribute_residual[i][j][k], including the final byte alignment.

mesh_attribute_residual[i][j][k] specifies the value of the prediction residual associated with the k-th component of the j-th predicted value of the i-th attribute.

### 2.2.10. Mesh Extra Attribute Data Syntax

| mesh_attribute_extra_data( index, type, method ) { | Descriptor |
|---|---|
| if( type == MESH_ATTR_TEXCOORD ) { | |
| if ( method == MESH_TEXCOORD_STRETCH ) | |
| mesh_texcoord_stretch_extra_data( index ) | |
| } | |
| else if(type == MESH_ATTR_NORMAL ) | |
| /* No extra data defined for specified prediction methods applied on normals */ | |
| else if(type == MESH_ATTR_COLOR ) | |
| /* No extra data defined for specified prediction methods applied on colors */ | |
| else if(type == MATERIAL_ID ) { | |
| if ( method == MESH_MATERIALID_DEFAULT ) | |
| mesh_materialid_default_extra_data( index ) | |
| } | |
| else if(type == GENERIC ) | |
| /* No extra data defined for specified prediction methods applied on generic*/ | |
| } | |

### 2.2.11. Mesh Texcoord Stretch Extra Data Syntax

| mesh_texcoord_stretch_extra_data( index ) { | Descriptor |
|---|---|
| mesh_texcoord_stretch_orientations_count[ index ] | vu(v) |
| if(mesh_texcoord_stretch_orientations_count > 0 ){ | |
| mesh_coded_texcoord_stretch_orientations_size[ index] | vu(v) |
| for( j=0; j< mesh_texcoord_stretch_orientations_count[ index ]; j++ ){ | |
| mesh_texcoord_stretch_orientation[ index ][ j ] | ae(v) |
| } | |
| } | |
| length_alignment( ) | |
| } | |

mesh_texcoord_stretch_orientations_count[i] specifies the size of the array containing orientation information mesh_texcoord_stretch_orientation used to predict texture coordinates when the mesh_attribute type of the i^{th} attribute equals MESH_ATTR_TEXCOORD and when the related mesh_attribute_prediction_method equals MESH_TEXCOORD_STRETCH.

mesh_coded_texcoord_stretch_orientationssize[i] specifies the size in bytes of the arithmetically coded sequence of orientations contained in the array mesh_texcoord_stretch_orientation[i], including the final byte alignment.

mesh_texcoord_stretch_orientation[i][j] specifies the value of the j-th orientation bit in the sequence used to generate the i-th attribute values from the arrays mesh_attribute_residual[i] and mesh_attribute_start[i].

### 2.2.12. Mesh Materialid Default Extra Data Syntax

| mesh_materialid_default_extra_data( index ) { | Descriptor |
|---|---|
| mesh_materialid_default_equal_count[ index ] | vu(v) |
| mesh_materialid_default_left_count[ index ] | vu(v) |
| mesh materialid_default_right_count[ index ] | vu(v) |
| mesh_materialid_default_facing_count[ index ] | vu(v) |
| if( mesh_materialid_default_equal_count[ index ] > 0 ){ | |
| mesh_coded_materialid_default_equal_size[ index ] | vu(v) |
| for( j=0; j< mesh_materialid_default_equal_count[ index ]; j++ ){ | |
| mesh_materialid_default_equal_flag[ index ][ j ] | ae(v) |
| } | |
| } | |
| if( mesh_materialid_default_left_count[ index ] > 0 ){ | |
| mesh_coded_materialid_default_left_size[ index ] | vu(v) |
| for( j=0; j< mesh_materialid_default_left_count[ index ]; j++ ){ | |
| mesh_materialid_default_left_flag[ index ][ j ] | ae(v) |
| } | |
| } | |
| if( mesh_materialid_default_right_count[ index ] > 0 ){ | |
| mesh_coded_materialid_default_right_size[ index ] | vu(v) |
| for( j-0; j< mesh_materialid_default_right_count[ index ]; j++ ){ | |
| mesh_materialid_default_right_flag[ index ][ j ] | ae(v) |
| } | |
| } | |
| if( mesh_materialid_default_facing_count[ index ] > 0 ){ | |
| mesh_coded_materialid_default_facing_size[ index ] | vu(v) |
| for( j-0; j< mesh_materialid_default_facing_count[ index ]; j++ ){ | |
| mesh_materialid_default_facing_flag[ index ][ j ] | ae(v) |
| } | |
| } | |
| length_alignment( ) | |
| } | |

mesh_materialid_default_equal_count[i] specifies the size of the array containing boolean information mesh_materialid_default_equal_flag used to predict material ids when the mesh_attribute type of the i-th attribute equals MESH_ATTR_MATERIAL_ID and when the related mesh attribute_prediction_method equals MESH_MATRIALID_DEFAULT.

mesh_coded_materialid_default_equal_size[i] specifies the size in bytes of the arithmetically coded sequence of booleans contained in the array mesh_materialid_default_equal_flag[i], including the final byte alignment.

mesh_materialid_default_equal_flag[i][j] specifies the value of the j-th bit in the sequence used to generate the i-th attribute value from the arrays mesh_attribute_residual[i], and mesh_attribute_start[i].

mesh_materialid_default_left_count[i] specifies the size of the array containing boolean information mesh_materialid_default_left_flag used to predict material ids when the mesh_attribute type of the i-th attribute equals MESH_ATTR_MATERIAL_ID and when the related mesh attribute_prediction_method equals MESH_MATRIALID_DEFAULT.

mesh_coded_materialid_default_left_size[i] specifies the size in bytes of the arithmetically coded sequence of booleans contained in the array mesh_materialid_default_left_flag[i], including the final byte alignment.

mesh_materialid_default_left_flag[i][j] specifies the value of the j-th bit in the sequence used to generate the i-th attribute value from the arrays mesh_attribute_residual[i], and mesh_attribute_start[i].

mesh_materialid_default_right_count[i] specifies the size of the array containing boolean information mesh_materialid_default_right_flag used to predict material ids when the mesh_attribute type of the i-th attribute equals MESH_ATTR_MATERIAL_ID and when the related mesh attribute_prediction_method equals MESH_MATRIALID_DEFAULT.

mesh_coded_materialid_default_right_size[i] specifies the size iₙ bytes of the arithmetically coded sequence of booleans contained in the array mesh_materialid_default_right_flag[i], including the final byte alignment.

mesh_materialid_default_right_flag[i][j] specifies the value of the j-th bit in the sequence used to generate the i-th attribute value from the arrays mesh_attribute_residual[i], and mesh_attribute_start[i].

mesh_materialid_default_facing_count[i] specifies the size of the array containing boolean information mesh_materialid_default_facing_flag used to predict material ids when the mesh_attribute type of the i-th attribute equals MESH_ATTR_MATERIAL_ID and when the related mesh_attribute_prediction_method equals MESH_MATRIALID_DEFAULT.

mesh_coded_materialid_default_facing_size[i] specifies the size in bytes of the arithmetically coded sequence of booleans contained in the array mesh_materialid_default_facing_flag[i], including the final byte alignment.

mesh_materialid_default_facing_flag[i][j] specifies the value of the j-th bit in the sequence used to generate the i-th attribute value from the arrays mesh_attribute_residual[i], and mesh_attribute start[i].

### 2.2.13. Mesh Attribute Deduplicate Information Syntax

Example embodiments further include syntax elements that provide deduplicate information.

1. A mesh decoding method comprising:
obtaining from a bitstream a CLERS table representing an edgebreaker encoding of a topology of a triangular mesh;
reconstructing the topology of the triangular mesh from the CLERS table;
obtaining from the bitstream ordered attribute information representing attributes of respective faces in the triangular mesh, wherein the ordered attribute information comprises at least a first vector, the first vector comprising an entry for each of a plurality of the faces, each entry in the first vector being a Boolean value indicating whether the attribute value of a respective current face is the same as an attribute value of a most-recently-decoded face; and
decoding the ordered attribute information to determine, for each of the faces, an attribute value of the respective face.

2. A mesh decoding apparatus comprising one or more processors configured to perform at least:
obtaining from a bitstream a CLERS table representing an edgebreaker encoding of a topology of a triangular mesh;
reconstructing the topology of the triangular mesh from the CLERS table;
obtaining from the bitstream ordered attribute information representing attributes of respective faces in the triangular mesh, wherein the ordered attribute information comprises at least a first vector, the first vector comprising an entry for each of a plurality of the faces, each entry in the first vector being a Boolean value indicating whether the attribute value of a respective current face is the same as an attribute value of a most-recently-decoded face; and
decoding the ordered attribute information to determine, for each of the faces, an attribute value of the respective face.

3. (canceled)

4. The method of claim 1, wherein the ordered attribute information further comprises at least a second vector, the second vector comprising an entry for each of a plurality of the faces, each entry in the second vector being a Boolean value indicating whether the attribute of a respective current face is the same as an attribute value of a neighboring face in a first direction from the current face, wherein the second vector includes entries only for faces that do not have an attribute value that is determined by the first vector.

5. (canceled)

6. The method of claim 4, wherein the ordered attribute information further comprises at least a third vector, the third vector comprising an entry for each of a plurality of the faces, each entry in the third vector being a Boolean value indicating whether the attribute of a respective current face is the same as an attribute value of a neighboring face in a second direction from the current face, wherein the third vector includes entries only for faces that do not have an attribute value that is determined by the first vector or the second vector.

7. (canceled)

8. The method of claim 6, wherein the ordered attribute information further comprises at least a fourth vector, the fourth vector comprising an entry for each of a plurality of the faces, each entry in the fourth vector being a Boolean value indicating whether the attribute of a respective current face is the same as an attribute value of a neighboring face in a third direction from the current face, wherein the fourth vector includes entries only for faces that do not have an attribute value that is determined by the first vector, the second vector, or the third vector.

9. (canceled)

10. The method of claim 8, wherein the ordered attribute information further comprises at least a fifth vector, the fifth vector comprising an entry for each of a plurality of the faces, each entry in the fifth vector including an attribute value of a respective current face, wherein the fifth vector includes entries only for faces that do not have an attribute value that is determined by the first vector, the second vector, the third vector, or the fourth vector.

11-12. (canceled)

13. The method of claim 4, further comprising:
entropy decoding the first vector from the bitstream using a first context; and
entropy decoding at least the second vector from the bitstream using a second context different from the first context.

14-18. (canceled)

19. A mesh encoding method comprising:
obtaining information describing a topology of a triangular mesh;
obtaining information indicating, for each face in the triangular mesh, an attribute value of the respective face;
encoding in a bitstream a CLERS table representing an edgebreaker encoding of the topology; and
encoding in the bitstream attribute ordered information indicating, for each of the faces, the attribute value of the respective face, wherein the ordered attribute information comprises at least a first vector, the first vector comprising an entry for each of a plurality of the faces, each entry in the first vector being a Boolean value indicating whether the attribute value of a respective current face is the same as an attribute value of a most-recently-encoded face.

20. A mesh encoding apparatus comprising one or more processors configured to perform at least:
obtaining information describing a topology of a triangular mesh;
obtaining information indicating, for each face in the triangular mesh, an attribute value of the respective face;
encoding in a bitstream a CLERS table representing an edgebreaker encoding of the topology; and
encoding in the bitstream ordered attribute information indicating, for each of the faces, the attribute value of the respective face, wherein the ordered attribute information comprises at least a first vector, the first vector comprising an entry for each of a plurality of the faces, each entry in the first vector being a Boolean value indicating whether the attribute value of a respective current face is the same as an attribute value of a most-recently-encoded face.

21. (canceled)

22. The method of claim 19, wherein the ordered attribute information further comprises at least a second vector, the second vector comprising an entry for each of a plurality of the faces, each entry in the second vector being a Boolean value indicating whether the attribute of a respective current face is the same as an attribute value of a neighboring face in a first direction from the current face.

23. (canceled)

24. The method of claim 22, wherein the ordered attribute information further comprises at least a third vector, the third vector comprising an entry for each of a plurality of the faces, each entry in the third vector being a Boolean value indicating whether the attribute of a respective current face is the same as an attribute value of a neighboring face in a second direction from the current face.

25. (canceled)

26. The method of claim 24, wherein the ordered attribute information further comprises at least a fourth vector, the fourth vector comprising an entry for each of a plurality of the faces, each entry in the fourth vector being a Boolean value indicating whether the attribute of a respective current face is the same as an attribute value of a neighboring face in a third direction from the current face.

27. (canceled)

28. The method of claim 26, wherein the ordered attribute information further comprises at least a fifth vector, the fifth vector comprising an entry for each of a plurality of the faces, each entry in the fourth vector including an attribute value of a respective current face.

29. The method of claim 28, wherein the fifth vector includes entries only for faces that do not have an attribute value that is determined by the first vector, the second vector, the third vector, or the fourth vector.

30-64. (canceled)

65. The apparatus of claim 2, wherein the ordered attribute information further comprises at least a second vector, the second vector comprising an entry for each of a plurality of the faces, each entry in the second vector being a Boolean value indicating whether the attribute of a respective current face is the same as an attribute value of a neighboring face in a first direction from the current face.

66. The apparatus of claim 65, wherein the ordered attribute information further comprises at least a third vector, the third vector comprising an entry for each of a plurality of the faces, each entry in the third vector being a Boolean value indicating whether the attribute of a respective current face is the same as an attribute value of a neighboring face in a second direction from the current face.

67. The method of claim 66, wherein the ordered attribute information further comprises at least a fourth vector, the fourth vector comprising an entry for each of a plurality of the faces, each entry in the fourth vector being a Boolean value indicating whether the attribute of a respective current face is the same as an attribute value of a neighboring face in a third direction from the current face.

68. The apparatus of claim 20, wherein the ordered attribute information further comprises at least a second vector, the second vector comprising an entry for each of a plurality of the faces, each entry in the second vector being a Boolean value indicating whether the attribute of a respective current face is the same as an attribute value of a neighboring face in a first direction from the current face.

69. The apparatus of claim 68, wherein the ordered attribute information further comprises at least a third vector, the third vector comprising an entry for each of a plurality of the faces, each entry in the third vector being a Boolean value indicating whether the attribute of a respective current face is the same as an attribute value of a neighboring face in a second direction from the current face.

70. The apparatus method of claim 69, wherein the ordered attribute information further comprises at least a fourth vector, the fourth vector comprising an entry for each of a plurality of the faces, each entry in the fourth vector being a Boolean value indicating whether the attribute of a respective current face is the same as an attribute value of a neighboring face in a third direction from the current face.
